(19) United States
(12) Patent Application Publication
(10) Pub. No.: US 2025/0365729 A1
(43) Pub. Date: Nov. 27, 2025

(54) TRANSMISSION CONFIGURATION INDICATION IN MULTI-CELL SCHEDULING

(71) Applicant: Samsung Electronics Co., Ltd., Suwon-si (KR)

(72) Inventors: Ebrahim MolavianJazi, San Jose, CA (US); Aristides Papasakellariou, Houston, TX (US)

(21) Appl. No.: 18/974,498

(22) Filed: Dec. 9, 2024

Related U.S. Application Data
(60) Provisional application No. 63/650,276, filed on May 21, 2024.
(60) Provisional application No. 63/703,035, filed on Oct. 3, 2024.

(51) Int. Cl. H04W 72/1273; H04L 1/1867; H04L 5/00; H04W 72/232

(52) U.S. Cl. CPC H04W 72/1273; H04L 1/1887; H04L 5/0092; H04W 72/232

(57) ABSTRACT

Methods and apparatuses for transmission configuration indication (TCI) in multi-cell scheduling. A method includes receiving first information for a set of cells and receiving a downlink control information (DCI) format that schedules physical downlink shared channels (PDSCHs) on first cells from the set. A TCI field of the DCI format provides first indicated TCI states for the first cells and second indicated TCI states for second cells that are not scheduled by the DCI format. The method further includes determining first new active downlink (DL) bandwidth part (BWPs) for the first cells based on an indicated DL BWP index in the DCI format. The first indicated TCI states are from activated TCI states on the first new active DL BWPs and the second indicated TCI states are from activated TCI states on current active DL BWPs. The method further includes receiving the PDSCHs on the first new active DL BWPs.

### CROSS-REFERENCE TO RELATED AND CLAIM OF PRIORITY

The present application claims priority under 35 U.S.C. § 119(e) to U.S. Provisional Patent Application No. 63/650,276 filed on May 21, 2024, and U.S. Provisional Patent Application No. 63/703,035 filed on Oct. 3, 2024, which are hereby incorporated by reference in their entirety.

### TECHNICAL FIELD

The present disclosure relates generally to wireless communication systems and, more specifically, the present disclosure relates to methods and apparatuses for transmission configuration indication (TCI) in multi-cell scheduling.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to TCI in multi-cell scheduling.

In one embodiment, a method for operating a user equipment (UE) is provided. The method includes receiving first information for a set of cells and receiving a downlink control information (DCI) format that schedules first one or more physical downlink shared channels (PDSCHs) on respective first one or more cells from the set of cells. A bandwidth part (BWP) indicator field of the DCI format indicates a downlink (DL) BWP index. A TCI field of the DCI format provides a TCI state indication including first one or more indicated TCI states for the first one or more cells, respectively, and second one or more indicated TCI states for second one or more cells, respectively. The second one or more cells are from the set of cells and are not scheduled by the DCI format.

The method further includes determining respective first one or more new active DL BWPs for the first one or more cells based on the indicated DL BWP index. The first one or more indicated TCI states are from associated first one or more sets of activated TCI states on the respective first one or more new active DL BWPs, and the second one or more indicated TCI states are from associated second one or more sets of activated TCI states on respective current active DL BWPs of the second one or more cells. The method further includes receiving the first one or more PDSCHs on the respective first one or more new active DL BWPs of the first one or more cells.

In another embodiment, a UE is provided. The UE includes a transceiver configured to receive first information for a set of cells and a DCI format that schedules first one or more PDSCHs on respective first one or more cells from the set of cells. A bandwidth part (BWP) indicator field of the DCI format indicates a downlink (DL) BWP index. A TCI field of the DCI format provides a TCI state indication including first one or more indicated TCI states for the first one or more cells, respectively, and second one or more indicated TCI states for second one or more cells, respectively. The second one or more cells are from the set of cells and are not scheduled by the DCI format. The UE includes a processor operably coupled with the transceiver. The processor is configured to determine respective first one or more new active DL BWPs for the first one or more cells based on the indicated DL BWP index. The first one or more indicated TCI states are from associated first one or more sets of activated TCI states on the respective first one or more new active DL BWPs, and the second one or more indicated TCI states are from associated second one or more sets of activated TCI states on respective current active DL BWPs of the second one or more cells. The transceiver is further configured to receive the first one or more PDSCHs on the respective first one or more new active DL BWPs of the first one or more cells.

In yet another embodiment, a base station includes a transceiver configured to transmit first information for a set of cells, transmit a DCI format that schedules first one or more PDSCHs on respective first one or more cells from the set of cells. A bandwidth part (BWP) indicator field of the DCI format indicates a downlink (DL) BWP index. A TCI field of the DCI format provides a TCI states indication including first one or more indicated TCI states for the first one or more cells, respectively, and second one or more indicated TCI states for second one or more cells, respectively. The second one or more cells are from the set of cells and are not scheduled by the DCI format. The base station includes a processor operably coupled with the transceiver. The processor is configured to determine respective first one or more new active DL BWPs for the first one or more cells based on the indicated DL BWP index. The first one or more indicated TCI states are from associated first one or more sets of activated TCI states on the respective first one or more new active DL BWPs, and the second one or more indicated TCI states are from associated second one or more sets of activated TCI states on respective current active DL BWPs of the second one or more cells. The transceiver is further configured to transmit the first one or more PDSCHs on the respective first one or more new active DL BWPs of the first one or more cells.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example UE according to embodiments of the present disclosure;

FIGS. 4A and 4B illustrates an example of a wireless transmit and receive paths according to embodiments of the present disclosure;

FIG. 5 illustrates a flowchart of an example UE procedure for generating sub-codebooks (sub-CBs) according to embodiments of the present disclosure;

FIG. 6 illustrates a flowchart of an example UE procedure for generating sub-CBs according to embodiments of the present disclosure; and

FIG. 7 illustrates a flowchart of an example UE procedure for generating sub-CBs according to embodiments of the present disclosure.

### DETAILED DESCRIPTION

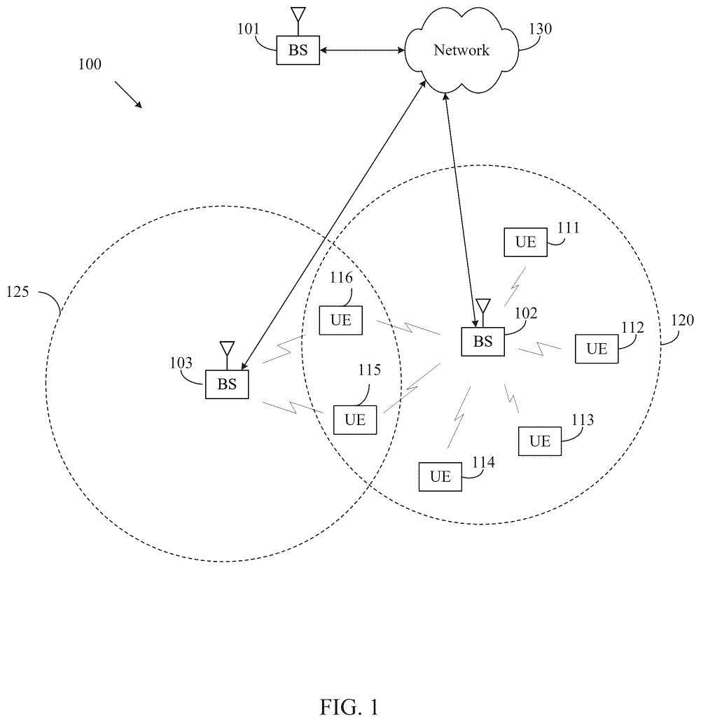

FIGS. 1-7, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [1] 3GPP TS 38.211 Rel-18 v 18.2.0, “NR; Physical channels and modulation;” [2] 3GPP TS 38.212 Rel-18 v 18.2.0, “NR; Multiplexing and channel coding;” [3] 3GPP TS 38.213 Rel-18 v 18.2.0, “NR; Physical layer procedures for control;” [4] 3GPP TS 38.214 Rel-18 v 18.2.0, “NR; Physical layer procedures for data;” [5] 3GPP TS 38.215 Rel-18 v 18.2.0, “NR; Physical layer measurements;” [6] 3GPP TS 38.321 Rel-18 v 18.1.0, “NR; Medium Access Control (MAC) protocol specification;” [7] 3GPP TS 38.331 Rel-18 v 18.1.0, “NR; Radio Resource Control (RRC) protocol specification;” and [8] 3GPP TS 38.300 Rel-18 v 18.1.0, “NR; NR and NG-RAN Overall Description; Stage 2”.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for TCI in multi-cell scheduling. In certain embodiments, one or more of the BSs 101-103 include circuitry, programing, or a combination thereof to support TCI in multi-cell scheduling.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

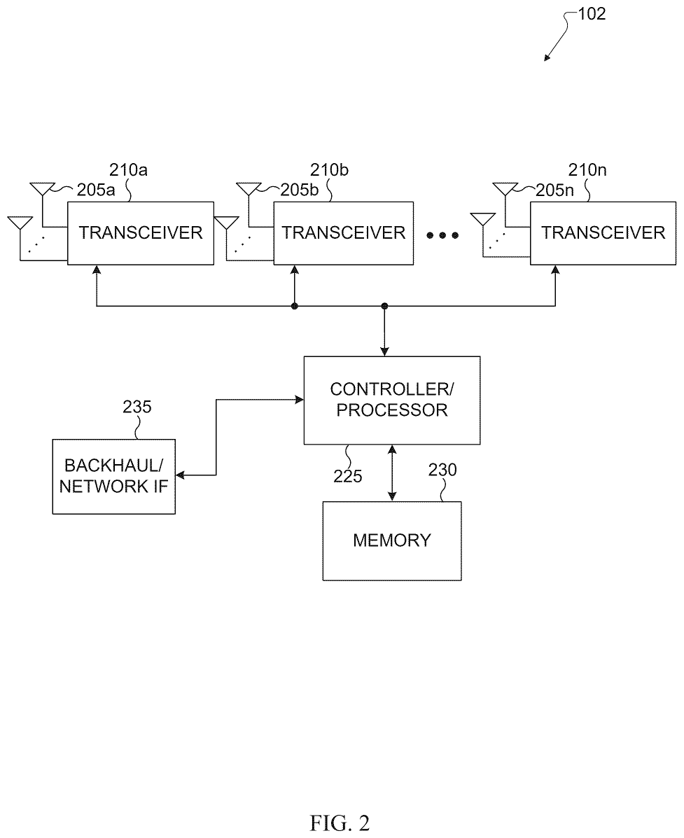

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as supporting TCI in multi-cell scheduling. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

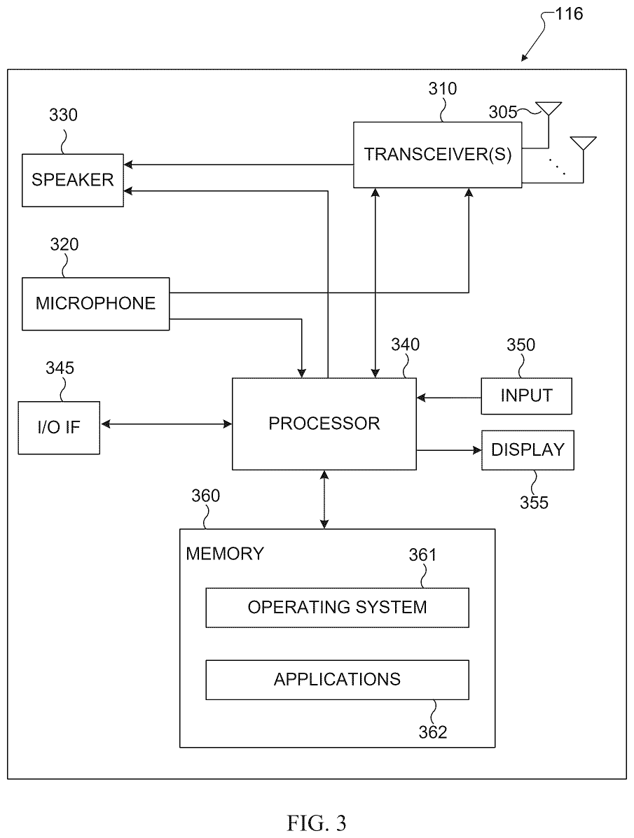

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for TCI in multi-cell scheduling as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

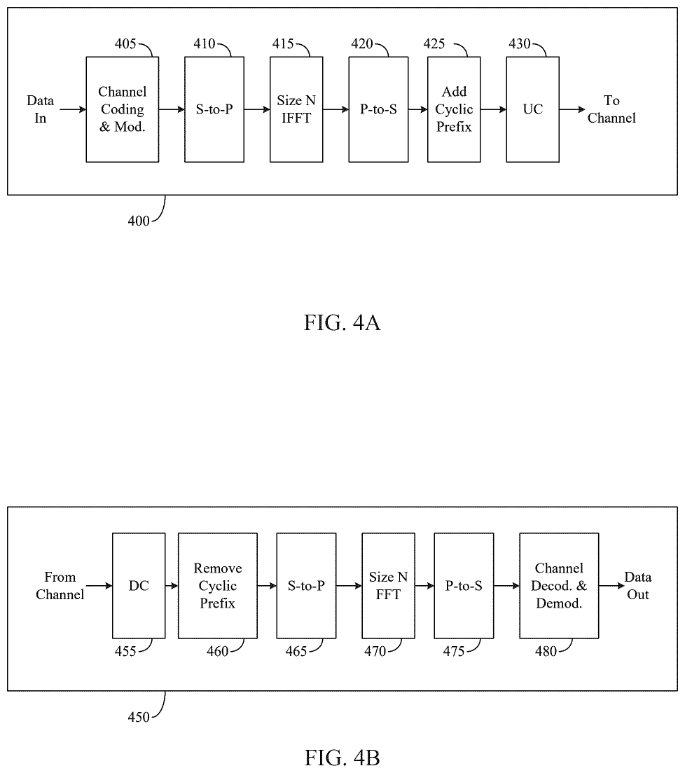

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 and/or receive path 450 is configured to utilize TCI in multi-cell scheduling as described in embodiments of the present disclosure.

As illustrated in FIG. 4A, the transmit path 400 includes a channel coding and modulation block 205, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 250 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

Any of the above variation embodiments can be utilized independently or in combination with at least one other variation embodiment.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of subject matter is defined by the claims.

The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

In addition, 5G radio provides optimized support for additional services and features in 3GPP Release 16 such as vehicular (V2X) and device-to-device (D2D) communications, wireless backhauling (IAB), coordinated multi-point (COMP) or Multi-TRP transmission and reception (multi-TRP), cross-link interference (CLI) and remote interference (RIM) detection and avoidance, and NR operation in unlicensed bands (NR-U).

In embodiments of the present disclosure, a beam is determined by either a transmission configuration indicator (TCI) state that establishes a quasi-colocation (QCL) relationship between a source reference signal (RS) (e.g., single sideband (SSB) and/or Channel State Information Reference Signal (CSI-RS)) and a target RS or a spatial relation information that establishes an association to a source RS, such as SSB or CSI-RS or sounding reference signal (SRS). In either case, the ID of the source reference signal identifies the beam. The TCI state and/or the spatial relation reference RS can determine a spatial RX filter for reception of downlink channels at the UE 116, or a spatial TX filter for transmission of uplink channels from the UE 116.

A communication system can include a downlink (DL) that refers to transmissions from a base station (such as the BS 102) or one or more transmission points to UEs (such as the UE 116) and an uplink (UL) that refers to transmissions from UEs (such as the UE 116) to a base station (such as the BS 102) or to one or more reception points.

A time unit for DL signaling or for UL signaling on a cell is referred to as a slot and can include one or more symbols. A symbol can also serve as an additional time unit. A frequency (or bandwidth (BW)) unit is referred to as a resource block (RB). One RB includes a number of sub-carriers (SCs). For example, a slot can have duration of 1 millisecond or 0.5 millisecond, include 14 symbols and an RB can include 12 SCs with inter-SC spacing of 15 kHz or 30 kHz, and so on.

DL signals include data signals conveying information content, control signals conveying DL control information (DCI), and reference signals (RS) that are also known as pilot signals. A gNB transmits data information or DCI through respective physical DL shared channels (PDSCHs) or physical DL control channels (PDCCHs). A PDSCH or a PDCCH can be transmitted over a variable number of slot symbols including one slot symbol. For brevity, a DCI format scheduling a PDSCH reception by a UE is referred to as a DL DCI format and a DCI format scheduling a physical uplink shared channel (PUSCH) transmission from a UE is referred to as an UL DCI format.

A gNB (such as the BS 102) transmits one or more of multiple types of RS including channel state information RS (CSI-RS) and demodulation RS (DM-RS). A CSI-RS is primarily intended for UEs to perform measurements and provide channel state information (CSI) to a gNB. For channel measurement, non-zero power CSI-RS (NZP CSI-RS) resources are used. For interference measurement reports (EIRs), CSI interference measurement (CSI-IM) resources associated with a zero power CSI-RS (ZP CSI-RS) configuration are used. A CSI process includes of NZP CSI-RS and CSI-IM resources.

A UE (such as the UE 116) can determine CSI-RS transmission parameters through DL control signaling or higher layer signaling, such as radio resource control (RRC) signaling, from a gNB (such as the BS 102). Transmission instances of a CSI-RS can be indicated by DL control signaling or be configured by higher layer signaling. A DM-RS is transmitted only in the BW of a respective PDCCH or PDSCH and a UE can use the DM-RS to demodulate data or control information.

In certain embodiments, UL signals also include data signals conveying information content, control signals conveying UL control information (UCI), DM-RS associated with data or UCI demodulation, sounding RS (SRS) enabling a gNB to perform UL channel measurement, and a RA preamble enabling a UE to perform RA (see also NR specification). A UE transmits data information or UCI through a respective PUSCH or a physical UL control channel (PUCCH). A PUSCH or a PUCCH can be transmitted over a variable number of slot symbols including one slot symbol. The gNB can configure the UE to transmit signals on a cell within an active UL bandwidth part (BWP) of the cell UL BW.

UCI includes HARQ acknowledgement (ACK) information, indicating correct or incorrect detection of data transport blocks (TBs) in a PDSCH, scheduling request (SR) indicating whether a UE has data in a buffer, and CSI reports enabling a gNB to select appropriate parameters for PDSCH or PDCCH transmissions to a UE. HARQ-ACK information can be configured to be with a smaller granularity than per TB and can be per data code block (CB) or per group of data CBs where a data TB includes a number of data CBs.

A CSI report from a UE can include a channel quality indicator (CQI) informing a gNB of a largest modulation and coding scheme (MCS) for the UE to detect a data TB with a predetermined block error rate (BLER), such as a 10% BLER (see NR specification), of a precoding matrix indicator (PMI) informing a gNB how to combine signals from multiple transmitter antennas in accordance with a MIMO transmission principle, and of a rank indicator (RI) indicating a transmission rank for a PDSCH.

UL RS includes DM-RS and SRS. DM-RS is transmitted only in a BW of a respective PUSCH or PUCCH transmission. A gNB can use a DM-RS to demodulate information in a respective PUSCH or PUCCH. SRS is transmitted by a UE to provide a gNB with an UL CSI and, for a time division duplexing (TDD) system, an SRS transmission can also provide a PMI for DL transmission. Additionally, in order to establish synchronization or an initial higher layer connection with a gNB, a UE can transmit a physical random-access channel (physical random access channel (PRACH) as shown in NR specifications).

An antenna port is defined such that the channel over which a symbol on the antenna port is conveyed can be inferred from the channel over which another symbol on the same antenna port is conveyed.

For DM-RS associated with a PDSCH, the channel over which a PDSCH symbol on one antenna port is conveyed can be inferred from the channel over which a DM-RS symbol on the same antenna port is conveyed only if the two symbols are within the same resource as the scheduled PDSCH, in the same slot, and in the same precoding resource block group (PRG).

For DM-RS associated with a PDCCH, the channel over which a PDCCH symbol on one antenna port is conveyed can be inferred from the channel over which a DM-RS symbol on the same antenna port is conveyed only if the two symbols are within resources for which the UE 116 may expect the same precoding being used.

For DM-RS associated with a physical broadcast channel (PBCH), the channel over which a PBCH symbol on one antenna port is conveyed can be inferred from the channel over which a DM-RS symbol on the same antenna port is conveyed only if the two symbols are within a synchronization signal/physical broadcast channel (SS/PBCH) block transmitted within the same slot, and with the same block index.

Two antenna ports are said to be quasi co-located if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial Rx parameters.

The UE 116 (such as the UE 116) may expect that synchronization signal (SS)/physical broadcast channel block (also denoted as SSBs) transmitted with the same block index on the same center frequency location are quasi co-located with respect to Doppler spread, Doppler shift, average gain, average delay, delay spread, and, when applicable, spatial Rx parameters. The UE 116 may not expect quasi co-location for any other synchronization signal SS/PBCH block transmissions.

In absence of CSI-RS configuration, and unless otherwise configured, the UE 116 may expect PDSCH DM-RS and SSB to be quasi co-located with respect to Doppler shift, Doppler spread, average delay, delay spread, and, when applicable, spatial Rx parameters. The UE 116 may expect that the PDSCH DM-RS within the same code division multiplexing (CDM) group is quasi co-located with respect to Doppler shift, Doppler spread, average delay, delay spread, and spatial Rx. The UE 116 may also expect that DM-RS ports associated with a PDSCH are QCL with QCL type A, type D (when applicable) and average gain. The UE 116 may further expect that no DM-RS collides with the SS/PBCH block.

The UE 116 can be configured with a list of up to M transmission configuration indication (TCI) State configurations within the higher layer parameter PDSCH-Config to decode PDSCH according to a detected PDCCH with DCI intended for the UE 116 and the given serving cell, where M depends on the UE 116 capability maxNumberConfiguredTCIstatesPerCC. Each TCI-State contains parameters for configuring a quasi-colocation (QCL) relationship between one or two downlink reference signals and the DM-RS ports of the PDSCH, the DM-RS port of PDCCH or the CSI-RS port(s) of a CSI-RS resource.

The quasi co-location relationship is configured by the higher layer parameter qcl-Type1 for the first DL RS, and qcl-Type2 for the second DL RS (if configured). For the case of two DL RSs, the QCL types may not be the same, regardless of whether the references are to the same DL RS or different DL RSs. The quasi co-location types corresponding to each DL RS are given by the higher layer parameter qcl-Type in QCL-Info and may take one of the following values: QCL-TypeA: {Doppler shift, Doppler spread, average delay, delay spread}; QCL-TypeB: {Doppler shift, Doppler spread; QCL-TypeC: {Doppler shift, average delay}; and QCL-TypeD: {Spatial Rx parameter}.

The UE 116 receives a MAC-control element (CE) activation command to map up to [N](e.g., N=8) TCI states to the codepoints of the DCI field “Transmission Configuration Indication.” When the HARQ-ACK corresponding to the PDSCH carrying the activation command is transmitted in slot n, the indicated mapping between TCI states and codepoints of the DCI field “Transmission Configuration Indication” may be applied after a MAC-CE application time, e.g., starting from the first slot that is after slot (

$$( n + 3 {N}_{slot}^{subframe , μ} ) where {N}_{slot}^{subframe , μ}$$

is a number of slot per subframe for subcarrier spacing (SCS) configuration μ.

In the following and throughout the disclosure, various embodiments of the disclosure may be also implemented in any type of UE including, for example, UEs with the same, similar, or more capabilities compared to typical 5G NR UEs. Although various embodiments of the disclosure discuss 3GPP 5G NR communication systems, the embodiments may apply in general to UEs operating with other RATs and/or standards, such as next releases/generations of 3GPP, IEEE WiFi, and so on.

In the following, unless otherwise explicitly noted, providing a parameter value by higher layers includes providing the parameter value by master information block (MIB) or a system information block (SIB), such as a SIB1, or by a common RRC signaling, or by UE-specific RRC signaling.

In the following, for brevity of description, the higher layer provided TDD UL-DL frame configuration refers to tdd-UL-DL-ConfigurationCommon as example for RRC common configuration and/or tdd-UL-DL-ConfigurationDedicated as example for UE-specific configuration. The UE determines a common TDD UL-DL frame configuration of a serving cell by receiving a SIB such as a SIB1 when accessing the cell from RRC_IDLE or by RRC signaling when the UE is configured with SCells or additional secondary cell groups (SCGs) by an information element (IE) ServingCellConfigCommon in RRC_CONNECTED. The UE determines a dedicated TDD UL-DL frame configuration using the IE ServingCellConfig when the UE is configured with a serving cell, e.g., add or modify, where the serving cell may be the SpCell or an SCell of an master cell group (MCG) or SCG. A TDD UL-DL frame configuration designates a slot or symbol as one of types ‘D’, ‘U’ or ‘F’ using at least one time-domain pattern with configurable periodicity.

In the following, for brevity of description, slot format indication (SFI) refers to a slot format indicator as example that is indicated using higher layer provided IEs such as slotFormatCombination or slotFormatCombinationsPerCell and which is indicated to the UE by group common DCI format such as DCI F2_0 where slotFormats are defined in [REF3, TS 38.213].

The Synchronization Signal and PBCH block (SSB) includes of primary and secondary synchronization signals (PSS, SSS), each occupying 1 symbol and 127 subcarriers, and PBCH spanning across 3 OFDM symbols and 240 subcarriers, but on one symbol leaving an unused part in the middle for SSS. The time locations of SSBs within a half-frame are determined by sub-carrier spacing and the periodicity of the half-frames where SSBs are transmitted is configured by the network (e.g., the network 130). During a half-frame, different SSBs may be transmitted in different spatial directions (i.e., using different beams, spanning the coverage area of a cell).

Within the frequency span of a carrier, multiple SSBs can be transmitted. The physical cell IDs (PCIs) of SSBs transmitted in different frequency locations do not have to be unique, i.e., different SSBs in the frequency domain can have different PCIs. However, when an SSB is associated with an remaining minimum system information (RMSI), the SSB is referred to as a Cell-Defining SSB (CD-SSB). A primary cell (PCell) is associated to a CD-SSB located on the synchronization raster.

Polar coding is used for PBCH. The UE may expect a band-specific sub-carrier spacing for the SSB unless a network has configured the UE to expect a different sub-carrier spacing. PBCH symbols carry its own frequency-multiplexed demodulation reference signal (DMRS). QPSK modulation is used for PBCH.

Measurement time resource(s) for SSB-based reference signal received power (RSRP) measurements may be confined within a SSB Measurement Time Configuration (SMTC). The SMTC configuration provides a measurement window periodicity/duration/offset information for UE radio resource management (RRM) measurement per carrier frequency. For intra-frequency connected mode measurement, up to two measurement window periodicities can be configured. For RRC_IDLE, a single SMTC is configured per carrier frequency for measurements. For inter-frequency mode measurements in RRC_CONNECTED, a single SMTC is configured per carrier frequency. Note that if RSRP is used for L1-RSRP reporting in a CSI report, the measurement time resource(s) restriction provided by the SMTC window size is not applicable. Similarly, measurement time resource(s) for received signal strength indicator (RSSI) are confined within SMTC window duration. If no measurement gap is used, RSSI is measured over OFDM symbols within the SMTC window duration. If a measurement gap is used, RSSI is measured over OFDM symbols corresponding to overlapped time span between SMTC window duration and minimum measurement time within the measurement gap.

Throughout the present disclosure, the term “configuration” or “higher layer configuration” and variations thereof (such as “configured” and so on) are used to refer to one or more of: a system information signaling such as by a MIB or a SIB (such as SIB1), a common or cell-specific higher layer/RRC signaling, or a dedicated or UE-specific or BWP-specific higher layer/RRC signaling.

Throughout the present disclosure, the term signal quality is used to refer to e.g., RSRP or reference signal received quality (RSRQ) or RSSI or signal-to-noise ratio (SNR) or signal-to-interference-plus-noise ratio (SINR), with or without filtering such as L1 or L3 filtering, of a channel or a signal such as a reference signal (RS) including SSB, CSI-RS, or SRS.

The present disclosure provides enhanced scheduling operation in a carrier aggregation (CA) framework to support joint scheduling of multiple cells, such as when operating with one or multiple sets of cells for multi-cell scheduling.

In typical 5G NR systems, a downlink or uplink data transmission can be scheduled only for a single serving cell. In other words, a DCI format provides scheduling information parameters for a PD SCH or a PUSCH on a single serving cell. If the serving cell is a scheduled cell, the UE receives a DCI format for the PDSCH/PUSCH in a PDCCH that the UE receives on a corresponding scheduling cell. Based on a carrier indication field (CIF) in the DCI format, the UE can determine a serving cell on which the UE can receive the PDSCH or transmit the PUSCH.

Embodiments of the present disclosure recognizes that the typical NR system does not support joint scheduling of multiple PDSCHs or multiple PUSCH on multiple cells using a single/common control signaling, such as by using a single DCI format. For such operation, the UE receives multiple DCI formats, wherein each DCI format can schedule one of the multiple PDSCHs or PUSCHs on one of the serving cells. Such operation achieves the intended outcome, but with high signaling overhead. In various scenarios, several scheduling parameters or corresponding UE operations are shared among the multiple PDSCHs or PUSCHs on the jointly scheduled cells, referred to as co-scheduled cells.

For example, the UE may use a same PUCCH resource to transmit HARQ-ACK feedback corresponding to the multiple PDSCHs. Therefore, an indication for the same PUCCH resource (and corresponding operations for PUCCH transmission) may be unnecessarily repeated multiple times. In addition, in some scenarios, such as intra-band CA, it is likely that physical channel conditions are correlated, so various scheduling parameters pertaining link adaptation, MIMO/beamforming operation, and even resource allocation can be common and repeated among the co-scheduled cells. Such unnecessary overhead in control signaling can be significant, especially when the number of co-scheduled cells are large, such as 4-8 cells. Last but not least, cyclic redundancy check (CRC) field needs to be repeated multiple times, which incurs significant signaling overhead, especially for large number of co-scheduled cells.

Design of HARQ-ACK codebooks in typical 5G NR systems is based on evaluation of single PDSCH reception on a single serving cell that is individually scheduled by a corresponding DCI format, herein referred to as DCI formats for single-cell scheduling. For example, HARQ-ACK information corresponding to each DCI (in case of TB-based PDSCH reception) is 1 or 2 bits, depending on whether a corresponding PDSCH includes 1 or 2 transport blocks (TBs). For a Type-2 or “dynamic” HARQ-ACK CB, definition of downlink assignment index (DAI) aims to detect missed DCIs, so each DAI refers to a single DCI and a single corresponding PDSCH. Other HARQ-ACK design aspects, such as total DAI in UL DCI formats and HARQ timeline evaluations, rely on the same assumption for single-cell scheduling.

When the UE is configured multiple sets of cells for multi-cell scheduling, the UE needs to determine how to generate the HARQ-ACK codebook, such as Type-2 HARQ-ACK codebook, since different DCI formats corresponding to different sets of cells can trigger different number of HARQ-ACK information bits. Therefore, there is a need to determine a number of Type-2 sub-codebooks (sub-CBs) in association with the sets of cells for multi-cell scheduling.

In addition, when a HARQ-ACK codebook include multiple Type-2 sub-CBs, the UE needs to operate with separate counter/total DAIs in DL DCI formats for each sub-CB. In addition, an UL DCI format can provide a DAI value to be used instead of a total DAI in a last monitoring occasion, so the UE needs to determine an association between the DAI value in the UL DCI format with different Type-2 sub-CBs.

Furthermore, when a number of UCI bits is no larger than 11 bits, a Reed-Muller coding scheme would be applicable to the UCI (rather than the Polar coding used for UCI having more than 11 bits). Therefore, there is a need to determine a number of HARQ-ACK information bits for the case of UCI bits not exceeding 11 bits.

The present disclosure provides methods and apparatus for acknowledgment information with one or multiple set of cells for multi-cell scheduling.

One motivation for multi-cell scheduling using a single DCI format is enhanced cross-carrier scheduling operation for larger number of cells, such as 4-8 cells, operating in an intra-band CA framework in frequency bands below 6 GHz or above 6 GHz, referred to as FR1 or FR2, respectively.

In general, the embodiments apply to any deployments, verticals, or scenarios including inter-band CA with fragmented spectrum in frequency domain, with enhanced mobile broadband (eMBB), ultra reliable low latency communications (URLLC) and industrial internet of things (IIoT) and extended reality (XR), massive machine-type communications (mMTC) and IoT, with sidelink/V2X communications, with multi-TRP/beam/panel, in unlicensed/shared spectrum (NR-U), for non-terrestrial networks (NTN), for aerial systems such as unmanned aerial vehicles (UAVs) such as drones, for private or non-public networks (NPN), for operation with reduced capability (RedCap) UEs, and so on.

Embodiments of the disclosure for HARQ-ACK codebook design in presence of multiple sets of cells for multi-cell scheduling are summarized in the following and are fully elaborated further herein. Combinations of the embodiments are also applicable, but they are not described in detail for brevity.

In one embodiment for Multi-cell scheduling operation, a UE can be provided a number of sets of co-scheduled cells by higher layers. The term set of co-scheduled cells is used to refer to a set of serving cells wherein the UE can be scheduled PDSCH receptions or PUSCH transmissions on two or more cells from the set of co-scheduled cells by a single DCI format, or by using complementary methods such as those described in one or more embodiments herein. Additionally, the UE can be indicated via a DCI format in a PDCCH or via a MAC CE in a PDSCH a subset of a set of co-scheduled cells, wherein cells of the subset can change across different PDCCH monitoring occasions, for example, as indicated by a corresponding DCI format.

In another embodiment for various mechanisms for multi-cell scheduling, the UE can distinguish a single-cell scheduling DCI format from a multi-cell scheduling DCI format via various methods, such as a DCI format size, or a radio network temporary identifier (RNTI) used for scrambling a CRC of a DCI format for multi-cell scheduling, or by an explicit indication by a field in the DCI format, or by a dedicated CORESET and associated search space sets.

In another embodiment for PDCCH monitoring for multi-cell scheduling, the UE can distinguish a single-cell scheduling DCI format from a multi-cell scheduling DCI format via various methods, such as a DCI format size, or an RNTI used for scrambling a CRC of a DCI format for multi-cell scheduling, or by an explicit indication by a field in the DCI format, or by a dedicated CORESET and associated search space sets. There can be two cases for monitoring a DCI format for multi-cell scheduling: a first case based on search space set(s) dedicated to multi-cell scheduling, and a second case based on search space set(s) shared by both single-cell scheduling and multi-cells scheduling.

In another embodiment for general evaluation for HARQ-ACK codebook for multi-cell scheduling, a UE configured with multi-cell scheduling for a set of co-scheduled cells expects that cells in the set of co-scheduled cells belong to a same PUCCH group, and also that the UE is provided configuration for a HARQ-ACK codebook, such as Type-1 or Type-2 codebook. HARQ codebook generation for multi-cell scheduling can depend on configuration of a TDRA table, a set of K0 values, and/or a set of K1 values provided for multi-cells scheduling. The UE can be provided a dedicated TDRA/K0/K1 configuration for multi-cell scheduling for a set of co-scheduled cells or for cells with multi-cell scheduling configuration, or the UE can implicitly determine a TDRA/K0/K1 configuration for multi-cell scheduling based on intersection (or union) of corresponding configurations for single-cell scheduling among the set of co-scheduled cells. A value of K0 can be with respect to (w.r.t.) an SCS configuration of a corresponding serving cell or w.r.t. a reference SCS configuration such as a largest SCS configuration among the set of co-scheduled cells. A value of K1 can be w.r.t. an SCS configuration of a corresponding cell with PUCCH configuration (such as the PCell).

In another embodiment for Generation of a separate Type-2 sub-CB for DCI formats scheduling a single cell and multiple separate Type-2 sub-CBs for DCI formats scheduling multiple cells corresponding to more than one sets of cells for multi-cell scheduling is discussed.

In one embodiment, for a UE configured with more than one sets of cells for multi-cell scheduling of PDSCHs, the UE can generate a first Type-2 sub-CB for DCI formats scheduling a single cell or triggering a single bit for HARQ-ACK information per DCI format, and multiple second Type-2 sub-CBs for DCI formats that schedule more than one cell. The multiple second Type-2 sub-CBs can have a one-to-one or one-to-many association with the more than one sets of cells for multi-cell scheduling. The multiple second Type-2 sub-CBs include a number of HARQ-ACK information bits based on a number of TBs configured for the cell combinations that are configured for the associated sets of cells for multi-cell scheduling. The counter/total DAI in downlink DCI formats as well as the DAI in uplink DCI formats increment based on a number of DCI formats (for example, rather than a number of PDSCHs or TBs that trigger the HARQ-ACK information bits). Accordingly, the UE can operate with a first counter/total DAI corresponding to DCI formats scheduling a single cell or triggering a single bit for HARQ-ACK information, and multiple second counter/total DAIs corresponding to multi-cell scheduling DCI formats, from the more than one sets of cells, that schedule more than one cell. Similar, the UE can operate with a DAI field in uplink DCI formats that provide first bits/value corresponding to DCI formats scheduling a single cell or triggering a single bit for HARQ-ACK information, and multiple second bits/values corresponding to multi-cell scheduling DCI formats, from the more than one sets of cells, that schedule more than one cell. An UL DCI format can include DAI values for Type-2 sub-CBs or only for one or some Type-2 sub-CBs. When applicable, the UE can determine a last DCI format separately for each set of cells or for each Type-2 sub-CB, or jointly across a number/sets of cells or Type-2 sub-CBs. The UE determines missed DCI formats based on values of the total DAI fields provided in downlink DCI formats or based on bits/values provided in DAI fields in uplink DCI formats, and inserts a corresponding number of negative acknowledgment (NACK) bits for the missed DCI formats in a respective Type-2 sub-CB. The UE generates a Type-2 HARQ-ACK CB (for transmission in a PUCCH or PUSCH) by concatenating the first Type-2 sub-CB and the multiple Type-2 sub-CBs in ascending order of the sets of cells.

In another embodiment, generation of multiple separate Type-2 sub-CB for DCI formats scheduling a single cell and multiple separate Type-2 sub-CBs for DCI formats scheduling multiple cells corresponding to more than one sets of cells for multi-cell scheduling is discussed.

In one embodiment, for a UE configured with one or more than one sets of cells for multi-cell scheduling of PDSCHs, the UE can generate multiple first Type-2 sub-CBs for DCI formats scheduling a single cell or triggering a single bit for HARQ-ACK information per DCI format, and multiple second Type-2 sub-CBs for DCI formats that schedule more than one cell. The multiple first Type-2 sub-CBs can have a one-to-one mapping with a number of HARQ-ACK information bits (such as two first sub-CBs corresponding to one or two HARQ-ACK information bits) or can have a same association with the one or more than one sets of cells for multi-cell scheduling, according to one or more embodiments described herein, including any cells that do not belong to any set of cells for multi-cell scheduling. The UE generates the multiple second Type-2 sub-CBs according to one or more embodiments described herein. The counter/total DAI in downlink DCI formats as well as the DAI in uplink DCI formats increment based on a number of DCI formats (for example, rather than a number of PDSCHs or TBs that have triggered the HARQ-ACK information bits). Accordingly, the UE can operate with multiple first counter/total DAIs corresponding to DCI formats scheduling a single cell or triggering a single bit for HARQ-ACK information, and multiple second counter/total DAIs corresponding to multi-cell scheduling DCI formats, from the more than one sets of cells, that schedule more than one cell. Similar, the UE can operate with a DAI field in uplink DCI formats that provide multiple first bits/values corresponding to DCI formats scheduling a single cell or triggering a single bit for HARQ-ACK information, and multiple second bits/values corresponding to multi-cell scheduling DCI formats, from the more than one sets of cells, that schedule more than one cell. An UL DCI format can include DAI values for Type-2 sub-CBs or only for one or some Type-2 sub-CBs. When applicable, the UE can determine a last DCI format separately for each set of cells or each Type-2 sub-CB, or jointly across a number/sets of cells or Type-2 sub-CBs. The UE determines missed DCI formats based on values of the counter/total DAI fields provided in downlink DCI formats or based on bits/values provided in the DAI field in uplink DCI formats, and inserts a corresponding number of NACK bits for the missed DCI formats in a respective Type-2 sub-CB. The UE generates a Type-2 HARQ-ACK CB (for transmission in a PUCCH or PUSCH) by concatenating the multiple first Type-2 sub-CBs in ascending order of the number of HARQ-ACK information bits or the order of the sets of cells and the multiple Type-2 sub-CBs in ascending order of the sets of cells.

In another embodiment, generation of a separate Type-2 sub-CB for DCI formats scheduling a single cell and a single separate Type-2 sub-CB for DCI formats scheduling multiple cells across different sets of cells for multi-cell scheduling is discussed.

In one embodiment, for a UE configured with more than one sets of cells for multi-cell scheduling of PDSCHs, the UE can generate a first Type-2 sub-CB for DCI formats scheduling a single cell or triggering a single bit for HARQ-ACK information per DCI format, and a (single) second Type-2 sub-CB for DCI formats that schedule more than one cell. The second Type-2 sub-CB corresponds to (all) different sets of cells for multi-cell scheduling. The second Type-2 sub-CBs includes a number of HARQ-ACK information bits based on a number of TBs configured for the cell combinations that are configured across different sets of cells for multi-cell scheduling in a PUCCH group. The counter/total DAI in downlink DCI formats as well as the DAI in uplink DCI formats increment based on a number of DCI formats (for example, rather than a number of PDSCHs or TBs that trigger the HARQ-ACK information bits). Accordingly, the UE can operate with a first counter/total DAI corresponding to DCI formats scheduling a single cell or triggering a single bit for HARQ-ACK information, and a second counter/total DAI corresponding to multi-cell scheduling DCI formats, from the more than one sets of cells, that schedule more than one cell. Similar, the UE can operate with a DAI field in uplink DCI formats that provide a first value corresponding to DCI formats scheduling a single cell or triggering a single bit for HARQ-ACK information, and a second value corresponding to multi-cell scheduling DCI formats, from the more than one sets of cells, that schedule more than one cell. An UL DCI format can include DAI values for both Type-2 sub-CBs or only for one Type-2 sub-CB. The UE determines missed DCI formats based on values of the total DAI fields provided in downlink DCI formats or based on bits/values provided in DAI fields in uplink DCI formats, and inserts a corresponding number of NACK bits for the missed DCI formats in a respective Type-2 sub-CB. The UE generates a Type-2 HARQ-ACK CB (for transmission in a PUCCH or PUSCH) by concatenating the first Type-2 sub-CB and the second Type-2 sub-CB.

In another embodiment, separate HARQ-ACK codebook types for single-cell scheduling and multi-cell scheduling DCI formats is discussed.

In one embodiment, a UE can be configured a first HARQ-ACK codebook type for first DCI formats, such as for a Type-1 codebook for single-cell scheduling DCI formats, and a second HARQ-ACK codebook type for second DCI formats, such as a Type-2 codebook for multi-cell scheduling DCI formats. The UE can transmit a PUCCH or PUSCH that includes only one HARQ-ACK codebook with one HARQ-ACK codebook type, or the UE can concatenate the two HARQ-ACK codebooks that are of different HARQ-ACK codebook and transmit the two codebooks in a same PUSCH or PUCCH.

In another embodiment, separate spatial bundling type for single-cell scheduling and multi-cell scheduling DCI formats is discussed.

In one embodiment, a UE can be configured a first information element (IE) providing a first type of spatial bundling of HARQ-ACK information in PUSCH/PUCCH for first DCI formats and a second IE providing a second type of spatial bundling of HARQ-ACK information in PUSCH/PUCCH for second DCI formats. For example, the ULE can be configured to provide HARQ-ACK information without spatial bundling for the two TBs of a PDSCH that is scheduled by a single-cell scheduling DCI format, and to provide HARQ-ACK information with spatial bundling for the two TBs of a PDSCH that is scheduled by a multi-cell scheduling DCI format. Such design can be beneficial, for example, to reduce a size of the HARQ-ACK CB.

In another embodiment, a Number of HARQ-ACK bits for PUCCH power control is discussed.

In one embodiment, when a UE transmits a PUCCH with a UCI that is no larger than 11 bits, the UE determines a number of HARQ-ACK information bits as n_{HARQ-ACK}=n_{HARQ-ACK,TB}+n_{HARQ-ACK,Multi-Cell}, wherein n_{HARQ-ACK,TB} is based on a number of HARQ-ACK information bits in a first sub-codebook, such as for single-cell scheduling DCI formats, and n_{HARQ-ACK,Multi-Cell} is based on a number of HARQ-ACK information bits in a second sub-codebook, such as for multi-cell scheduling. For example, the UE generates a single Type-2 sub-CB across different sets of cells for multi-cell scheduling, as provided in one or more embodiments described herein.

In another embodiment, HARQ-ACK generation based on advanced UE capability for multiple MAC DCIs (MC-DCIs) per cell or per set of cells per MO is discussed.

In one embodiment, when a UE indicates a capability for HARQ-ACK generation based on processing more than one unicast DL MC-DCI 1_3 per cell or per set of cells configured for multi-cell scheduling in a same PDCCH monitoring occasion (MO) or in a same slot of the scheduling cell, the UE counts the cell or the set of serving cells a number

$${N}_{M C - D C I}^{M O}$$

times in each PDCCH MO index ‘m’ in a pseudo-code for Type-2 HARQ-ACK codebook generation, wherein

$${N}_{M C - D C I}^{M O}$$

is the number of unicast DL MC-DCI 1_3 that the UE can process in a same MO or slot. Accordingly, the cell or the set of serving cells can be checked a corresponding number of times for MC-DCIs that can schedule the cell or the set of serving cells in a corresponding PDCCH MO index ‘m’, and the UE can generate a corresponding number of sets of HARQ-ACK information bits if the UE has processed multiple MC-DCIs for the same cell or the same set of cells in the corresponding MO.

In another embodiment, HARQ-ACK skipping in case of BWP change is discussed.

In one embodiment, when a UE is provided an MC-DCI format 1_3 in a PDCCH, and the MC-DCI format 1_3 schedules first PDSCHs on first cells from a set of cells, and the UE receives the PDCCH in a monitoring occasion (MO)/slot that is before a BWP change event, the UE can skip the HARQ-ACK information corresponding to one or more or PDSCHs from the first PDSCHs. Herein, the BWP change event can include change for one or more of: an active DL BWP of a cell from the first cells, an active DL BWP of a cell from the set of cells, active DL BWPs of cells from the first cells, active DL BWPs of cells from the set of cells, active UL BWP of PCell or primary secondary cell (PSCell) or PUCCH-SCell or secondary PUCCH-SCell (sPUCCH-SCell). For example, the UE can skip the HARQ-ACK information corresponding to the cell with a change of the active DL BWP. For example, the UE can skip the HARQ-ACK information for cells from the first (co-scheduled) cells when there is a change of active DL BWP for each cell from the first cells or when there is a change of active DL BWP for at least one cell from the first cells.

In another embodiment, HARQ-ACK for unified TCI state indication is discussed.

In one embodiment, when a UE applies unified TCI states indicated by an MC-DCI format 1_3 for cells that are not scheduled respective PDSCH by the DCI format 1_3, the UE can generate a predetermined ACK value to acknowledge the reception of the DCI format 1_3 for indication of the unified TCI state.

Throughout the present disclosure, the term “configuration” or “higher layer configuration” and variations thereof (such as “configured” and so on) are used to refer to one or more of: a system information signaling such as by a MIB or a SIB (such as SIB1), a common or cell-specific higher layer/RRC signaling, or a dedicated or UE-specific or BWP-specific higher layer/RRC signaling.

Various embodiments are described in terms of multiple PDSCHs or multiple PUSCHs that are jointly scheduled on multiple serving cells, such as a subset/set of cells from among one or more sets of co-scheduled cells.

The embodiments are generic and can apply to various other scenarios such as when a UE is jointly scheduled to receive/transmit multiple PDSCHs/PUSCHs:
from/to multiple transmission-reception points (TRPs) or other communication entities, such as multiple distributed units (DUs) or multiple remote radio heads (RRHs) and so on, for example, in a distributed MIMO operation, wherein TRPs/DUs/RRHs can be associated with one or more cells; or
in multiple time units, such as multiple slots or multiple transmission time intervals (TTIs); or
on multiple BWPs associated with one or more cells/carriers/TRPs, including multiple BWPs of a single serving cell/carrier for a UE with a capability of reception/transmission on multiple active BWPs; or
on one or more TRPs/cells, wherein the UE can receive/transmit more than one PDSCH/PUSCH on each co-scheduled TRP/cell; or
for multiple transport blocks (TBs), or for multiple codewords (CWs) corresponding to single TB or multiple TBs; or
for multiple semi-persistently scheduled PDSCHs (SPS PDSCHs) or for multiple configured grant PUSCHs (CG PUSCHs) that are jointly activated on one or multiple TRPs/cells.

Accordingly, any reference to “co-scheduled cells” can be replaced with/by “co-scheduled TRPs/DUs/RRHs”, or “co-scheduled slots/TTIs”, or “co-scheduled BWPs”, or “co-scheduled PDSCHs/PUSCHs”, or “co-scheduled TBs/CWs”, or “co-scheduled SPS-PDSCHs/CG-PUSCHs”, and so on. Similar for other related terms, such as “multi-cell scheduling”, and so on.

Various embodiments provide reception of multiple PDSCHs or transmission of multiple PUSCHs on respective cells, including carriers of a same cell such as on an UL carrier (also referred to as, a normal UL (NUL) carrier) or a supplemental UL (SUL) carrier. The embodiments also apply to cases where scheduling is for a mixture of PDSCHs and PUSCHs. For example, the UE can receive first PDSCHs on respective first cells and can transmit second PUSCHs on respective second cells, wherein the first PDSCHs and the second PUSCHs are jointly scheduled.

In various embodiments, the phrase “a UE configured with multi-cell scheduling” refers to a UE that is configured joint scheduling for at least one set of co-scheduled cells.

In various embodiments, the phrase “scheduled PDSCH” refers to a PDSCH that is scheduled/indicated by a DCI format, regardless of whether the PDSCH is received or not yet.

A UE can be provided a number of sets of co-scheduled cells by higher layers. The term set of co-scheduled cells is used to refer to a set of serving cells wherein the UE can be scheduled PDSCH receptions or PUSCH transmissions on two or more cells from the set of co-scheduled cells by a single DCI format, or by using complementary methods according to one or more embodiments described herein. Additionally, the UE can be indicated via a DCI format in a PDCCH or via a MAC CE in a PDSCH a subset of a set of co-scheduled cells, wherein cells of the subset can change across different PDCCH monitoring occasions, for example, as indicated by a corresponding DCI format.

In one example, multi-cell scheduling can also include operations related to DL/UL transmissions such as reporting HARQ-ACK information, beam/CSI measurement or reporting, transmission or reception of UL/DL reference signals, and so on.

In one example, the UE can be configured by higher layers, such as by a UE-specific RRC configuration, a number of sets of co-scheduled cells. For example, the UE can be configured a first set of cells, such as {cell #0, cell #1, cell #4, cell #7} and a second set {cell #2, cell #3, cell #5, cell #6}. The multiple sets of co-scheduled cells can be scheduled from a same scheduling cell or from different scheduling cells.

In one example, a set of co-scheduled cells can include a primary cell (PCell/PSCell) and one or more SCells. In another example, a set of co-scheduled cells can include only SCells. In one example, a scheduling cell can belong to a set of co-scheduled cells. In another example, the UE does not expect that a scheduling cell belongs to a set of co-scheduled cells.

In one example, per specifications of the system operation, a set of co-scheduled cells is defined as a set that includes scheduled cells having a same scheduling cell, and additional higher layer configuration is not required for indication of the set of co-scheduled cells. Accordingly, a DCI format for multi-cell scheduling, or other complementary methods, can jointly schedule any number of scheduled cells that have a same scheduling cell.

In another example, a set of co-scheduled cells can have two or more scheduling cells. For example, a UE can receive a DCI format for scheduling multiple co-scheduled cells on a first scheduling cell in a first PDCCH monitoring occasion, or on a second scheduling cell in a second PDCCH monitoring occasion. The DCI format can be associated with any search space set or can be restricted to be associated with UE-specific search space (USS) sets. For example, the DCI format can be associated with multicast scheduling and have CRC scrambled by a group RNTI (G-RNTI) and PDCCH candidates monitored according to common search space (CSS) sets, or can be associated with unicast scheduling and have CRC scrambled by a C-RNTI and PDCCH candidates monitored according to USS sets. Such PDCCH monitoring from two scheduling cells can be simultaneous, for example in a same span of symbol or in a same slot, or can be non-overlapping, such as in different slots (per higher layer configuration, or per indication in a PDCCH or via a MAC CE). The UE may or may not expect that both the first scheduling cell and the second scheduling cell can schedule, through PDCCH transmissions in a same time interval such as a span or a slot, transmissions or receptions on a same cell. The UE can also monitor PDCCH for detection of a DCI format providing scheduling only on one cell from the set of co-scheduled cells (single-cell scheduling DCI format).

A UE can report one or more of: a maximum number of sets of co-scheduled cells, or a maximum number of cells within a set of co-scheduled cells, or a maximum total number of co-scheduled cells across different sets, or a maximum number of co-scheduled cells per PDCCH monitoring occasion, as capability to the gNB. In one example, that capability can depend on an operating frequency band or on a frequency range such as above or below 6 GHz.

Multi-cell scheduling can be an optional UE feature with capability signaling that can additionally be separate for PDSCH receptions and for PUSCH transmissions. For example, a UE can report a capability for a maximum number of {2, 4, 8, 16} co-scheduled cells for the DL and a maximum of {2, 4} co-scheduled cells for the UL.

A UE can also be configured a number of cells that do not belong to any of set of co-scheduled cells. For example, the UE can be configured a cell #8 that does not belong to either the first set or the second set of co-scheduled cells in the previous example.

In one example, restrictions can apply for co-scheduled cells and a UE can expect that co-scheduled cells in a corresponding set:
have a same numerology (SCS configuration and cyclic prefix (CP)); or
have a same numerology for respective active DL/UL BWPs; or
have a same duplex configuration, for example, cells have frequency division duplexing (FDD) configuration or cells have TDD configuration and, in case of a TDD configuration, also have a same UL-DL configuration; or
are within a same frequency band (intra-band CA).

A serving cell can belong only to a single set of co-scheduled cells so that the sets of co-scheduled cells do not include any common cell, or can belong to multiple sets of co-scheduled cells to enable larger scheduling flexibility to a serving gNB. For example, a serving cell can belong to a first set of co-scheduled cells and to a second set of co-scheduled cells, when cells in the first and second sets of co-scheduled cells have a common feature such as a common numerology, duplex configuration, operating frequency band/range, and so on. Also, a serving cell can belong to both a first set of co-scheduled cells and to a second set of co-scheduled cells, when the serving cell has a first common feature with cells in the first set of co-scheduled cells and a second common feature with cells in the second set of co-scheduled cells, wherein the first common feature can be different from the second common feature.

In a first approach, a UE expects to be provided multi-cell scheduling for cells in a set of co-scheduled cells. For example, for a first set of co-scheduled cells including cells {cell #0, cell #1, cell #4, cell #7}, a DCI format schedules PDSCH receptions or PUSCH transmissions on four cells in the first set of co-scheduled cells {cell #0, cell #1, cell #4, cell #7}.

In a second approach, the UE can be provided multi-cell scheduling for a subset of a set of co-scheduled cells. For example, a DCI format can schedule PDSCH receptions or PUSCH transmissions on only two cells, such as {cell #0, cell #4}, from the first set of cells.

In a first option for the second approach, the subset of cells can be indicated by a MAC CE. Such a MAC CE command can include one or more of: an indication for activation or deactivation/release of a subset of cells; an indication for a number of sets of co-scheduled cells; or an indication for a number of subsets of co-scheduled cells from a corresponding number of sets of co-scheduled cells.

For example, a MAC CE activates a first subset of a set of co-scheduled cells and subsequent DCI format(s) for multi-cell scheduling apply to the first subset of cells activated by the MAC CE. The UE can receive another MAC CE command that deactivates the first subset of co-scheduled cells, or activates a second subset of co-scheduled cells, wherein the second subset can be a subset of the same set of co-scheduled cells or a subset of a different set of co-scheduled cells. If a UE receives a MAC CE that deactivates the first subset of co-scheduled cells, but does not activate a second subset of co-scheduled cells, in one alternative, the UE does not expect to receive a DCI format for multi-cell scheduling, and the UE may not monitor PDCCH according to respective search space sets, until the UE receives a new MAC CE that activates a second subset of co-scheduled cells. In another alternative, the UE can receive DCI format(s) for multi-cell scheduling even before receiving a new MAC CE that activates a second subset of co-scheduled cells, but the UE expects to be provided an indication for a subset of co-scheduled cells by the DCI format(s), or by using complementary methods according to one or more embodiments described herein.

In a second option for the second approach, the subset of the set of co-scheduled cells can be provided by a DCI format in a PDCCH/PDSCH. The subset of cells can change between PDCCH monitoring occasions (MOs) for PDSCH/PUSCH scheduling as indicated by a corresponding DCI format. For example, a first DCI format in a first PDCCH MO indicates scheduling on a first subset of cells, while a second DCI format in a second PDCCH MO indicates scheduling on a second subset of cells.

In a first example, a DCI format for multi-cell scheduling provides an index for a subset of cells that are co-scheduled such as a CIF value that corresponds to a subset of one or more cells from a set of co-scheduled cells. For example, UE-specific RRC signaling can indicate first/second/third/fourth indexes and corresponding first/second/third/fourth subsets that include one or more cells from a set of co-scheduled cells, wherein a subset can also include cells from the set of co-scheduled cells. Then, a CIF field of 2 bits in a DCI format can provide a value that indicates the subset of scheduled cells.

In a second example, a DCI format can include a 1-bit flag field to indicate whether the DCI format is for single-cell scheduling or for multi-cell scheduling in order for a UE to accordingly interpret fields of the DCI format that may also include the CIF field. Then, for single-cell scheduling, the CIF field can be interpreted as in case of single-cell cross-carrier scheduling while for multi-cell scheduling the CIF field can be interpreted as indicating a subset from the set of co-scheduled cells.

In a third example, a DCI format for multi-cell scheduling provides a number of co-scheduled cells, and the indexes of the co-scheduled cells are provided by additional methods, such as by an additional DCI format (or an additional part/stage of a same DCI format) or by higher layer signaling according to one or more embodiments described herein.

In a fourth example, a CIF field in a DCI format for multi-cell scheduling can be a bitmap mapping to the individual cells or subsets of cells from the set of co-scheduled cells. When the DCI format is applicable to cells in the set of co-scheduled cells, the DCI format may not include a CIF.

In a third option for the second approach, a UE (e.g., the UE 116) can implicitly determine indexes for co-scheduled cells without need for explicit gNB (e.g., the BS 102) indication. For example, the UE can determine indexes for co-scheduled cells based on a PDCCH monitoring parameter, such as:
a CORESET index; or
a search space set index, or a carrier indicator parameter n_CI corresponding to the search space set index; or
a set of CCEs in the search space set or a first/last CCE in the search space set; where the UE received a PDCCH providing the DCI format for multi-cell scheduling.

According to the third option, the UE can be configured a mapping among values for PDCCH monitoring parameters, such as search space sets, and a number of co-scheduled cells or indexes of the co-scheduled cells. In one example, first and second values for parameter n_CI in a search space set can respectively indicate first and second subsets of co-scheduled cells. According to this example, the parameter n_CI can correspond to a single cell or can correspond to a group of cells, such as a subset/set of co-scheduled cells.

Receptions or transmissions on a respective subset of cells that are jointly scheduled by a single DCI format, or by using complementary methods according to one or more embodiments described herein, can refer to PDSCHs or PUSCHs that may or may not overlap in time. For example, the UE can be indicated to receive PDSCHs or to transmit PUSCHs on respective co-scheduled cells wherein receptions/transmissions are in a same slot or at least one reception/transmission is in a different slot than the remaining ones.

A UE that is configured for multi-cell scheduling can be provided a first set of cell-common parameters whose values apply for scheduling on co-scheduled cells, and a second set of cell-specific parameters whose values apply for scheduling on each corresponding co-scheduled cell. The UE can determine cell-common and cell-specific scheduling information parameters based on the specifications of the system operation, or based on higher layer configuration. For some cell-specific scheduling information parameters, the UE can be provided differential values compared to a reference value wherein the reference value can correspond, for example, to a first scheduled cell from a set of scheduled cells.

For a UE that is configured a number of sets of co-scheduled cells, a DCI format for multi-cell scheduling can provide complete or partial information for cell-common or cell-specific scheduling parameters, for multiple PDSCH receptions or multiple PUSCH transmissions on respective multiple co-scheduled cells. When the DCI format for multi-cell scheduling provides partial information for a scheduling parameter, the UE can determine remaining information from UE-specific RRC signaling or by other complementary methods.

The UE can distinguish a single-cell scheduling DCI format from a multi-cell scheduling DCI format via various methods, such as a DCI format size, or an RNTI used for scrambling a CRC of a DCI format for multi-cell scheduling, or by an explicit indication by a field in the DCI format, or by a dedicated CORESET and associated search space sets.

For a UE that is configured a set of co-scheduled cells, a DCI format for multi-cell scheduling can provide full or partial information for values of cell-common and cell-specific fields for scheduling PDSCH receptions or PUSCH transmissions on respective two or more cells from the set of co-scheduled cells. When the DCI format provides partial information, the UE can determine remaining information from RRC signaling or by using other complementary methods.

In a first approach, referred to as concatenated DCI format for multi-cell scheduling, a DCI format for multi-cell scheduling can provide separate values of fields for each of the multiple co-scheduled cells. A first value corresponds to a first cell, a second value corresponds to a second cell, and so on. Therefore, DCI format fields for the multiple cells are concatenated, thereby referring to such DCI format as a concatenated DCI format for multi-cell scheduling. This approach can be beneficial, for example, for co-scheduling cells that have different channel characteristics or configurations, such as for inter-band CA operation, or for co-scheduling a PDSCH reception and a PUSCH transmission.

In a second approach, referred to as multi-cell scheduling via multi-cell mapping, a UE can be provided information for multi-cell scheduling of multiple PDSCHs/PDCCHs on multiple respective cells using a multi-cell mapping, wherein a field in a DCI format can be interpreted to provide multiple values for a corresponding scheduling parameter for the multiple co-scheduled cells. Such interpretation can be based on a configured one-to-many mapping/table or based on multiple configured offset values for respective cells that are applied to a reference value indicated by the DCI format. For example, the field can be an MCS field wherein a value indicated in the DCI format can be for a PDSCH reception on a first cell and a value for a PDSCH reception on a second cell can be determined from the first value and a configured offset value. This approach can be beneficial, for example, for co-scheduling cells that have several similar physical channel characteristics or configurations, such as for intra-band CA operation.

In a third approach, referred to as single-cell DCI pointing to a PDSCH with multi-cell scheduling, a UE can be provided information for multi-cell scheduling using a single-cell scheduling DCI format, namely a DCI format that schedules a first PDSCH on a first cell, wherein the first PDSCH includes scheduling information for reception of second PDSCH(s) or transmission of second PUSCH(s) on a subset from one or more sets of co-scheduled cells. This approach can be beneficial, for example, for co-scheduling several (such as 4-8) cells that have different channel characteristics or configurations, such as for inter-band CA operation.

In a first option for the third approach, the first PDSCH includes a MAC CE that provides scheduling information for the number of PDSCH(s) or PUSCH(s). Accordingly, the MAC CE can include a number of modified DCIs (M-DCIs), wherein each M-DCI includes full or partial scheduling information for a PDSCH/PUSCH from the number of PDSCH(s)/PUSCH(s).

In a second option for the third approach, multi-cell scheduling information is multiplexed as M-DCI in a PDSCH. The UE receives a first PDSCH that is scheduled by a single-cell scheduling DCI format, and the UE receives additional scheduling information for one or more PDSCH(s)/PUSCH(s) on one or more respective co-scheduled cell(s). The UE allocates the coded modulation symbols for M-DCIs to time/frequency resources within the first PDSCH, for example in a frequency-first, time-second manner, except for reserved resources corresponding to reference signals or other cell-level broadcast transmissions. The UE can start receiving the M-DCIs in a first symbol of the first PDSCH, or in a first symbol after first symbols with DM-RS REs, in the first PDSCH. The M-DCIs can be jointly coded and include a single CRC.

In the second option, physical layer processing of M-DCI(s) that are included in the first PDSCH can be same as that for a DCI in a PDCCH, such as for the DCI scheduling the first PDSCH, or can be same as that for data information/transport block in the first PDSCH. For example, physical layer processing refers to, for example, modulation, coding, scrambling, and so on. In addition, the UE can determine a number of coded modulation symbols corresponding to multi-scheduling information, such as M-DCIs, that are multiplexed in a first PDSCH scheduled by a single-cell scheduling DCI format, based on a scaling factor

$${β}_{offset}^{P D S C H} = {β}_{offset}^{M - DCI}$$

applied to a total (coded) payload size for the M-DCIs. Such scaling factor determines an effective channel coding rate of M-DCIs multiplexed on the first PDSCH, for flexible link adaptation and improved reliability of the M-DCIs according to physical channel conditions.

In a fourth approach, referred to as multi-stage PDCCHs/DCIs for multi-cell scheduling, a UE can be provided information for multi-cell scheduling of multiple PDSCHs/PDCCHs on multiple respective cells using a multi-stage DCI method, such as a 2-stage DCI wherein a first-stage DCI format includes a set of cell-common fields, and a second-stage DCI format includes cell-specific fields. The UE receives the first-stage DCI format in a first PDCCH and the second-stage DCI format in a second PDCCH. This approach can be beneficial, for example, for co-scheduling several cells that have several common physical characteristics, such as a time-domain resource allocation or a frequency-domain resource allocation, without incurring latency and without having a DCI format size that is too large (that would result if the first-stage and second-stage DCI formats were combined into a single DCI format) for receiving cell-specific parameters when the second PDCCH is received in a same slot as the first PDCCH. The first-stage DCI format can also indicate a location for a PDCCH providing the second-stage DCI format, such as a PDCCH candidate for a corresponding CCE aggregation level, so that the UE can interpret the contents of the second-stage DCI format or reduce a number of PDCCH receptions. A UE can determine an association among a number of linked multi-stage PDCCHs/DCIs, such as two PDCCHs/DCIs, that provide multi-cell scheduling information based on parameters of the linked DCI formats, such as size(s) of the DCI format(s), or RNTI(s) associated with the DCI format(s), or by an explicit indication in some field(s) in the DCI format(s), or based on PDCCH monitoring parameters, such as CORESET, search space, CCEs, or monitoring occasions in which the UE receives the first and the second linked PDCCHs.

The UE can distinguish a single-cell scheduling DCI format from a multi-cell scheduling DCI format via various methods, such as a DCI format size, or an RNTI used for scrambling a CRC of a DCI format for multi-cell scheduling, or by an explicit indication by a field in the DCI format, or by a dedicated CORESET and associated search space sets. There can be two cases for monitoring a DCI format for multi-cell scheduling: a first case based on search space set(s) dedicated to multi-cell scheduling, and a second case based on search space set(s) shared by both single-cell scheduling and multi-cells scheduling.

In a first case, a search space set for multi-cell scheduling is associated only with DCI format(s) for multi-cell scheduling on a set of co-scheduled cells. Such search space sets can correspond to a set-level n_CI value, which can be separate from n_CI values corresponding to search space sets for single-cell scheduling. By monitoring the search space set, the UE can detect a DCI format for scheduling on scheduled cells or only a subset of scheduled cells from the set of co-scheduled cells. Accordingly, the detected DCI format can include a CIF value that is same as or different from an n_CI value corresponding to the search space set for multi-cell scheduling. The search space set can be commonly configured, thereby linked, on the scheduling cell and on scheduled cells from the set of co-scheduled cells. The UE can monitor the search space set for multi-cell scheduling when linked search spaces sets on the scheduling cell and at least one scheduled cell from the set co-scheduled cells are configured on corresponding active DL BWPs of the scheduling cell and the at least one scheduled cell.

In a second case, a search space set for multi-cell scheduling is associated with DCI format(s) both for multi-cell scheduling on a set of co-scheduled cells and for single-cell scheduling on a first scheduled cell from the set of co-scheduled cells. Such search space sets correspond to an existing cell-level n_CI value corresponding to the first scheduled cell. By monitoring the search space set, the UE can detect a DCI format for single-cell scheduling on the first scheduled cell with a CIF value that is same as the n_CI value corresponding to the first scheduled cell, or can detect a DCI format for multi-cell scheduling on scheduled cells or only a subset of scheduled cells from the set of co-scheduled cells, with a set-level CIF value that is different from the n_CI value corresponding to the first scheduled cell. The search space set is commonly configured, thereby linked, on the scheduling cell and only the first scheduled cell, and the UE monitors the linked search space sets when both are configured on active DL BWPs of the scheduling cell and the first scheduled cell.

A UE configured with multi-cell scheduling for a set of co-scheduled cells expects that cells in the set of co-scheduled cells belong to a same PUCCH group, and also that the UE is provided configuration for a HARQ-ACK codebook, such as Type-1 or Type-2 codebook. HARQ codebook generation for multi-cell scheduling can depend on configuration of a TDRA table, a set of K0 values, and/or a set of K1 values provided for multi-cells scheduling. The UE can be provided a dedicated TDRA/K0/K1 configuration for multi-cell scheduling for a set of co-scheduled cells, or the UE can implicitly determine a TDRA/K0/K1 configuration for multi-cell scheduling based on intersection (or union) of corresponding configurations for single-cell scheduling among the set of co-scheduled cells. A value of K0 can be with respect to (w.r.t.) an SCS configuration of a corresponding serving cell or w.r.t. a reference SCS configuration such as a largest SCS configuration among the set of co-scheduled cells. A value of K1 can be w.r.t. an SCS configuration of a corresponding cell with PUCCH configuration (such as the PCell).

When a UE is configured two or multiple PUCCH groups, and the UE is also configured with a set of co-scheduled cells, the UE expects that serving cells in the set of co-scheduled cells belong to a same PUCCH group. For example, if a UE is configured a PUCCH-SCell, and a corresponding secondary PUCCH group, the UE expects that serving cells in a configured set of co-scheduled cells belong to either the primary PUCCH group or the secondary PUCCH group, and not both. In another example, if a UE is configured an MCG and an SCG, the UE expects that serving cells in a configured set of co-scheduled cells belong to either the MCG or the SCG, and not both.

A UE configured with multi-cell scheduling expects to be configured a HARQ-ACK codebook, for example using a parameter ‘pdsch-HARQ-ACK-Codebook’. The HARQ-ACK codebook (CB) can be, for example, one of Type-1 CB, also referred to as semi-static CB, or Type-2 CB, also referred to as dynamic CB, or enhanced Type-2 CB, also referred to as enhanced dynamic CB, and so on. Accordingly, the UE does not expect to provide separate HARQ-ACK feedback for each PDSCH from a number of co-scheduled PDSCHs on a set/subset of co-scheduled cells. The UE multiplexes HARQ-ACK feedback information corresponding to the number of co-scheduled PDSCH receptions on a set/subset of co-scheduled cells, based on a HARQ-ACK codebook configuration, and transmits the CB in a same PUCCH resource or multiplexes the CB in a same PUSCH transmission.

In one example, a UE configured with multi-cell scheduling can transmit HARQ-ACK information feedback for a first number of co-scheduled cells on a first PUCCH resource and transmit HARQ-ACK information feedback for a second number of co-scheduled cells on a second PUCCH resource, wherein the first and second number of co-scheduled cells are indicated by a same DCI format. This can be beneficial, for example, for reducing latency of HARQ retransmission for co-scheduled cells.

In one realization, a UE can be configured:
a first group of serving cell that are configured with single-cell scheduling only, and
a second group of serving cells that are configured with multi-cell scheduling only, and
a third group of serving cells that are configured with both single-cell scheduling and multi-cell scheduling.

At least one of the first and second and third groups of serving cells is non-empty. In one example, the second group of serving cells can be empty, so that any serving cell can be configured with single-cell scheduling, while some other serving cells (from the third group) can be additionally configured with multi-cell scheduling.

In one example, the UE expects that a serving cell with multi-cell scheduling is included in only one configured set of co-scheduled cells. Therefore, the UE does not expect to be configured multiple overlapping sets of co-scheduled cells. Accordingly, the UE determines only one TDRA/K0/K1 configuration (for HARQ-ACK codebook generation) for a serving cell with multi-cell scheduling configuration, as described next.

It is noted that, the UE can receive a first DCI format for multi-cell scheduling in a first PDCCH monitoring occasion that indicates joint scheduling for a first subset from the configured set of co-scheduled cells, and receive a second DCI format for multi-cell scheduling in a second PDCCH monitoring occasion that indicates joint scheduling for a second subset from the (same) configured set of co-scheduled cells, wherein the first subset and the second subset can be separate, but with non-empty overlap.

In one example, a DCI format for multi-cell scheduling can indicate scheduling on only a single serving cell, for instance, when the serving cell belongs to the third group of serving cells, per herein. In one example, single-cell scheduling can be provided as a fallback operation for any serving cell that is configured with multi-cell scheduling, without any explicit configuration for single-cell scheduling (that is, no distinction between the second group and third group of serving cells, as herein).

HARQ codebook generation for multi-cell scheduling can depend on configuration of a TDRA table, a set of K0 values, and/or a set of K1 values provided for multi-cells scheduling. Various methods for configuration of TDRA/K0/K1 for multi-cell scheduling is provided herein, and relationships with corresponding configurations for single-cell scheduling is also provided.

In one example, a serving cell that belongs to a set of co-scheduled cells, can be configured a first TDRA table (including a first set of K0 values) or a first set of K1 values for single-cell scheduling, and a second TDRA table (including a second set of K0 values) or a second set of K1 values for multi-cell scheduling, wherein the first TDRA/K0/K1 configuration can be separate from the second TDRA/K0/K1 configuration.

In another example, when a UE is configured a first set and a second set of co-scheduled cells, and a serving cell belongs to both the first set and the second set, the serving cell can be associated with a first TDRA table/K0 set/K1 set corresponding to the first set of co-scheduled cells, and a second TDRA table/K0 set/K1 set corresponding to the second set of co-scheduled cells. Such configurations are beneficial, for example, in order to provide high scheduling flexibility.

In another example, the TDRA/K0/K1 configuration can be simplified, for example, in order to reduce UE complexity or specification efforts. In one realization, a UE can be configured a same TDRA table/K0 set/K1 set for a serving cell, regardless of whether the UE belongs to a single set or multiple sets of co-scheduled cells. In another realization, cells within a same set of co-scheduled cells can be configured a same TDRA table/K0 set/K1 set. In a further realization, cells with multi-cell scheduling configuration, regardless of whether they belong to a same set or different sets of co-scheduled cells, are configured a same TDRA table/K0 set/K1 set.

In yet another example, the UE is not provided any dedicated configuration for TDRA table/K0 set/K1 set for the case of multi-cell scheduling. Instead, the UE implicitly determines an applicable configuration for TDRA table/K0 set/K1 set for multi-cell scheduling based on the corresponding configuration for single-cell scheduling. For example, the UE determines a TDRA table/K0 set/K1 set for multi-cell scheduling on a set of co-scheduled cells based on intersection or union of TDRA tables/K0 sets/K1 sets for single-cell scheduling corresponding to serving cells that belong to the set of co-scheduled cells. According to these example, and when the intersection operation is used, the UE determines that entries of TDRA tables or K0 values or K1 values, configured for a cell from a set of co-scheduled cells, that do not belong to the intersection of TDRA tables/K0 sets/K1 sets, are used only for single-cell scheduling for the corresponding cell.

For example, if K1={0, 1, 2, 3} for a first cell and K1={1, 2, 3, 4} for a second cell, then the UE evaluates:
K1=0 is used only for single-cell scheduling of the first cell; and
K1=4 is only for single-cell scheduling of the second cell; and
K1={1, 2, 3} can be used for both single-cell scheduling and multi-cell scheduling on the first cell and the second cell.

In one example, a TDRA field in a DCI format for multi-cell scheduling can be a cell-common field that commonly applies to co-scheduled cells by the DCI format. Such TDRA field will point to an entry in a TDRA table, wherein the entry includes a K0 value, a start and length indicator value (SLIV), and an indication for a PDSCH mapping type, that applies commonly to co-scheduled PDSCHs on the set/subset of co-scheduled cells. For example, the TDRA table is a TDRA table for multi-cell scheduling that the UE determines based on one of the methods described herein.

In one example, when co-scheduled cells have a common/same SCS, the K0 value determined from the TDRA field of the DCI format for multi-cell scheduling applies commonly to co-scheduled PDSCHSs based on the common SCS value.

In another example, when the co-scheduled cells have different SCSs, the UE applies the K0 value for each PDSCH on each serving cell from the set of co-scheduled cells based on:
an SCS configuration of the corresponding serving cell, or
a largest (or smallest) SCS configuration among the set/subset of co-scheduled cells, or
an SCS configuration of a corresponding scheduling cell, or
an SCS configuration provided by higher layers, or
a predetermined SCS configuration, such as 30 kHz for FR1, and 120 kHz for FR2.

For example, assuming the method in the first bullet point herein is used, if a DCI format jointly schedules PDSCHs on a first cell with SCS=15 kHz and a second cell with SCS=30 kHz, and the DCI format indicates K0=1, the UE determines a slot for a first PDSCH on the first cell with an offset equal to 1 slot w.r.t. SCS=15 kHz, and a slot for a second PDSCH on the second cell with an offset equal to 1 slot w.r.t. SCS=30 kHz, wherein the offsets are w.r.t. a slot where the multi-cell scheduling DCI format ends.

In one example, a TDRA field in a DCI format for multi-cell scheduling can be based on a “multi-cell mapping” to provide cell-specific TDRA for each of the co-scheduled cells. For example, a TDRA table for multi-cell scheduling on a set of [M] serving cells can include a number of entries, wherein each entry includes a number of up to [M] sets of K0/SLIV/mapping types. For each PDSCH from the co-scheduled PDSCHs on a serving cell from the set of co-scheduled cells, the UE applies the set of K0/SLIV/mapping type corresponding to the serving cell, from the number of sets of K0/SLIV/mapping types that is included in the TDRA entry which is indicated by the DCI format for multi-cell scheduling. According to this example, each K0 value provided for each serving cell from the set of co-scheduled cells is w.r.t. an SCS configuration of the corresponding serving cell.

When a DCI format for multi-cell scheduling is a two-stage DCI format with a 2^{nd}-stage DCI provided by a PDSCH or PDCCH, according to one or more embodiments described herein, the UE determines K0 relative to a 2^{nd}-stage DCI, at least for any PDSCHs whose scheduling information is at least partially provided by the 2^{nd}-stage DCI. Accordingly, the UE determines a slot for a PDSCH from co-scheduled PDSCHs to be a slot that is K0 slots from/after a last slot that includes the 2^{nd}-stage DCI format, wherein the UE determines the K0 value and an SCS configuration for determination of K0 slots based on one of the various methods described in the previous examples. In one example, if scheduling information for a first PDSCH from a set of co-scheduled PDSCHs is fully provided in a 1^{st}-stage DCI, the UE determines a slot for the first PDSCH to be a slot that is K0 slots from/after a last slot that includes the 1^{st}-stage DCI format, wherein the UE determines the K0 value and an SCS configuration for determination of K0 slots based on one of the various methods described in the previous examples. For example, the first PDSCH can be a PDSCH in which the 2^{nd}-stage DCI is multiplexed.

In one realization, when a UE is configured with multi-cell scheduling, the UE expects to be provided a single PUCCH resource for transmitting HARQ-ACK information corresponding to co-scheduled PDSCHs on a set of co-scheduled cells.

In one example, a PDSCH-to-HARQ_feedback timing indicator field (K1) in a DCI format for multi-cell scheduling is with respect to a corresponding cell with PUCCH configuration (such as the PCell). For example, the UE determines K1 based on an SCS configuration of the corresponding cell with PUCCH configuration (such as the PCell). According to this example, a K1 timing for transmitting HARQ-ACK information is relative to a last DL slot of a last PDSCH from co-scheduled PDSCHs on a set/subset of co-scheduled cells, w.r.t. a slot/SCS for the cell with PUCCH configuration (such as the PCell). For example, the last PDSCH can refer to a PDSCH that:
ends in a latest slot/symbol, among the co-scheduled PDSCHs, w.r.t. the SCS for the PUCCH cell (such as the PCell), or
corresponds to a cell, among the co-scheduled cells, with a largest cell index or largest CIF, or
corresponds to a cell, among the co-scheduled cells, with a largest (or smallest) SCS, or
corresponds to a cell, among the co-scheduled cells, that is indicated last in the DCI format for multi-cell scheduling, if the DCI format includes an ordered indication for the set of co-scheduled cells.

Supporting K1 relative to a last PDSCH can be beneficial, for example, when the co-scheduled PDSCHs can start in different slots (for example, due to different K0 values) or when the co-scheduled cells have different SCSs.

In another example, a K1 field in a DCI format for multi-cell scheduling can provide a cell-common value that applies commonly to co-scheduled cells. Therefore, the UE applies a same K1 value to each PDSCH from the co-scheduled PDSHCs, wherein the K1 value is w.r.t. the SCS of the cell with PUCCH configuration (such as the PCell). Such operation can be beneficial, for example, when co-scheduled PDSCHs start in a same slot (for example, due to same K0 value), and co-scheduled cells have a same SCS.

In one example, K1 can start from the last DL slot (of a corresponding PDSCH) that overlaps with a PUCCH slot (that corresponds to K1=0). For Type-2, K1 is w.r.t. PCell (cell of PUCCH). If there is a second stage DCI in a PDSCH, the K1 values of those DCIs can be w.r.t. the overlapping slot of the PCell.

In one realization, a UE (e.g., the UE 116) with multi-cell scheduling configuration can be provided with a single value for each of TDRA, K1, and PRI parameters, but the UE interprets the fields separately for each cell from the set of co-scheduled cells, that is, a cell-specific interpretation. For example, based on a single/same indication for TDRA/K0/K1/PRI, the UE determines a first TDRA/K0 value for a first PDSCH with a corresponding HARQ-ACK feedback to be transmitted in a first PUCCH resource and with a slot timing based on a first K1, while the UE determines a second TDRA/K0 value for a second PDSCH with a corresponding HARQ-ACK feedback to be transmitted in a second PUCCH resource and with a slot timing based on a second K1. For example, the first and second values for each of the corresponding TDRA/K0/K1/PRI parameters can be different. Such UE behavior can be realized, for example, based on corresponding configurations for single-cell scheduling, that is, without need for any dedicated configuration(s) for multi-cell scheduling. Construction of Type-1 HARQ-ACK codebooks for such a scenario can follow typical procedure applied to each PDSCH from co-scheduled PDSCHs on the set of co-scheduled cells. Therefore, this realization is not further evaluated in the remainder of the present disclosure.

In one example, a UE can be configured multiple sets of cells for multi-cell scheduling of PDSCHs/PUSCHs by a DCI format 0_3/1_3. For example, each set of cells, from the multiple sets of cells, can include one or more cells. For example, the UE expects that different sets of cells are mutually exclusive, so a cell in a first set of cells cannot be included in a second set of cells. In another example, the UE can be configured two sets of cells that include a same cell. For example, the latter example can be conditioned to occur (only) when the two sets of cells include a same number of cells or correspond to a same maximum number of TBs across different cells or across different cell combinations configured for the set of cells.

For example, the UE can report a capability for a maximum number of sets of cells for multi-cell scheduling. For example, different sets of cells for multi-cell scheduling can correspond to same or different scheduling cell. In one example, each set of cells corresponds to a different scheduling cells, so the UE is configured a single set of cells for each scheduling cell. The latter example can be based on a UE capability that does not support multiple sets of cells for a same scheduling cell. In one example, the UE can be configured a scheduling cell that corresponds to more than one sets of cells. The latter example can be based on a UE capability that supports multiple sets of cells for a same scheduling cell. For example, the UE can report a maximum number of sets of cells that can correspond to each/any scheduling cell.

In one example, when a UE is configured first and second sets of cells for multi-cell scheduling from a same scheduling cell, mixture scheduling among different sets of cells is not supported. For example, a DCI format 0_3/1_3 can schedule PUSCHs/PDSCHs on cells from (only) one set of cells, wherein the UE can determine the one set of cells, for example, based on a cell set indicator field (CSIF or SIF for short) in the DCI format 1_3/0_3. A bit-width of the CSIF is ceil(log 2(N_set)), wherein N_set is a number of sets of cells for multi-cell scheduling associated with a same scheduling cell. For example, a first DCI format 0_3/1_3 can schedule first PUSCHs/PUSCHs on first cells (only) from a first set of cells, and a second DCI format 0_3/1_3 can schedule second PUSCHs/PUSCHs on second cells (only) from a second set of cells. In another example, mixture scheduling among different sets of cells may be supported, for example, subject to UE capability. For example, a DCI format 0_3/1_3 can schedule both first PUSCHs/PDSCHs on first cells from a first set of cells and second PUSCHs/PDSCHs on second cells from a second set of cells. For example, the DCI format 0_3/1_3 can include two CSIF values with a first CSIF value indicating the first set of cells and a second CSIF value indicating the second set of cells.

In one example, when the UE is configured only a single set of cells associated with a scheduling cell, N_set=0, a CSIF is not present in the DCI format 0_3/1_3, and the UE can determine that any DCI format 0_3/1_3 provided by a PDCCH on the scheduling cell corresponds to the single set of cells.

For example, a DCI format 0_3/1_3 can schedule any cell combination (that is, any subset of cells), from a set of cells, and the UE can determine a co-scheduled cell combination based on, for example, a cell-specific field in DCI format 0_3/1_3, such as an frequency domain resource assignment (FDRA) field, that provides separate values for each cell in the set of cells. For example, a DCI format can schedule only cell combinations (that is, only subset of cells), from a set of cells, that is provided by higher layers for the set for the set of cells. For example, the UE can be configured, for the set of cells, a table/list of cell combinations along with corresponding IDs for the respective cell combinations, and a co-scheduled cell combination indicator field in the DCI format 0_3/1_3 indicates a cell combination for scheduling PUSCHs/PDSCHs by providing an ID corresponding to the cell combination. For example, the co-scheduled cell combination indicator field includes ceiling(log 2(N_cell_combo,s)), wherein N_cell_combo,s is a number of configured cell combinations (or a number of corresponding IDs) for a set of cells with set index s. For example, the UE can be configured separate table/list of cell combinations for DCI format 0_3 for scheduling PUSCHs, and for DCI format 1_3 for scheduling PDSCHs. For example, a first set of cells can be configured for DCI format 1_3, and no DCI format 0_3 applies to the set of cells. For example, a second set of cells can be configured for DCI format 03, and no DCI format 1_3 applies to the set of cells. For example, a set of cells can be configured both DCI format 0_3 and DCI format 1_3. For example, the UE expects that sets of cells can be configured both DCI format 0_3 and 1_3.

For example, the UE determines a size of DCI format 0_3 separately for each set of cells for multi-cell scheduling. For example, the UE can determine a first size for a first DCI format 0_3 scheduling PUSCHs on cells from a first set of cells, and a second size for a second DCI format 0_3 scheduling PUSCHs on cells from a second set of cells.

For example, the UE determines a size of DCI format 1_3 separately for each set of cells for multi-cell scheduling. For example, the UE can determine a first size for a first DCI format 1_3 scheduling PDSCHs on cells from a first set of cells, and a second size for a second DCI format 1_3 scheduling PDSCHs on cells from a second set of cells.

In one example, the UE counts sizes of DCI formats 0_3 and 1_3 corresponding to a set of cells towards a DCI size budget (referred to as, the “3+1” rule) for a reference cell from the set of cells. For example, the reference for the set of cells cell can be the scheduling cell when the scheduling cell is included in the set of cells and search space sets of the DCI format 0_X/1_X is configured only on the scheduling cell. For example, when the search space sets of the DCI format 0_X/1_X are configured on a cell from the set of cells, in addition to the scheduling cell, the reference cell can be the cell on which (linked) search space sets of DCI format 0_X/1_X are configured and are associated with the search space sets of the scheduling cell with the same search space IDs. For example, when the scheduling cell is not included in a set of cells, the UE expects to be configured (linked) search space sets of DCI format 0_X/1_X on (only) one cell from the set of cells.

In one example, the UE can determine a first size for a DCI format 0_3 and a second size for a DCI format 1_3, with the first size different from the second size, when both DCI formats 0_3 and 1_3 correspond to a same set of cells. In one example, the UE applies size alignment between DCI formats 0_3 and 1_3 corresponding to a same set of cells when the DCI size budget (“3+1”) on a reference cell is exceeded after applying DCI size alignment to single-cell scheduling DCI formats.

In one example, different sets of cells for multi-cell scheduling can correspond to one or more of the following:
separate n_CI values, wherein an n_CI value for the set of cells is same as a value provided as the cell set indicator field (CSIF or SIF) in the DCI format 0_3/1_3; When multiple sets of cells correspond to a same scheduling cell, the UE expects unique/different n_CI values (equivalently, unique/different CSI values) for each set of cells;
separate search space sets (for example, USS sets) for monitoring one or both of DCI formats 0_3/1_3;
separate reference cells for counting DCI format sizes for DCI formats 0_3/1_3, or for counting a number of PDCCH candidates or non-overlapping CCEs corresponding to (search space sets for monitoring) DCI formats 0_3/1_3.

In one example, when a UE is configured multiple set of cells for multi-cell scheduling from a same or different scheduling cells, the UE can monitor a first PDCCH in a first monitoring occasion (MO) for detection of a first DCI format for multi-cell scheduling and can monitor a second PDCCH in the same MO for detection of a second DCI format for multi-cell scheduling, wherein the first and the second DCI formats correspond to cells from same or different sets of cells.

In one example, the UE can receive first and second PDCCHs on first and second scheduling cells in a same PDCCH monitoring occasion (MO), providing first and second DCI formats for multi-cell scheduling, such as first and second DCI formats 1_3, that schedule first PDSHCs and second PDSCHs on first cells from a first set of cells and second cells from a second set of cells, respectively, such that:
in a first example, the first set and the second set of cells are separate (the corresponding scheduling cells can be same or different); or
in a second example, the first set and the second set of cells are the same (so the corresponding scheduling cell is the same), and the first cells and the second cells are separate; or
in a third example, the first set and the second set of cells are the same (so the corresponding scheduling cell is the same), and the first cells and the second cells share at least one cell.

At least the second and third examples can be based on corresponding UE capabilities.

In one embodiment, for a UE configured with more than one sets of cells for multi-cell scheduling of PDSCHs, the UE can generate a first Type-2 sub-CB for DCI formats scheduling a single cell or triggering a single bit for HARQ-ACK information per DCI format, and multiple second Type-2 sub-CBs for DCI formats that schedule more than one cell. The multiple second Type-2 sub-CBs can have a one-to-one or one-to-many association with the more than one sets of cells for multi-cell scheduling. The multiple second Type-2 sub-CBs include a number of HARQ-ACK information bits based on a number of TBs configured for the cell combinations that are configured for the associated sets of cells for multi-cell scheduling. The counter/total DAI in downlink DCI formats as well as the DAI in uplink DCI formats increment based on a number of DCI formats (for example, rather than a number of PDSCHs or TBs that trigger the HARQ-ACK information bits). Accordingly, the UE can operate with a first counter/total DAI corresponding to DCI formats scheduling a single cell or triggering a single bit for HARQ-ACK information, and multiple second counter/total DAIs corresponding to multi-cell scheduling DCI formats, from the more than one sets of cells, that schedule more than one cell. Similar, the UE can operate with a DAI field in uplink DCI formats that provide first bits/value corresponding to DCI formats scheduling a single cell or triggering a single bit for HARQ-ACK information, and multiple second bits/values corresponding to multi-cell scheduling DCI formats, from the more than one sets of cells, that schedule more than one cell. An UL DCI format can include DAI values for Type-2 sub-CBs or only for one or some Type-2 sub-CBs. When applicable, the UE can determine a last DCI format separately for each set of cells or for each Type-2 sub-CB, or jointly across a number/sets of cells or Type-2 sub-CBs. The UE determines missed DCI formats based on values of the total DAI fields provided in downlink DCI formats or based on bits/values provided in DAI fields in uplink DCI formats, and inserts a corresponding number of NACK bits for the missed DCI formats in a respective Type-2 sub-CB. The UE generates a Type-2 HARQ-ACK CB (for transmission in a PUCCH or PUSCH) by concatenating the first Type-2 sub-CB and the multiple Type-2 sub-CBs in ascending order of the sets of cells.

When a UE is configured a number N≥1 sets of cells for multi-cell scheduling from same or different scheduling cells, in a first option, the UE generates a first Type-2 sub-CB and a number N second Type-2 sub-CBs (for example, referred to as sub-CB index {2_1, 2_2, . . . , to 2_N}). For example, the first Type-2 sub-CB corresponds to DCI formats that each schedule a single cell or trigger one HARQ-ACK information bit, such as one or more of the following:
a single-cell scheduling DCI format, such as DCI format 1_0, 1_1 or 1_2, that schedules a single cell; or
a multi-cell scheduling DCI format, such as DCI format 1_3, that schedules a single cell from any of N sets of cells for multi-cell scheduling; or
“special” DCI formats that are not used for scheduling PDSCH/data (e.g., used for control indication purposes) and trigger a single HARQ-ACK information bits, such as a DCI format for one or more of: SPS PDSCH release, CG PUSCH release, TCI state indication, SCell dormancy indication;
SPS PDSCH reception.

For example, each of the N second Type-2 sub-CBs correspond to a set of cells, from the N sets of cells for multi-cell scheduling. For example, the UE generates the Type-2 sub-CB index 2_1 for (all) DCI formats 1_3 that schedule PDSCHs on more than one cell from the first set of cells, and generates the Type-2 sub-CB index 2_2 for (all) DCI formats 1_3 that schedule PDSCHs on more than one cell from the second set of cells, and so on.

For example, an ordering of the N sets of cells for multi-cell scheduling (to determine, for example, the first/second/ . . . set of cells) can be based, for example, on one or more of the following:
in ascending (or descending) order of a smallest (or largest) cell index or CIF of cells within a set of cells. For example, a first set of cells comprising {cell 1, cell 4} has smaller set index than a second set of cells comprising {cell 2, cell 3}; or
in ascending (or descending) order of an (explicit) index for a set of cells provided as an information element (IE) for the set of cells by higher layer configuration, such as RRC. For example, a unique set index can be provided for each set of cells across different scheduling cells; or
first in ascending (or descending) order of a cell index or CIF for a scheduling cell corresponding to a set of cells, and next in ascending (or descending) order of:
   a smallest (or largest) cell index or CIF of cells within a set of cells, or
   an (explicit) index for a set of cells provided as an information element (IE) for the set of cells by higher layer configuration. For example, a unique set index can be provided for each set of cells corresponding to a same scheduling cell (while same set index values can be re-used across different scheduling cells).

For example, the UE generates one HARQ-ACK information bit for each DCI format corresponding to the first Type-2 sub-CB (at least) when the UE is configured a single TB for a PDSCH reception on any cell from any sets of cells or any cell in a corresponding PUCCH group or when the UE is configured spatial bundling for HARQ-ACK information on the cell group. For example, the UE generates two HARQ-ACK information bits for each DCI format corresponding to the first Type-2 sub-CB when the UE is configured two TBs for a PDSCH reception on at least one cell from a set of cells and the UE is not configured spatial bundling. In the latter example, for DCI formats that do not schedule two TBs, the UE can generate a predetermined value, such as ACK or NACK, for the second HARQ-ACK information bit corresponding to the DCI format.

For example, the UE generates L_1 bits for each DCI format corresponding to a second Type-2 sub-CB with index 2_1 corresponding to a first set of cells for multi-cell scheduling, L_2 bits for a second Type-2 sub-CB with index 2_2 corresponding to a second set of cells for multi-cell scheduling, and so on. For example, L1, L2, and so on are:
a number of cells in the respective set of cells; or
a maximum number of cells across configured cell combinations for the set of cells; or
a maximum total number of configured TBs for cells across the configured cell combinations for the set of cells.

The UE determines a number of HARQ-ACK information bits in each of the multiple second Type-2 sub-CBs independently for each set of cells.

For example, when the UE is configured:
a set of cells including cells {1, 2, 3, 4},
two TBs for cell #1, one TB for cell #2, one TB for cell #3, and two TBs for cell #4, and
cell combination #1=cells {1, 2}, cell combination #2=cells {3, 4}, cell combination #3=cells {1, 2, 3}, and cell combination #4=cells {1, 3, 4},
   then:
the set of cells has 4 cells,
the maximum number of cells across configured cell combinations for the set of cells is 3 cells, and
the cell combinations #1, #2, #3, and #4 are associated with 3, 3, 4, and 5 TBs, respectively, so a maximum total number of configured TBs for cells across the configured cell combinations is 5 TBs.

For example, based on the last method, the UE generates 5 bits of HARQ-ACK information for each DCI format corresponding to the set of cells.

In a second option, the UE generates a first Type-2 sub-CB as described in the first option, and a number M second Type-2 sub-CBs (for example, referred to as sub-CB index {2_1, 2_2, . . . , to 2_M}), where 1≤M≤N. For example, the UE generates a same second Type-2 CB for a first set of cells and a second set of cells when the first and the second sets of cells:
correspond to a same scheduling cell; or
include a same number of cells; or
correspond to a same maximum number of cells across cell combinations configured for the respective set of cells; or
correspond to a same maximum total number of configured TBs across cell combinations configured for the respective set of cells.

In a first example, the UE generates the Type-2 sub-CB index 2_1 for (all) DCI formats 1_3 that schedule PDSCHs on more than one cell from any set of cells corresponding to a first scheduling cell, and generates the Type-2 sub-CB index 2_2 for (all) DCI formats 1_3 that schedule PDSCHs on more than one cell from any set of cells corresponding to a second scheduling cell, and so on. For example, an ordering of the scheduling cells can be in ascending (or descending) order of a cell index for a scheduling cell.

For example, the UE generates L_1 bits for each DCI format corresponding to a second Type-2 sub-CB with index 2_1 that is associated with (all) sets of cells for a first scheduling, L_2 bits for a second Type-2 sub-CB with index 2_2 that is associated with a (all) sets of cells for a second scheduling cell, and so on. For example, L_1, L_2, . . . , and L_M are:
a maximum number of cells across sets of cells for a respective scheduling cell; or
a maximum number of cells across configured cell combinations for any set of cells for a respective scheduling cell; or
a maximum total number of configured TBs for cells across the configured cell combinations for any set of cells for a respective scheduling cell.

The UE determines a number of HARQ-ACK information bits in each of the multiple second Type-2 sub-CBs independently for each scheduling cell.

In a second example, the UE generates the Type-2 sub-CB index 2_1 for (all) DCI formats 1_3 that schedule PDSCHs on more than one cell from any set of cells that include a first number of cells (for example, set of cells with 2 cells), and generates the Type-2 sub-CB index 2_2 for (all) DCI formats 1_3 that schedule PDSCHs on more than one cell from any set of cells that include a second number of cells (for example, set of cells with 3 cells), and so on. For example, an ordering of the second Type-2 sub-CBs can be in ascending (or descending) order of a number of cells in a set of cells.

For example, the UE generates L_1 bits for each DCI format corresponding to a second Type-2 sub-CB with index 2_1 that is associated with (all) sets of cells that include a first number of cells (such as 2 cells), L_2 bits for a second Type-2 sub-CB with index 2_2 that is associated with (all) sets of cells that include a second number of cells (such as 3 cells), and so on. For example, L_1, L_2, . . . , and L_M are:
the first/second/ . . . number of cells (for example, 2 bits when 2 cell, 3 bits when 3 cells, and so on); or
a maximum number of cells across configured cell combinations for any set of cells that include a first/second/ . . . number of cells; or
a maximum total number of configured TBs for cells across the configured cell combinations for any set of cells that include a first/second/ . . . number of cells.

The UE determines a number of HARQ-ACK information bits in each of the multiple second Type-2 sub-CBs independently for each collections of sets of cells that include a same (first/second/ . . . ) number of cells.

In a third example, the UE determines, for each set of cells, a respective maximum number of cells among cell combinations configured for the set of cells. When first and second sets of cells have a same respective maximum number of cells among the corresponding cell combinations, the UE generates a same second Type-2 sub-CB for the first and second sets of cells.

For example, the UE generates:
the Type-2 sub-CB index 2_1 for (all) DCI formats 1_3 that schedule PDSCHs on more than one cell from any set of cells for which a maximum number of cells among the corresponding cell combinations equals a first value, that is, any set of cells with a size of a largest cell combination equal to the first value (for example, set of cells with cell combinations having at most 2 cells), and
the Type-2 sub-CB index 2_2 for (all) DCI formats 1_3 that schedule PDSCHs on more than one cell from any set of cells for which a maximum number of cells among the corresponding cell combinations equals a second value, that is, any set of cells with a size of a largest cell combination equal to the second value (for example, set of cells with cell combinations having at most 3 cells),
and so on.

For example, an ordering of the second Type-2 sub-CBs can be in ascending (or descending) order of a maximum number of cells in respective largest cell combinations.

For example, the UE generates L_1 bits for each DCI format corresponding to a second Type-2 sub-CB with index 2_1 that is associated with (all) sets of cells with a size of a largest cell combination equal to a first value (such as, set of cells with cell combinations having at most 2 cells), L_2 bits for a second Type-2 sub-CB with index 2_2 that is associated with (all) sets of cells with a size of a largest cell combination equal to the second value (such as, set of cells with cell combinations having at most 3 cells), and so on. For example, L_1, L_2, . . . , and L_M are:
a maximum number of cells across sets of cells with a respective size for a largest cell combination;
the first/second/ . . . values (for example, 2 bits when 2 cells, 3 bits when 3 cells, and so on); or
a maximum total number of configured TBs for cells across the configured cell combinations for any set of cells with a respective size for a largest cell combination.

The UE determines a number of HARQ-ACK information bits in each of the multiple second Type-2 sub-CBs independently for each collections of sets of cells with a same size for a largest cell combination.

In a fourth example, the UE determines, for each set of cells, a total number of TBs configured for cells among cell combinations configured for the set of cells, and accordingly determines a respective maximum total number of TBs configured for cells among the respective cell combinations. When first and second sets of cells have a same respective maximum total number of TBs configured for cells among the respective cell combinations, the UE generates a same second Type-2 sub-CB for the first and second sets of cells.

For example, the UE generates:
the Type-2 sub-CB index 2_1 for (all) DCI formats 1_3 that schedule PDSCHs on more than one cell from any set of cells for which a maximum total number of TBs configured for cells among the corresponding cell combinations is equal to a first value (for example, set of cells with a maximum of 2 TBs for any cell combination), and
the Type-2 sub-CB index 2_2 for (all) DCI formats 1_3 that schedule PDSCHs on more than one cell from any set of cells for which a maximum number of cells among the corresponding cell combinations is equal to a second value (for example, set of cells with a maximum of 3 TBs for any cell combination),
and so on.

For example, an ordering of the second Type-2 sub-CBs can be in ascending (or descending) order of a value of a maximum total number of TBs in respective cell combinations.

For example, the UE generates L_1 bits for each DCI format corresponding to a second Type-2 sub-CB with index 2_1 that is associated with (all) sets of cells with a maximum total number of TBs configured for cells among the corresponding cell combinations equal to a first value (for example, set of cells with a maximum of 2 TBs for any cell combination), L_2 bits for a second Type-2 sub-CB with index 2_2 that is associated with (all) sets of cells with a maximum total number of TBs configured for cells among the corresponding cell combinations equal to a second value (for example, set of cells with a maximum of 3 TBs for any cell combination), and so on. For example, L_1, L_2, . . . , and L_M are:
a maximum number of cells across sets of cells with a respective value for a maximum number of TBs across cell combination;
a maximum number of cells across configured cell combinations for any set of cells with a respective value for a maximum number of TBs across cell combination;
the first/second/ . . . values (for example, 2 bits when 2 TBs, 3 bits when 3 TBs, and so on).

The UE determines a number of HARQ-ACK information bits in each of the multiple second Type-2 sub-CBs independently for each collections of sets of cells with a same value for a maximum number of TBs across cell combination.

When a UE receives a DCI format 1_3 that schedules:
multiple PDSCHs on multiple cells from a set of cells for multi-cell scheduling, and
to receive the multiple PDSCHs, except for one PDSCH on one cell from the multiple cells, on symbols that overlap with UL symbols as indicated by a respective common or dedicated TDD DL/UL configuration,
   the UE provides HARQ-ACK information bits corresponding to the DCI format 1_3 in a second Type-2 sub-CB, from the multiple second Type-2 sub-CBs, that is associated with the set of cells (using any of the methods for association herein). The UE does not receive the multiple PDSCHs, except for the one PDSCH on the one cell. In one example, the UE (e.g., the UE 116) generates ACK values for the PDSCHs that overlap with the UL symbols. In another example, the UE generates NACK values for the PDSCHs that overlap with the UL symbols.

For each DCI format in any of the multiple second Type-2 sub-CBs, a corresponding number of HARQ-ACK information bits for the respective co-scheduled PDSCHs by a DCI format 1_3 are ordered in ascending (or descending) order of serving cell indices, or cell-level CIF values, or a (new) index provided for cells in a respective set of cells, of the co-scheduled PDSCHs.

When a DCI format 1_3 corresponding to a second Type-2 sub-CB index 2_j schedules fewer cells than a maximum number of cells in any configured cell combination for an associated set of cells, the UE determines N HARQ-ACK feedback information bits corresponding to the actually scheduled cells, with N<N_{max,2_j} wherein N_{max,2_j} is a number of HARQ-ACK information bits that UE generates for each corresponding DCI format 1_3. In one example, HARQ-ACK information corresponding to the remaining (N_{max,2_j}−N) bits for the non-scheduled cells are NACKs. In another example, the HARQ-ACK information corresponding to the remaining (N_{max,2_j}−N) bits for the non-scheduled cells are ACKs.

The UE determines the ordering/placement of N HARQ-ACK feedback information bits corresponding to the scheduled cells within the N_{max,2_j} bits based on one of the following options:
Option 1: The N HARQ-ACK information bits corresponding to actually co-scheduled cells by the DCI format are placed first, where the N bits are placed in ascending (or descending) order of the cell index or CIF value of the cells or an ordering of cells within the set of cells, and the (N_{max,2_j}−N) NACKs are included at the end, or
Option 2: The HARQ-ACK information bits for both scheduled and non-scheduled cells are placed in order based on any of the ordering described in Option 1, such as in ascending order of cell indexes of the cells. For example, N HARQ-ACK information bits corresponding to actually co-scheduled cells by the DCI format 1_3 are placed in corresponding positions based on the ordering of cell, and for each cell from the set of cells that is not scheduled by the DCI format 1_3, NACK bits (or ACK bits) are inserted in the corresponding position based on the same ordering (in between the Nbits).

In one example, when a cell is configured with up to 2 TBs for a PDSCH without spatial bundling, the HARQ-ACK information bits corresponding to the cell includes 2 consecutive bits regardless of whether a DCI format 1_3 schedules a PDSCH with one TB or 2 TBs on the cell. In another example, when a DCI format schedules a PDSCH with one TB, the UE can include the HARQ-ACK information for the non-scheduled TB along with HARQ-ACK information bits for any non-scheduled cells, so it is separate from HARQ-ACK information for the actually scheduled TB by the DCI format 1_3.

For the non-scheduled TB, in one alternative, the UE includes a NACK bit. In another alternative, the UE includes an ACK bit. In one example, a HARQ-ACK information for a non-scheduled TB is same as a HARQ-ACK information bit for a non-scheduled cell (both NACKs, or both ACKs).

The UE includes a corresponding number of HARQ-ACK information bits for each missed DCI format for each of the first or the multiple second Type-2 sub-CBs. The UE detects the existence and ordering of missed DCI formats based on values provided by a total DAI (tDAI) field/sub-field in DCI formats scheduling PDSCH receptions or by a corresponding DAI field/sub-field in DCI formats scheduling PUSCH transmissions (sometimes referred to as, UL DAI).

For example, the UE generates a number of bits, such as 1 or 2 bits, for each DCI format corresponding to the first Type-2 sub-CB, as described herein. For example, the UE determines a number of bits for the first Type-2 sub-CB regardless of a method for determining a number of the multiple second sub-CBs or respective sizes of the multiple second sub-CBs.

The UE concatenates the multiple second sub-CBs based on the ordering methods as described herein, and appends the concatenated second sub-CBs to the end of the first sub-CB to generate the Type-2 CB that the UE provides on the corresponding PUCCH or PUSCH transmission.

In one example, when the UE does not detect any DCI format corresponding to a set of cells with index j, with j∈{1, . . . N}, the UE does not generate a Type-2 sub-CB index 2_j or include in the concatenated Type-2 CB. Similar, when the UE does not detect any DCI format corresponding to any sets of cells associated with a Type-2 sub-CB with index 2_j, with j∈{1, . . . M}, the UE does not generate a Type-2 sub-CB index 2_j or include in the concatenated Type-2 CB.

In one example, the UE operates with a first counter DAI in first DCI formats that are associated with the first Type-2 sub-CB, and multiple second counter DAIs in respective second DCI formats that are associated with the respective multiple second Type-2 sub-CBs (such as M or N second counter DAIs corresponding to the M or N second sub-CBs, respectively, as described herein). For example, the first DCI formats are the DCI formats associated with the first Type-2 sub-CB, as described herein.

For example, the UE operates with a second counter DAI index 2_1 for a second Type-2 sub-CB index 2_1, a second counter DAI index 2_2 for a second Type-2 sub-CB index 2_2, and so on.

For example, when:
a DCI format 1_3 schedules multiple PDSCHs on multiple cells from a set of cells for multi-cell scheduling, and
the set of cells is associated with a second Type-2 sub-CB with index 2_j (with j∈{1, . . . , M} or j∈{1, . . . , N}) from the multiple (M or N) second Type-2 sub-CBs (using any of the methods for association as described herein), a DAI field in the DCI format 1_3 provides a value for a counter DAI index 2_j.

In one example, the UE increments the counter DAI per DCI format, regardless of a number of PDSCHs that are scheduled by the DCI format. For example, if a DCI format 1_3 schedules 4 PDSCHs, the UE increments the counter DAI by (only) one. The UE increments the counter DAI index 2_j by one each time the UE receives a DCI format 1_3 corresponding to a set of cells for multi-cell scheduling that is associated with the second Type-2 HARQ-ACK sub-CB index 2_j.

In one example, the value of the second counter DAI index 2_j field in the corresponding DCI format 1_3 denotes the accumulative number of {serving/reference cell, PDCCH monitoring occasion}-pairs in which PDSCH receptions, is present up to a reference serving cell and a current PDCCH monitoring occasion,
first, if the UE indicates by type2-HARQ-ACK-Codebook support for more than one PDSCH reception on a reference cell that are scheduled from a same PDCCH monitoring occasion, in increasing order of the PDSCH reception starting time for the same {reference cell, PDCCH monitoring occasion} pair,
second in ascending order of reference cell index, and
third in ascending order of PDCCH monitoring occasion index m, where 0≤m<M.

In one example, a UE does not expect to support a DCI format 1_3 that schedules more than one PDSCH receptions on a serving/reference cell in a same PDCCH monitoring occasion. Accordingly, the first bullet herein may not apply for determination of the second counter DAIs.

In one example, a reference cell for counter DAI determination is a cell with smallest cells index, from the cells that are scheduled by the DCI format 1_3. For example, if a DCI format 1_3 schedules PDSCHs on cells with indexes {2, 3}, the reference cell for the counter DAI is cell 2. This holds even if cells {2, 3} are from a configured set of cells for multi-cell scheduling that includes cells with indexes {1, 2, 3, 4}.

In another example, a reference cell for counter DAI determination is a cell with smallest cells index, from the set of cells. In the example herein, the reference cell for the counter DAI is cell 1, regardless of the cell combination scheduled by the DCI format 1_3, including whether or not the DCI format schedules a PDSCH on cell 1. For example, the reference cell is cell 1 (and not cell 2, as in the previous example).

For example, a size of a counter DAI can be 2 bits to provide a same reliability level for detection of missed DCIs and correct size of the HARQ-ACK sub-codebook as for single-cell scheduling DCI formats [REF3][TS 38.213, v 17.4.0], which is 3 missed DCI formats. For example, a value of a counter DAI is provided by the 2 MSBs of a DAI field in the corresponding DCI format, such as DCI format 1_3.

For each Type-2 sub-CB, the UE orders the HARQ-ACK information bits among corresponding DCI formats 1_3 in ascending order of the counter DAI values provided in DCI formats 1_3. When a next value of respective counter DAI is not present in a next DCI format for a corresponding Type-2 sub-CB, the UE detects a missed DCI format and generates a corresponding number of NACK bits in the corresponding order/location. The UE also detects missed DCI formats based on total DAI or a DAI in an uplink DCI format, as described herein.

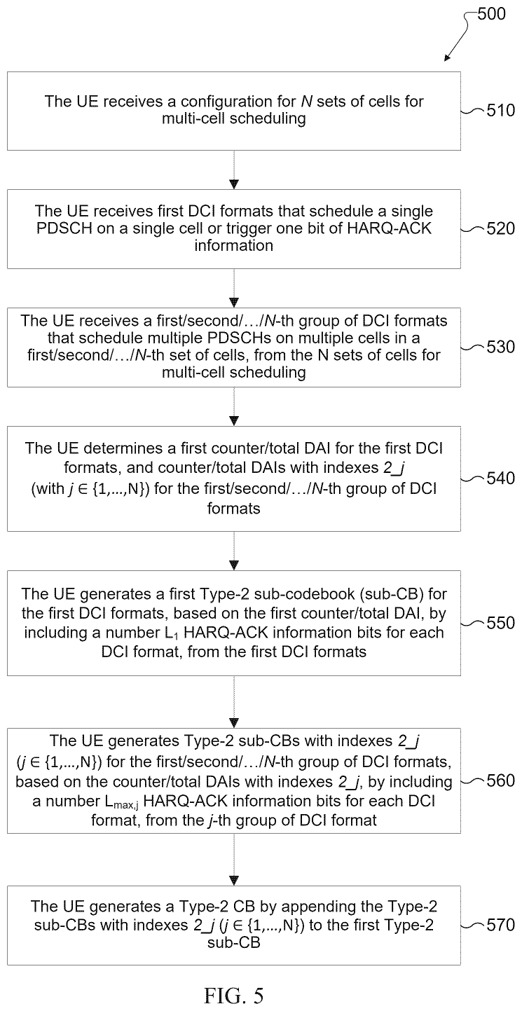

FIG. 5 illustrates a flowchart of an example UE procedure 500 for generating sub-CBs according to embodiments of the present disclosure. For example, UE procedure 500 for generating sub-CBs can be performed by any of the UEs 111-116 of FIG. 1, such as the UE 111. This example is for illustration only and other embodiments can be used without departing from the scope of the present disclosure.

The procedure begins in 510, the UE receives a configuration for N sets of cells for multi-cell scheduling. In 520, the UE receives first DCI formats that schedule a single PDSCH on a single cell or trigger one bit of HARQ-ACK information. In 530, the UE receives a first/second/ . . . /N-th group of DCI formats that schedule multiple PDSCHs on multiple cells in a first/second/ . . . /N-th set of cells, from the N sets of cells for multi-cell scheduling. In 540, the UE determines a first counter/total DAI for the first DCI formats, and counter/total DAIs with indexes 2_j (with j∈{1, . . . , N}) for the first/second/ . . . /N-th group of DCI formats. In 550, the UE generates a first Type-2 sub-codebook (sub-CB) for the first DCI formats, based on the first counter/total DAI, by including a number L₁ HARQ-ACK information bits for each DCI format, from the first DCI formats. In 560, the UE generates Type-2 sub-CBs with indexes 2_j (j∈{1, . . . , N}) for the first/second/ . . . /N-th group of DCI formats, based on the counter/total DAIs with indexes 2_j, by including a number L_{max,j} HARQ-ACK information bits for each DCI format, from the j-th group of DCI format. In 570, the UE generates a Type-2 CB by appending the Type-2 sub-CBs with indexes 2_j (j∈{1, . . . , N}) to the first Type-2 sub-CB.

In one example, the UE operates with a first total DAI in first DCI formats that are associated with the first Type-2 sub-CB, and multiple second total DAIs in respective second DCI formats that are associated with the respective multiple second Type-2 sub-CBs (such as M or N second total DAIs corresponding to the M or N second sub-CBs, respectively, as described herein).

For example, the UE determines the first total DAI as for single-cell PDSCH scheduling, wherein the UE counts/accumulates a total number of first DCI formats across serving cells up to a current PDCCH monitoring occasion. For example, the first DCI formats are the DCI formats associated with the first Type-2 sub-CB, as described herein.

For example, the UE operates with a total DAI index 2_1 for a Type-2 sub-CB index 2_1, a total DAI index 2_2 for a Type-2 sub-CB index 2_2, and so on.

For example, when:
a DCI format 1_3 schedules multiple PDSCHs on multiple cells from a set of cells for multi-cell scheduling, and
the set of cells is associated with a second Type-2 sub-CB with index 2_j (with j∈{1, . . . , M} or j∈{1, . . . , N}) from the multiple (M or N) second Type-2 sub-CBs (using any of the methods for association as described herein),
   a DAI field in the DCI format 1_3 provides a value for a total DAI index 2_j.

For example, the UE determines a total DAI index 2_j by counting/accumulating a total number of DCI formats 1_3 associated with the Type-2 sub-CB with index 2_j up to a current PDCCH monitoring occasion.

For example, a size of a total DAI can be 2 bits to provide a same reliability level for detection of missed DCIs and correct size of the HARQ-ACK sub-codebook as for single-cell scheduling DCI formats [REF3][TS 38.213, v 17.4.0], which is 3 missed DCI formats. For example, a value of the total DAI is provided as 2 least significant bits (LSBs) of the DAI field in the corresponding DCI format, such as DCI format 1_3.

It is noted that, each DCI format (for single-cell or multi-cell scheduling) includes a single value for total DAI value for the corresponding Type-2 sub-CB. For example, the DAI value in DCI format 1_3 corresponding to Type-2 sub-CB with index 2_j does not include a value for the first total DAI or for the second total DAI with index other than 2_j.

In one example, when HARQ-ACK codebook generation depends on a value of a counter DAI or a total DAI or other properties associated with a last DCI format, and when the UE detects, in a (last) PDCCH monitoring occasion, more than one DCI format, such as a first DCI format 1_3 scheduling PDSCH on cells from a set of cell for multi-cell scheduling, and a second DCI format (such as a DCI format 1_0/1_1/1_2 or a second DCI format 1_3), the UE determines the last DCI format to be DCI format that is associated with the largest (or smallest) cell index. The first DCI format 1_3 (and the second DCI format 1_3) can be associated with more than one cell indexes, and a cell with smallest cell index is used as a reference cell for the first (or second) DCI format 1_3 when determining a last DCI format. For last DCI format determination, in one alternative, the UE determines the reference cell for the DCI format 1_3 to be a smallest cell index among the cells on which PDSCHs are scheduled by the DCI format 1_3. In another alternative, the UE determines the reference cell for the DCI format 1_3 to be a smallest cell index among the set of cells associated with the DCI format 1_3, regardless of whether or not the smallest cell index is scheduled by the DCI format 1_3.

In one example, a last DCI format is determined separately for each set of cells for multi-cell scheduling. In another example, a last DCI format is jointly determined among different sets of cells for multi-cell scheduling or among different Type-2 sub-CBs. In yet another alternative, a last DCI format is determined among a number of sets of cells for multi-cell scheduling or a number of Type-2 sub-CBs, that are determined as described herein for DAI value in UL DCI formats.

For example, a last DCI format can be, for example, a last DCI format in a last monitoring occasion among a number of PDCCH monitoring occasions corresponding to a HARQ-ACK transmission in a PUCCH/PUSCH.

With reference to FIG. 5, an example procedure is shown for generating separate Type-2 HARQ-ACK sub-CBs for single-cell scheduling and for multi-cell scheduling, wherein separate Type-2 sub-CBs are generated for each set of cells for multi-cell scheduling.

When a UE generates a first Type-2 sub-CB for first DCI format, and multiple (such as M or N) second Type-2 sub-CBs for corresponding second DCI formats that are associated with the respective set of cells for multi-cell scheduling, an uplink DCI format that schedules a PUSCH transmission can include a DAI field with:
a first DAI value/sub-field, for the first Type-2 sub-CB, and
multiple (such as M or N) second DAI value/sub-field, each corresponding to one of the multiple second Type-2 sub-CBs, such as a value/sub-field for a DAI index 2-j associated with a Type-2 sub-CB with index 2_j.

In one example, the herein applies when the UE determines separate counter/total DAI values for each Type-2 sub-CBs per corresponding DL DCI format.

For example, a size of each total DAI value/sub-field for each of the sub-CBs can be 2 bits to provide a same reliability level for detection of missed DCIs and correct size of the HARQ-ACK sub-codebook as for single-cell scheduling DCI formats [REF3][TS 38.213, v 17.4.0], which is 3 missed DCI formats.

When multiplexing HARQ-ACK information on the PUSCH, the UE generates each of the Type-2 sub-CBs by determining parameter Vₜₑₘₚ₂ in a corresponding pseudo-code based on a value of a corresponding DAI sub-field in the UL DCI format, instead of a corresponding total DAI value provided in an associated DL DCI format.

The examples herein can apply to any UL DCI format, such as a DCI format, such as an UL DCI format for single-cell scheduling, for example, DCI format 0_1/0_2, or a DCI format for multi-cell scheduling, for example, DCI format 0_3.

In one example, a DAI field in an UL DCI format includes only some of the herein DAI values/sub-fields. For example, an UL DCI format for single-cell scheduling, such as DCI format 0_1/0_2, provides a DAI value only for the first Type-2 sub-CB, and does not provide a value/sub-field for any of the multiple second Type-2 sub-CBs.

For example, an UL DCI format for single-cell scheduling, such as DCI format 0_1/0_2, provides a first DAI value/sub-field for the first Type-2 sub-CB, and a second DAI value/sub-field for one second Type-2 sub-CB (for example with index 2_j), from the multiple second Type-2 sub-CBs. For example, the DAI field includes an index (for example, j) of the one second Type-2 sub-CB for which the DAI value/sub-field is provided.

For example, an UL DCI format for multi-cell scheduling, such as DCI format 0_3, provides multiple DAI values/sub-fields for the multiple second Type-2 sub-CB, and does not provide a value/sub-field for a first Type-2 sub-CB.

For example, an UL DCI format for multi-cell scheduling, such as a DCI format 03, that schedules only a single PUSCH on a single cell provides a DAI value only for the first Type-2 sub-CB, and does not provide a value for any of the second Type-2 sub-CB with index 2_j.

For example, an UL DCI format for multi-cell scheduling, such as DCI format 0_3, provides only one DAI value for one of the second Type-2 sub-CB (for example with index 2_j), from the multiple Type-2 sub-CBs, and does not provide a DAI value for the first Type-2 sub-CB or for any other second Type-2 sub-CBs (other than index 2_j), from the multiple second Type-2 sub-CBs. For example, the DAI field includes an index (for example, j) of the one second Type-2 sub-CB for which the DAI value is provided. In a variation, the one DAI value provided in DCI format 0_3 can be a DAI value corresponding to any of the Type-2 sub-CBs, including the first Type-2 sub-CB.

For example, an UL DCI format for multi-cell scheduling, such as DCI format 0_3, provides a number (one or more than one) of DAI values/subfield, wherein the number is provided by higher layers or predetermined in the specifications of system operation. For example, a DCI format 0_3 can include a number of indexes or a bitmap to indicate corresponding number of Type-2 sub-CBs.

In the examples herein, when an UL DCI format does not provide a DAI value/sub-field for a Type-2 sub-CB, the UE generates the corresponding Type-2 sub-CB by determining parameter Vₜₑₘₚ₂ in a corresponding pseudo-code based on a value of a corresponding total DAI value provided in an associated DL DCI format.

In on example, a size of DAI field in UL DCI formats or DL DCI formats for multi-cell scheduling, such as DCI format 0_3 or 13, can be configurable by higher layers such as RRC.

In one embodiment, for a UE configured with one or more than one sets of cells for multi-cell scheduling of PDSCHs, the UE can generate multiple first Type-2 sub-CBs for DCI formats scheduling a single cell or triggering a single bit for HARQ-ACK information per DCI format, and multiple second Type-2 sub-CBs for DCI formats that schedule more than one cell. The multiple first Type-2 sub-CBs can have a one-to-one mapping with a number of HARQ-ACK information bits (such as two first sub-CBs corresponding to one or two HARQ-ACK information bits) or can have a same association with the one or more than one sets of cells for multi-cell scheduling, according to one or more embodiments described herein, including any cells that do not belong to any set of cells for multi-cell scheduling. The UE generates the multiple second Type-2 sub-CBs according to one or more embodiments described herein. The counter/total DAI in downlink DCI formats as well as the DAI in uplink DCI formats increment based on a number of DCI formats (for example, rather than a number of PDSCHs or TBs that have triggered the HARQ-ACK information bits). Accordingly, the UE can operate with multiple first counter/total DAIs corresponding to DCI formats scheduling a single cell or triggering a single bit for HARQ-ACK information, and multiple second counter/total DAIs corresponding to multi-cell scheduling DCI formats, from the more than one sets of cells, that schedule more than one cell. Similar, the UE can operate with a DAI field in uplink DCI formats that provide multiple first bits/values corresponding to DCI formats scheduling a single cell or triggering a single bit for HARQ-ACK information, and multiple second bits/values corresponding to multi-cell scheduling DCI formats, from the more than one sets of cells, that schedule more than one cell. An UL DCI format can include DAI values for Type-2 sub-CBs or only for one or some Type-2 sub-CBs. When applicable, the UE can determine a last DCI format separately for each set of cells or each Type-2 sub-CB, or jointly across a number/sets of cells or Type-2 sub-CBs. The UE determines missed DCI formats based on values of the counter/total DAI fields provided in downlink DCI formats or based on bits/values provided in the DAI field in uplink DCI formats, and inserts a corresponding number of NACK bits for the missed DCI formats in a respective Type-2 sub-CB. The UE generates a Type-2 HARQ-ACK CB (for transmission in a PUCCH or PUSCH) by concatenating the multiple first Type-2 sub-CBs in ascending order of the number of HARQ-ACK information bits or the order of the sets of cells and the multiple Type-2 sub-CBs in ascending order of the sets of cells.

In a first example, the UE generates two first Type-2 sub-CBs, such as a Type-2 sub-CB index 1_1 for DCI formats that trigger a single HARQ-ACK information bit, and a Type-2 sub-CB index 1_2 for DCI formats the schedule PDSCH on a single cell and trigger two HARQ-ACK information bits. For example, the Type-2 sub-CB index 1_1 is associated with one or more of:
“special” DCI formats for control purpose that do not schedule a PDSCH and trigger a single HARQ-ACK information bit, such as a DCI format for one or more of: SPS PDSCH release or CG PUSCH release, or for SCell dormancy indication, or for TCI state indication, and
SPS PDSCH reception;
DCI formats for single-cell scheduling, such as DCI format 1_0/1_1/1_2, that schedules a PDSCH on a cell, wherein the cell is configured only one TB, or is configured two TBs with spatial bundling for HARQ-ACK reporting on PUSCH or PUCCH,
DCI formats for multi-cell scheduling, such as DCI format 1_3 that schedules a single PDSCH on a single cell, wherein the single cell is configured only one TB, or is configured two TBs with spatial bundling for HARQ-ACK reporting on PUSCH or PUCCH.

For example, the Type-2 sub-CB index 1_2 is associated with one or more of:
DCI formats for single-cell scheduling, such as DCI format 1_0/1_1/1_2, that schedules a PDSCH on a cell, wherein the cell is configured two TBs for PDSCH without spatial bundling for HARQ-ACK reporting on PUSCH or PUCCH,
DCI formats for multi-cell scheduling, such as DCI format 1_3, that schedules a single PDSCH on a single cell, wherein the single cell is configured two TBs without spatial bundling for HARQ-ACK reporting on PUSCH or PUCCH.

In a variation, when a cell is configured with two TBs for a PDSCH, and a DCI format for single-cell scheduling or for multi-cell scheduling schedules only one PDSCH with one TB on the cell, the DCI format corresponds to the Type-2 sub-CB index 11 (rather than 1_2, as described in the previous example).

The UE generates one HARQ-ACK information bits for sub-CB index 11, and two HARQ-ACK information bits for the sub-CB index 1_2.

In the example herein, an ordering of the two first Type-2 sub-CBs is based on the number of HARQ-ACK information bits for each sub-CB, that is, the Type-2 sub-CB index 1_2 is appended to the end of the Type-2 sub-CB index 1_1.

In a second example, the UE generates (M+1) or (N+1) first Type-2 sub-CBs, with indexes 1_1, 1_2, . . . , 1_M, 1_(M+1), or with indexes 1_1, 1_2, . . . , 1_N, 1_(N+1), wherein generates M or N refer to a number of second Type-2 sub-CBs that the UE generates for multi-cell scheduling DCI formats associated with the more than one sets of cells for multi-cell scheduling.

For example, the first Type-2 sub-CB index 1_j (with j∈{1, . . . , M} or j∈{1, . . . , N}) is associated with DCI formats for single-cell scheduling or multi-cell scheduling that schedule a single PDSCH on a single cell, from a set of cells that is associated with the second Type-2 sub-CB index 2_j.

For example, the first Type-2 sub-CB index 1_(M+1) or 1_(N+1) is associated with
“special” DCI formats for control purpose that do not schedule a PDSCH and trigger a single HARQ-ACK information bit, such as a DCI format for one or more of: SPS PDSCH release or CG PUSCH release, or for SCell dormancy indication, or for TCI state indication, and
DCI formats for single-cell scheduling, such as DCI format 1_0/1_1/1_2, that schedules a PDSCH on a cell (if any) that is not included in any set of cells.

In the example herein, an ordering of the multiple first Type-2 sub-CBs is based on the ordering of the sets of cells or ordering of the corresponding Type-2 sub-CBs, and the Type-2 sub-CB index 1_(M+1) or 1_(N+1) is appended to the end (or alternatively, included at the beginning) of the other first Type-2 sub-CBs.

The UE operates with multiple first counter/total DAI values corresponding to the multiple first Type-2 sub-CBs, and with multiple second counter/total DAI values corresponding to the multiple second Type-2 sub-CBs. The procedures are similar to one or more embodiments described herein.

A DAI field in an UL DCI format that schedules a PUSCH on a cell (or multiple PUSCHs on multiple cells) can provide multiple first DAI values/sub-fields corresponding to the multiple first Type-2 sub-CBs, and with multiple second DAI values/sub-fields corresponding to the multiple second Type-2 sub-CBs. This applies to any DCI format, including a DCI format for single-cell scheduling, such as DCI formats 0_1/0_2, or a DCI format 0_3 for multi-cell scheduling. In another example, a DAI field in an UL DCI format provides only one or a number of DAI values/sub-fields for one or a number of Type-2 sub-CBs (along with indexes of the sub-CBs). The procedures are similar to one or more embodiments described herein.

In one example, when the UE (e.g., the UE 116) does not detect any DCI format associated with a Type-2 sub-CB with index 1_j, the UE does not generate a Type-2 sub-CB index 1_j or include in the concatenated Type-2 CB.

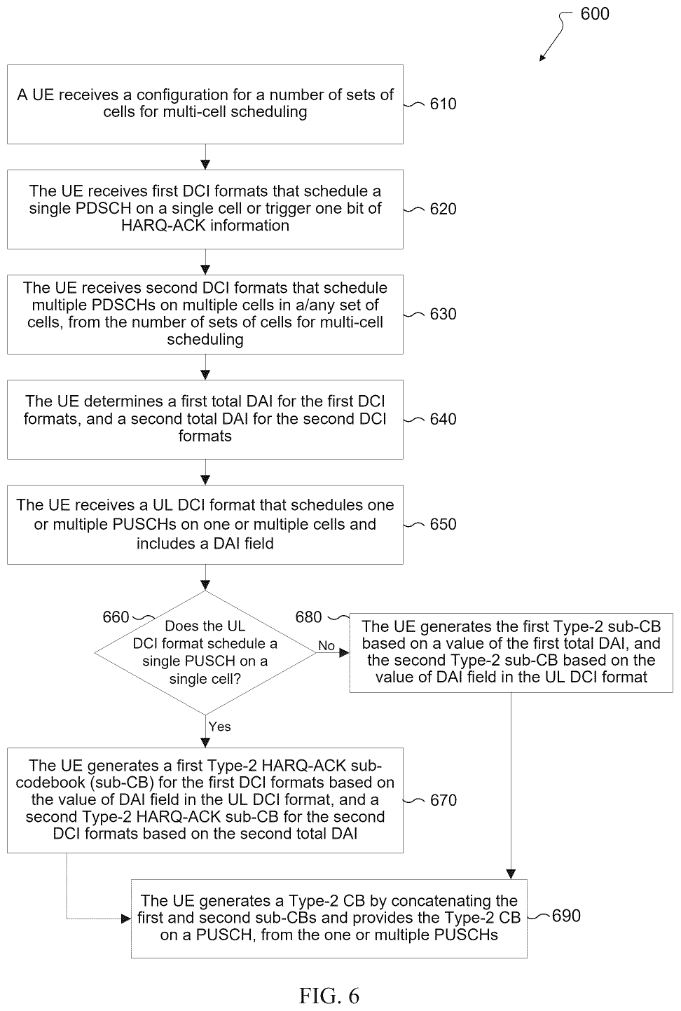

FIG. 6 illustrates a flowchart of an example UE procedure 600 for generating sub-CBs according to embodiments of the present disclosure. For example, UE procedure 600 for generating sub-CBs can be performed by any of the UEs 111-116 of FIG. 1, such as the UE 114. This example is for illustration only and other embodiments can be used without departing from the scope of the present disclosure.

The procedure begins in 610, a UE receives a configuration for a number of sets of cells for multi-cell scheduling. In 620, the UE receives first DCI formats that schedule a single PDSCH on a single cell or trigger one bit of HARQ-ACK information. In 630, the UE receives second DCI formats that schedule multiple PDSCHs on multiple cells in a/any set of cells, from the number of sets of cells for multi-cell scheduling. In 640, the UE determines a first total DAI for the first DCI formats, and a second total DAI for the second DCI formats. In 650, the UE receives a UL DCI format that schedules one or multiple PUSCHs on one or multiple cells and includes a DAI field. In 660, the UE determines whether or not the UL DCI format schedules a single PUSCH on a single cell. In 670, when the UE determines that the UL DCI format scheduled a single PUSCH on a single cell, the UE generates a first Type-2 HARQ-ACK sub-codebook (sub-CB) for the first DCI formats based on the value of DAI field in the UL DCI format, and a second Type-2 HARQ-ACK sub-CB for the second DCI formats based on the second total DAI. In 680, when the UE determines that the UL DCI format is not scheduled a single PUSCH on a single cell, the UE generates the first Type-2 sub-CB based on a value of the first total DAI, and the second Type-2 sub-CB based on the value of DAI field in the UL DCI format. In 690, the UE generates a Type-2 CB by concatenating the first and second sub-CBs and provides the Type-2 CB on a PUSCH, from the one or multiple PUSCHs.

In one embodiment, for a UE configured with more than one sets of cells for multi-cell scheduling of PDSCHs, the UE can generate a first Type-2 sub-CB for DCI formats scheduling a single cell or triggering a single bit for HARQ-ACK information per DCI format, and a (single) second Type-2 sub-CB for DCI formats that schedule more than one cell. The second Type-2 sub-CB corresponds to (all) different sets of cells for multi-cell scheduling. The second Type-2 sub-CBs includes a number of HARQ-ACK information bits based on a number of TBs configured for the cell combinations that are configured across different sets of cells for multi-cell scheduling in a PUCCH group. The counter/total DAI in downlink DCI formats as well as the DAI in uplink DCI formats increment based on a number of DCI formats (for example, rather than a number of PDSCHs or TBs that trigger the HARQ-ACK information bits). Accordingly, the UE can operate with a first counter/total DAI corresponding to DCI formats scheduling a single cell or triggering a single bit for HARQ-ACK information, and a second counter/total DAI corresponding to multi-cell scheduling DCI formats, from the more than one sets of cells, that schedule more than one cell. Similar, the UE can operate with a DAI field in uplink DCI formats that provide a first value corresponding to DCI formats scheduling a single cell or triggering a single bit for HARQ-ACK information, and a second value corresponding to multi-cell scheduling DCI formats, from the more than one sets of cells, that schedule more than one cell. An UL DCI format can include DAI values for both Type-2 sub-CBs or only for one Type-2 sub-CB. The UE determines missed DCI formats based on values of the total DAI fields provided in downlink DCI formats or based on bits/values provided in DAI fields in uplink DCI formats, and inserts a corresponding number of NACK bits for the missed DCI formats in a respective Type-2 sub-CB. The UE generates a Type-2 HARQ-ACK CB (for transmission in a PUCCH or PUSCH) by concatenating the first Type-2 sub-CB and the second Type-2 sub-CB.

For example, the UE generates the first Type-2 sub-CB same according to one or more embodiments described herein. For example, the UE generates the Type-2 sub-CB by including HARQ-ACK information corresponding to DCI formats 1_3 that schedule PDSCHs on more than one cell from any set of cells.

For example, the UE generates one or two HARQ-ACK information bits for each DCI in the first Type-2 sub-CB.

For example, the UE generates a number of HARQ-ACK information bits for each DCI format corresponding to the second Type-2 sub-CB that is equal to:
a maximum number of cells in any set of cells, from the more than one sets of cells; or
a maximum number of cells across configured cell combinations for any set of cells, from the more than one sets of cells; or
a maximum total number of configured TBs for cells across the configured cell combinations for any set of cells, from the more than one sets of cells.

When a UE receives a DCI format 1_3 that schedules:
multiple PDSCHs on multiple cells from a set of cells for multi-cell scheduling, and
to receive the multiple PDSCHs, except for one PDSCH on one cell from the multiple cells, on symbols that overlap with UL symbols as indicated by a respective common or dedicated TDD DL/UL configuration, the UE provides HARQ-ACK information bits corresponding to the DCI format 1_3 in the second Type-2 sub-CB. The UE does not receive the multiple PDSCHs, except for the one PDSCH on the one cell. In one example, the UE generates ACK values for the PDSCHs that overlap with the UL symbols. In another example, the UE generates NACK values for the PDSCHs that overlap with the UL symbols.

For each DCI format 1_3 that schedules multiple PDSCHs on multiple cells from any set of cells, a corresponding number of HARQ-ACK information bits, in the second Type-2 sub-CB, for the respective co-scheduled PDSCHs by the DCI format 1_3 are ordered in ascending (or descending) order of serving cell indices, or cell-level CIF values, or a (new) index provided for cells in a respective set of cells, of the co-scheduled PDSCHs.

When a DCI format 1_3 corresponds to the second Type-2 sub-CB and schedules fewer cells than a maximum number of cells in any configured cell combination for an associated set of cells, the UE determines N HARQ-ACK feedback information bits corresponding to the actually scheduled cells, with N<Nₘₐₓ wherein Nₘₐₓ is a number of HARQ-ACK information bits that UE generates for each corresponding DCI format 1_3 (as described herein, for example, based in a maximum number of TBs for any cell combination in any set of cells). In one example, HARQ-ACK information corresponding to the remaining (Nₘₐₓ−N) bits for the non-scheduled cells are NACKs. In another example, the HARQ-ACK information corresponding to the remaining (Nₘₐₓ−N) bits for the non-scheduled cells are ACKs.

The UE determines the ordering/placement of N HARQ-ACK feedback information bits corresponding to the scheduled cells within the Nₘₐₓ bits based on one of the following options:
Option 1: The N HARQ-ACK information bits corresponding to actually co-scheduled cells by the DCI format are placed first, where the N bits are placed in ascending (or descending) order of the cell index or CIF value of the cells or an ordering of cells within the set of cells, and the (Nₘₐₓ−N) NACKs are included at the end, or
Option 2: The HARQ-ACK information bits for both scheduled and non-scheduled cells are placed in order based on any of the ordering described in Option 1, such as in ascending order of cell indexes of the cells. For example, N HARQ-ACK information bits corresponding to actually co-scheduled cells by the DCI format 1_3 are placed in corresponding positions based on the ordering of cells, and for each cell from the set of cells that is not scheduled by the DCI format 1_3, NACK bits (or ACK bits) are inserted in the corresponding position based on the same ordering (in between the Nbits).

The UE includes a corresponding number of HARQ-ACK information bits for each missed DCI format for each of the first or the multiple second Type-2 sub-CBs. The UE detects the existence and ordering of missed DCI formats based on values provided by a total DAI (tDAI) field/sub-field in DCI formats scheduling PDSCH receptions or by a corresponding DAI field/sub-field in DCI formats scheduling PUSCH transmissions (sometimes referred to as, UL DAI).

In one example, the UE operates with a first counter DAI in first DCI formats that are associated with the first Type-2 sub-CB, and a second counter DAI in second DCI formats that are associated with the second Type-2 sub-CB. For example, the first and second DCI formats are associated with the first and second Type-2 sub-CB, respectively, as described herein.

In one example, the UE increments the counter DAI per DCI format, regardless of a number of PDSCHs that are scheduled by the DCI format. For example, if a DCI format 1_3 schedules 4 PDSCHs, the UE increments the counter DAI by (only) one. The UE increments the counter DAI by one each time the UE receives a DCI format 1_3 that scheduled PDSCHs on more than one cell from any set of cells.

In one example, the value of the second counter DAI field in a corresponding DCI format 1_3 denotes the accumulative number of {serving/reference cell, PDCCH monitoring occasion}-pairs in which PDSCH receptions, is present up to a reference serving cell and a current PDCCH monitoring occasion,
first, if the UE indicates by type2-HARQ-ACK-Codebook support for more than one PDSCH reception, on a reference cell, that are scheduled from a same PDCCH monitoring occasion, in increasing order of the PDSCH reception starting time for the same {reference cell, PDCCH monitoring occasion} pair,
second in ascending order of reference cell index, and
third in ascending order of PDCCH monitoring occasion index m, where 0≤m<M.

In one example, a UE does not expect to support a DCI format 1_3 that schedules more than one PDSCH receptions on a serving/reference cell in a same PDCCH monitoring occasion. Accordingly, the first bullet may not apply for determination of the second counter DAI.

In one example, a reference cell for counter DAI determination is a cell with smallest cells index, from the cells that are scheduled by the DCI format 1_3. For example, if a DCI format 1_3 schedules PDSCHs on cells with indexes {2, 3}, the reference cell for the counter DAI is cell 2. This holds even if cells {2, 3} are from a configured set of cells for multi-cell scheduling that includes cells with indexes {1, 2, 3, 4}.

In another example, a reference cell for counter DAI determination is a cell with smallest cells index, from the set of cells. In the example herein, the reference cell for the counter DAI is cell 1, regardless of the cell combination scheduled by the DCI format 1_3, including whether or not the DCI format schedules a PDSCH on cell 1. For example, the reference cell is cell 1 (and not cell 2, as in the previous example).

For example, a size of a counter DAI can be 2 bits to provide a same reliability level for detection of missed DCIs and correct size of the HARQ-ACK sub-codebook as for single-cell scheduling DCI formats [REF3][TS 38.213, v 17.4.0], which is 3 missed DCI formats. For example, a value of a counter DAI is provided by the 2 MSBs of a DAI field in the corresponding DCI format, such as DCI format 1_3.

For the first/second Type-2 sub-CB, the UE orders the HARQ-ACK information bits among corresponding DCI formats in ascending order of the counter DAI values provided in the respective DCI formats. For example, for the second Type-2 sub-CB, the UE orders the HARQ-ACK information bits among corresponding DCI formats 1_3 in ascending order of the counter DAI values provided in DCI formats 1_3. When a next value of respective counter DAI is not present in a next DCI format for a corresponding Type-2 sub-CB, the UE detects a missed DCI format and generates a corresponding number of NACK bits in the corresponding order/location. The UE also detects missed DCI formats based on total DAI or a DAI in an uplink DCI format, as described herein.

In one example, the UE operates with a first total DAI in first DCI formats that are associated with the first Type-2 sub-CB, and a second total DAI in second DCI formats that are associated with the second Type-2 sub-CB.

For example, the UE determines the first total DAI as for single-cell PDSCH scheduling, wherein the UE counts/accumulates a total number of first DCI formats across serving cells up to a current PDCCH monitoring occasion. For example, the first DCI formats are the DCI formats associated with the first Type-2 sub-CB, as described herein.

For example, the UE determines a second total DAI by counting/accumulating a total number of DCI formats 1_3 associated with the second Type-2 sub-CB up to a current PDCCH monitoring occasion.

For example, a size of a total DAI can be 2 bits to provide a same reliability level for detection of missed DCIs and correct size of the HARQ-ACK sub-codebook as for single-cell scheduling DCI formats [REF3][TS 38.213, v 17.4.0], which is 3 missed DCI formats. For example, a value of the total DAI is provided as 2 LSBs of the DAI field in the corresponding DCI format, such as DCI format 1_3.

It is noted that, each DCI format (for single-cell or multi-cell scheduling) includes a single value for total DAI value for the corresponding Type-2 sub-CB. For example, the DAI value in DCI format 1_3 corresponding to second Type-2 sub-CB does not include a value for the first total DAI.

When a UE generates a first Type-2 sub-CB for first DCI format, and a second Type-2 sub-CBs for corresponding second DCI formats that are associated with the respective set of cells for multi-cell scheduling, an uplink DCI format that schedules a PUSCH transmission can include a DAI field with a first DAI value/sub-field, for the first Type-2 sub-CB, and a second DAI value/sub-field, for the second Type-2 sub-CB.

For example, a size of each total DAI value/sub-field for each of the sub-CBs can be 2 bits to provide a same reliability level for detection of missed DCIs and correct size of the HARQ-ACK sub-codebook as for single-cell scheduling DCI formats [REF3][TS 38.213, v 17.4.0], which is 3 missed DCI formats.

When multiplexing HARQ-ACK information on the PUSCH, the UE generates each of the Type-2 sub-CBs by determining parameter Vₜₑₘₚ₂ in a corresponding pseudo-code based on a value of a corresponding DAI sub-field in the UL DCI format, instead of a corresponding total DAI value provided in an associated DL DCI format.

The examples herein can apply to any UL DCI format, such as a DCI format, including an UL DCI format for single-cell scheduling, for example, DCI format 0_1/0_2, or a DCI format for multi-cell scheduling, for example, DCI format 0_3.

In one example, a DAI field in an UL DCI format includes only one of the two DAI values/sub-fields. For example, an UL DCI format for single-cell scheduling, such as DCI format 0_1/0_2, provides a DAI value only for the first Type-2 sub-CB, and does not provide a value/sub-field for the second Type-2 sub-CB.

For example, an UL DCI format for multi-cell scheduling, such as DCI format 0_3, provides a DAI value only for the second Type-2 sub-CB, and does not provide a value for the first Type-2 sub-CB.

For example, an UL DCI format for multi-cell scheduling, such as DCI format 03, that schedules only a single PUSCH on a single cell provides a DAI value only for the first Type-2 sub-CB, and does not provide a value for the second Type-2 sub-CB.

For example, an UL DCI format (for single-cell scheduling or multi-cell scheduling) provided a DAI value only for one of the two Type-2 sub-CBs, and includes a one-bit flag to indicate whether the provided DAI value is the first DAI value for the first Type-2 sub-CB or the second DAI value for the second Type-2 sub-CB.

In the examples herein, when an UL DCI format does not provide a DAI value/sub-field for a Type-2 sub-CB, the UE generates the corresponding Type-2 sub-CB by determining parameter Vₜₑₘₚ₂ in a corresponding pseudo-code based on a value of a corresponding total DAI value provided in an associated DL DCI format.

With reference to FIG. 6, an example procedure is shown for generating separate Type-2 HARQ-ACK sub-CBs for single-cell scheduling and for multi-cell scheduling, based on a value of a DAI in an UL DCI format that is applicable to only one of the sub-CBs.

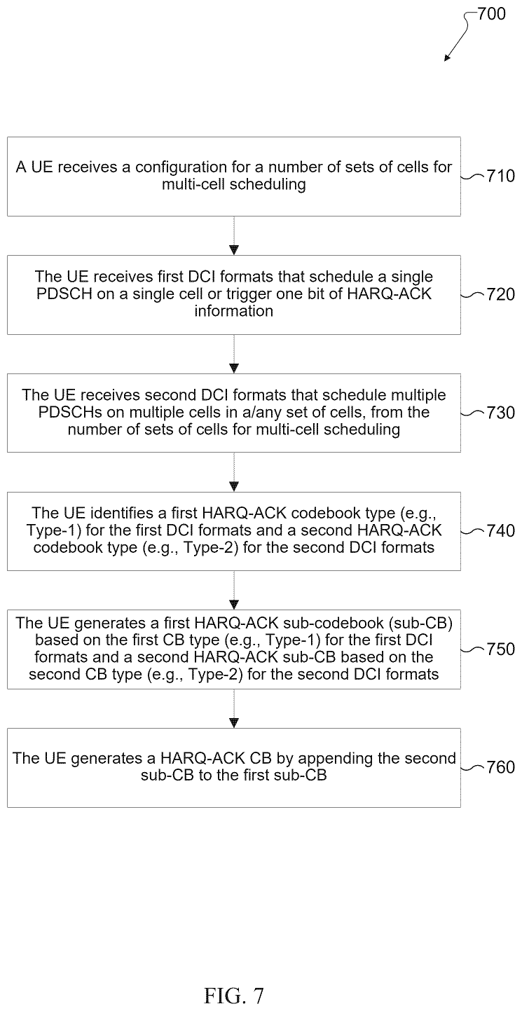

FIG. 7 illustrates a flowchart of an example UE procedure 700 for generating sub-CBs according to embodiments of the present disclosure. For example, UE procedure 700 for generating sub-CBs can be performed by the UE 116 of FIG. 3. This example is for illustration only and other embodiments can be used without departing from the scope of the present disclosure.

The procedure begins in 710, a UE receives a configuration for a number of sets of cells for multi-cell scheduling. In 720, the UE receives first DCI formats that schedule a single PDSCH on a single cell or trigger one bit of HARQ-ACK information. In 730, the UE receives second DCI formats that schedule multiple PDSCHs on multiple cells in a/any set of cells, from the number of sets of cells for multi-cell scheduling. In 740, the UE identifies a first HARQ-ACK codebook type (e.g., Type-1) for the first DCI formats and a second HARQ-ACK codebook type (e.g., Type-2) for the second DCI formats. In 750, the UE generates a first HARQ-ACK sub-codebook (sub-CB) based on the first CB type (e.g., Type-1) for the first DCI formats and a second HARQ-ACK sub-CB based on the second CB type (e.g., Type-2) for the second DCI formats. In 760, the UE generates a HARQ-ACK CB by appending the second sub-CB to the first sub-CB.

In one embodiment, a UE can be configured a first HARQ-ACK codebook type for first DCI formats, such as for a Type-1 codebook for single-cell scheduling DCI formats, and a second HARQ-ACK codebook type for second DCI formats, such as a Type-2 codebook for multi-cell scheduling DCI formats. The UE can transmit a PUCCH or PUSCH that includes only one HARQ-ACK codebook with one HARQ-ACK codebook type, or the UE can concatenate the two HARQ-ACK codebooks that are of different HARQ-ACK codebook and transmit the two codebooks in a same PUSCH or PUCCH.

In one example, the UE can be configured multiple HARQ-ACK codebook types in a PUCCH group, wherein the UE is configured to generate a first HARQ-ACK codebook/sub-codebook according to a first HARQ-ACK codebook type, and a second HARQ-ACK codebook/sub-codebook according to a second HARQ-ACK codebook type. For example, the UE generates a Type-1 HARQ-ACK CB/sub-CB for DCI formats for single-cell scheduling, such as DCI format 1_0/1_1/1_2 (including for self-scheduling), and a Type-2 HARQ-ACK CB/sub-CB for DCI formats for multi-cell scheduling, such as DCI formats 1_3. Such design can be beneficial, for example, since multi-cell scheduling operates based on fast signaling exchange or coordination among, including for DAI values, among different cells, so an operation of Type-2 CB becomes more feasible.

For example, DCI formats that do not schedule a PDSCH (and are used for control purpose) and trigger HARQACK information, such as DCI formats for SPS PDSCH release or configured grant PUSCH release or SCell dormancy indication, or TCI state indication are predetermined or configured to be included among the first DCI formats, for example, associated with a Type-1 CB/sub-CB (alternatively, Type-2 CB/sub-CB).

For example, DCI formats for multi-cell scheduling such as DCI format 1_3 that schedule only a single PDSCH on a single cell can be predetermined or configured to be included among the first DCI formats, for example, associated with a Type-1 CB/sub-CB (alternatively, Type-2 CB/sub-CB).

In one example, the UE generates a HARQ-ACK codebook by concentering the first HARQ-ACK sub-CB with the first HARQ-ACK codebook type and the second HARQ-ACK sub-CB with the second HARQ-ACK codebook type. Accordingly, the UE provides the HARQ-ACK codebook in a PUCCH or a PUSCH transmission.

In another example, the UE provides only one of the first or the second HARQ-ACK codebook in a PUCCH or PUSCH transmission. For example, the UE is configured by higher layers whether a PUCCH resource is associated with the first HARQ-ACK codebook type or the second HARQ-ACK codebook type. For example, the UE is provided a pattern or mapping among PUCCH resources and the HARQ-ACK codebook types. For example, the UE provides a first HARQ-ACK codebook type in first PUCCH resources and a second HARQ-ACK codebook type in second PUCCH resources. For example, a DL DCI that triggers a PUCCH transmission includes a field (such as a one-bit flag) to indicate whether to provide a first or a second HARQ-ACK codebook type on the PUCCH. For example, an UL DCI that schedules a PUSCH transmission includes a field (such as a one-bit flag) to indicate whether to provide a first or a second HARQ-ACK codebook type on the PUSCH.

With reference to FIG. 7, an example procedure is shown for generating separate Type-2 HARQ-ACK sub-CBs for single-cell scheduling and for multi-cell scheduling, with different HARQ-ACK codebook types, such as Type-1 for single-cell scheduling and Type-2 for multi-cell scheduling.

In one embodiment, a UE can be configured a first information element (IE) providing a first type of spatial bundling of HARQ-ACK information in PUSCH/PUCCH for first DCI formats and a second IE providing a second type of spatial bundling of HARQ-ACK information in PUSCH/PUCCH for second DCI formats. For example, the ULE can be configured to provide HARQ-ACK information without spatial bundling for the two TBs of a PDSCH that is scheduled by a single-cell scheduling DCI format, and to provide HARQ-ACK information with spatial bundling for the two TBs of a PDSCH that is scheduled by a multi-cell scheduling DCI format. Such design can be beneficial, for example, to reduce a size of the HARQ-ACK CB.

In one embodiment, when a UE transmits a PUCCH with a UCI that is no larger than 11 bits, the UE determines a number of HARQ-ACK information bits as n_{HARQ-ACK}=n_{HARQ-ACK,TB}+n_{HARQ-ACK,Multi-Cell}, wherein n_{HARQ-ACK,TB} is based on a number of HARQ-ACK information bits in a first sub-codebook, such as for single-cell scheduling DCI formats, and n_{HARQ-ACK,Multi-Cell} is based on a number of HARQ-ACK information bits in a second sub-codebook, such as for multi-cell scheduling.

For example, the UE generates a single Type-2 sub-CB across different sets of cells for multi-cell scheduling according to one or more embodiments described herein.

For example, let O_{ACK} denote a number of HARQ-ACK information bits, O_{SR} denote a number of scheduling request (SR) bits, and let O_{CSI} denote a number of CSI report bits. For example, the formula n_{HARQ-ACK}=n_{HARQ-ACK,TB}+n_{HARQ-ACK,Multi-Cell} applies when O_{ACK}+O_{SR}+O_{CSI}≤11.

For example, the following holds for the first Type-2 sub-CB:

$${n}_{H A R Q - A C K , T B} = ( ( {V}_{DAI , {m}_{last}}^{D L} - {\sum }_{c = 0}^{{N}_{cells}^{D L} - 1} {U}_{D A I , c} ) mod ( {T}_{D} ) ) {N}_{TB , max}^{D L} + {\sum }_{c = 0}^{{N}_{cells}^{D L} - 1} ( {\sum }_{m = 0}^{M - 1} {N}_{m , c}^{r e c e i v e d} + {N}_{S P S , c} ) + {\sum }_{g = 0}^{G - 1} ( ( ( {V}_{DAI , {m}_{last , g}}^{D L} - {\sum }_{c = 0}^{{N}_{cells , g}^{D L} - 1} {U}_{D A I , c , g} ) mod ( {T}_{D , g} ) ) {N}_{TB , max , g}^{D L} + {\sum }_{c = 0}^{{N}_{cells , g}^{D L} - 1} ( {\sum }_{m = 0}^{{M}_{g} - 1} {N}_{m , c , g}^{r e c e i v e d} + {N}_{S P S , c , g} ) ) .$$

When multi-cast broadcast service (MBS) is not applicable, the corresponding terms do not contribute to the summation herein, so the formula simplifies as follows:

$${n}_{H A R Q - A C K , T B} = ( ( {V}_{DAI , {m}_{last}}^{D L} - {\sum }_{c = 0}^{{N}_{cells}^{D L} - 1} {U}_{D A I , c} ) mod ( {T}_{D} ) ) {N}_{TB , max}^{D L} + {\sum }_{c = 0}^{{N}_{cells}^{D L} - 1} ( {\sum }_{m = 0}^{M - 1} {N}_{m , c}^{r e c e i v e d} + {N}_{S P S , c} ) ,$$

wherein terms are defined in [REF3][TS 38.213, v 17.4.0]. For example,

$${N}_{cells}^{D L}$$

is a number of serving cells where the UE is configured to receive unicast PDSCHs (that are scheduled by single-cell or multi-cell scheduling DCI format).

For example, a contribution of the second sub-CB is based on the following:

$${n}_{HARQ - ACK , Multi - Cell} = ( ( {V}_{DAI , {m}_{last}}^{D L} - {\sum }_{s = 0}^{{N}_{s e t s}^{DL , Multi - Cell} - 1} {U}_{D A I , s}^{Multi - Cell} ) mod ( {T}_{D} ) ) {N}_{H A R Q - ACK , max}^{Multi - Cell , max} + {\sum }_{s = 0}^{{N}_{s e t s}^{DL , Multi - Cell} - 1} {\sum }_{m = 0}^{M - 1} {N}_{m , s}^{r e c e i v e d , Multi - Cell} .$$

For example,
If

$${N}_{cells}^{DL} = 1 , {V}_{DAI , {m}_{last}}^{DL}$$

is the value of the counter DAI in the last multi-cell scheduling DCI format (such as DCI format 1_3) scheduling more than one PDSCH receptions on more than one cell, from any sets of cells for multi-cell scheduling, that the UE detects within the M PDCCH monitoring occasions;
if

$${N}_{cells}^{DL} > 1 , {V}_{DAI , {m}_{last}}^{DL}$$

is the value of the total DAI in the last multi-cell scheduling DCI format (such as DCI format 1_3) scheduling more than one PDSCH receptions on more than one cell, from any sets of cells for multi-cell scheduling, that the UE detects within the M PDCCH monitoring occasions;

$${V}_{DAI , {m}_{last}}^{DL} = 0 ,$$

if the UE (e.g., the UE 116) does not detect any multi-cell scheduling DCI format (such as DCI format 1_3) scheduling more than one PDSCH receptions on more than one cell, from any sets of cells for multi-cell scheduling, in any of the M PDCCH monitoring occasions.

$${U}_{DAI , s}^{Multi - Cell}$$

is the total number of multi-cell scheduling DCI formats (such as DCI format 1_3) scheduling more than one PDSCH receptions on more than one cell in a set s of cells for multi-cell scheduling, from the

$${N}_{sets}^{DL , Multi - Cell}$$

sets of cells, that the UE detects within the M PDCCH monitoring occasions for the set of cells s.

$${U}_{DAI , s}^{Multi - Cell} = 0$$

if the UE does not detect any multi-cell scheduling DCI formats (such as DCI format 1_3) scheduling more than one PDSCH receptions on more than one cell, from a set s of cells for multi-cell scheduling, in any of the M PDCCH monitoring occasions.
   Alternatively,

$${U}_{DAI , s}^{Multi - Cell}$$

can be replaced with

$${U}_{DAI , c}^{Multi - Cell}$$

that is the total number of multi-cell scheduling DCI formats (such as DCI format 1_3) scheduling more than one PDSCH receptions on more than one cell in a set of cells for multi-cell scheduling that has serving cell c as the reference cell, from the

$${N}_{Ref - Cells}^{DL , Multi - Cell}$$

reference cells for sets of cells for multi-cell scheduling, that the UE detects within the M PDCCH monitoring occasions for the set of cells with reference cell as cell c.

$${U}_{DAI , c}^{Multi - Cell} = 0$$

if the UE does not detect any multi-cell scheduling DCI formats (such as DCI format 1_3) scheduling more than one PDSCH receptions on more than one cell, from a set of cells for multi-cell scheduling that has serving cell c as the reference cell, in any of the M PDCCH monitoring occasions;
For example, a reference cell for a set of cells is a corresponding scheduling cell if the scheduling cell is included in the set of cell and the scheduling cell is the only cell in the set of cells with a search space for monitoring multi-cell scheduling DCI format, such as DCI format 0_3/1_3, with unique search space set ID (that is, without a linked search space set having a same search space set ID);
For example, a reference cell for a set of cells is a cell from the set of cells that is provided a (linked) search space set for monitoring multi-cell scheduling DCI format, such as DCI format 0_3/1_3, and has a same search space set ID as an (original) search space set for monitoring the multi-cell scheduling DCI format on the scheduling cell;

$${T}_{D} = {2}^{{N}_{C - DAI}^{DL}} where {N}_{C - DAI}^{DL}$$

the number of bits for the counter DAI field in unicast DCI formats for multi-cell scheduling (such as DCI format 1_3);

$${N}_{HARQ - ACK , max}^{Multi - Cell , max}$$

is a number of HARQ-ACK information bits that the UE generates in response to detecting a multi-cell scheduling DCI format (such as DCI format 1_3) scheduling more than one PDSCH receptions on more than one cell, from any sets of cells for multi-cell scheduling. For example,

$${N}_{HARQ - ACK , max}^{Multi - Cell , max}$$

is a maximum number of TBs across configured cell combinations for any set of cells, from the

$${N}_{sets}^{DL , Multi - Cell}$$

sets of cells for multi-cell scheduling;
m is an index for a monitoring occasion within the MPDCCH monitoring occasions;

$${N}_{m , s}^{received , Multi - Cell}$$

is a number of transport blocks in PDSCHs that the UE receives in the more than one cells in a set s of cells for multi-cell scheduling, from the

$${N}_{s e t s}^{DL , Multi - Cell}$$

sets of cells for multi-cell scheduling, in PDCCH monitoring occasion m and the UE reports corresponding HARQ-ACK information in the PUCCH.
   When spatial bundling of HARQ-ACK information in PUCCH is enabled,

$${N}_{m , s}^{received , Multi - Cell}$$

refers to “a number of PDSCHs that . . . ” rather than “a number of transport blocks in PDSCHs that . . . ”;

$${N}_{m , s}^{received , Multi - Cell}$$

can be replaced by

$${N}_{m , c}^{received , Multi - Cell} ,$$

wherein c is an index of a reference cell for the corresponding set of cells.

In one embodiment, when a UE indicates a capability for HARQ-ACK generation based on processing more than one unicast DL MC-DCI 1_3 per cell or per set of cells configured for multi-cell scheduling in a same PDCCH monitoring occasion (MO) or in a same slot of the scheduling cell, the UE counts the cell or the set of serving cells a number

$${N}_{MC - DCI}^{M O}$$

times in each PDCCH MO index ‘m’ in a pseudo-code for Type-2 HARQ-ACK codebook generation, wherein

$${N}_{MC - DCI}^{M O}$$

is the number of unicast DL MC-DCI 1_3 that the UE can process in a same MO or slot. Accordingly, the cell or the set of serving cells can be checked a corresponding number of times for MC-DCIs that can schedule the cell or the set of serving cells in a corresponding PDCCH MO index ‘m’, and the UE can generate a corresponding number of sets of HARQ-ACK information bits if the UE has processed multiple MC-DCIs for the same cell or the same set of cells in the corresponding MO.

For example, the UE can indicate, by a new UE capability, such as type2-HARQ-ACK-Codebook-MC-DCI, a support for Type-2 HARQ-ACK codebook generation based on processing more than one unicast DL MC-DCI 1_3 per cell or per set of cells configured for multi-cell scheduling in a same PDCCH monitoring occasion (MO) or in a same slot of the scheduling cell. For example, such UE capability type2-HARQ-ACK-Codebook-MC-DCI can be reported per band combination (BC) or per UE. For example, such UE capability type2-HARQ-ACK-Codebook-MC-DCI can have as prerequisite a UE capability for DL multi-cell scheduling (such as FG 49-1) or a UE capability for DL multi-cell scheduling with different/mixed numerology (such as FG 49-1b) or a UE capability for processing more than one unicast MC-DCI per cell or per set of cells in a same slot or in N consecutive slots of the scheduling cell (as described further herein, herein referred to as Advanced-MC-DCI-processing-r18). For example, the UE can report a support for such UE capability type2-HARQ-ACK-Codebook-MC-DCI separately from a UE capability type2-HARQ-ACK-Codebook (FG 18-9) for Type-2 HARQ-ACK codebook generation based on processing more than one unicast DL SC-DCI 1_0/1_1/1_2 per cell in a same PDCCH MO or in a same slot of the scheduling cell.

In one example, when the UE indicates a UE capability type2-HARQ-ACK-Codebook-MC-DCI, the UE counts a set of serving cells

$${N}_{MC - DCI}^{M O}$$

times in each MO. For example, the UE counts a set of serving cells ‘s’ in each MO a number

$${N}_{MC - DCI}^{M O}$$

times when the UE indicates the UE capability type2-HARQ-ACK-Codebook-MC-DCI or the UE capability Advanced-MC-DCI-processing-r18 for a band or BC that includes (the cell or) the set of serving cells. For example, when the UE indicates the UE capability type2-HARQ-ACK-Codebook-MC-DCI or the UE capability Advanced-MC-DCI-processing-r18 in a per-UE setting, the UE counts any/all sets of serving cells in each MO a number

$${N}_{MC - DCI}^{M O}$$

times

An example specification text to capture such UE behavior can be as follows:

```
$Set {N}_{cells , set}^{DL , max} to the maxium number of serving cells in ScheduledCel l - ListDC I \text{-1-3} of a set of$
  serving cells provided by MC-DCI-SetofCells, across the number of sets of serving cells,
  that can be scheduled PDSCH receptions by DCI format 1_3
$Set {N}_{sets}^{TB , max} to the maximum total number of TBs in PDSCH receptions that can be scheduled by$
  a DCI format 1_3 over more than one serving cells in a setof serving cells across the number
  of sets of serving cells
$Set {N}_{s e t s}^{D L} to the number of sets of serving cells M C - DC I - S etofCells in a PUCCH group$
- if the UE indicates type 2-HARQ-ACK-Codebook-MC-DCI, a set of serving cells MC-DCI-
  $SetofCells is counted {N}_{M C - D C I}^{M O} times where$
  ${N}_{M C - D C I}^{M O} is the number of DCI formats 1 \_ 3 in$
  PDCCH receptions at a same PDCCH monitoring occasion (corresponding to the set of serving cells)
  based on the reported value of Advacned-PDCCH-MC-DCI-processing-r 18
Set s to index of sets of serving cells, $s = 0 , … , {N}_{sets}^{DL} - 1$
Set mc to the index of a serving cell, in a set of indexes of serving cells arranged in ascending
$order , from the set of {N}_{cells , sets}^{DL , max}$
$serving cell s , mc = 0 , … , {N}_{cells , sets}^{DL , max} - 1$
Set m = 0 − PDCCH monitoring occasion index for detection of a DCI format 1_3 scheduling
  PDSCH receptions on serving cells from a set of serving cells: lower index corresponds to
  earlier PDCCH monitoring occasion
Set j = 0
Set Vₜₑₘₚ = 0
Set Vₜₑₘₚ₂ = 0
Set Vₛ = ∅
Set M to the number of PDCCH monitoring occasions
while m < M
  s = 0
  if harq-ACK-SpatialBundlingPUCCH is not provided,
while $s < {N}_{sets}^{DL}$
            *** < Unchanged parts are omitted > ***
```

In one example, the sentence “if the UE indicates type2-HARQ-ACK-Codebook-MC-DCI, a set of serving cells MC-DCI-SetofCells is counted . . . ” can be replaced by “if the UE indicates type2-HARQ-ACK-Codebook-MC-DCI for a set of serving cells MC-DCI-SetofCells, the set of serving cells MC-DCI-SetofCells is counted . . . ”, for example, when the UE reports the UE capability per band or per BC, so that the UE behavior applies only to bands or BCs where the UE has indicated the support for the corresponding UE capability.

In one example, the UE capability type2-HARQ-ACK-Codebook-MC-DCI or counting of a set of serving cells in each MO a number

$${N}_{MC - DCI}^{M O}$$

times can be based on a (maximum) number of PDSCH receptions that can be scheduled on at least one cell from the set of cells or on cells in the set of serving cells using (more than one) MC-DCI formats 1_3 in (more than one) PDCCHs in a corresponding PDCCH MO. For example, the parameter

$${N}_{MC - DCI}^{M O}$$

can be referred to as/replaced by parameter

$${N}_{P D S C H}^{M O} .$$

In one example, methods and examples herein apply to a second Type-2 HARQ-ACK sub-codebook (sub-CB) that the UE determines in association with MC-DCI formats 1_3 that schedule more than one PDSCHs on respective more than one serving cells from a set of cells configured for multi-cell scheduling.

In another example, similar methods and examples herein can apply to a first Type-2 HARQ-ACK sub-codebook (sub-CB) that the UE determines in association with unicast SPS PDSCH receptions or with any unicast DCI format scheduling PDSCH reception on a single serving cell, or having associated HARQ-ACK information without scheduling a PDSCH reception. For example, when the UE indicates a UE capability type2-HARQ-ACK-Codebook-MC-DCI, the UE counts a serving cell ‘c’ in each MO a number

$${N}_{MC - DCI}^{M O}$$

times. For example, the MC-DCI format 1_3 can schedule a single serving cell up to

$${N}_{MC - DCI}^{M O}$$

times in a same MO. In another example, a (typical) UE capability type2-HARQ-ACK-Codebook-r16 can be modified so that it includes MC-DCI format 1_3 as well.

In one example, for a UE that is capable of multi-cell scheduling, the UE can report a capability for a number of unicast DCI formats that the UE can process per slot or per a number of consecutive slots. A unicast DCI format can be a single-cell scheduling DCI (SC-DCI) format such as DCI format 0_0/1_0/0_1/1_1/0_2/1_2 or a multi-cell scheduling DCI (MC-DCI) format 0_3/1_3. There can be various options in terms of processing only one of MC-DCI or SC-DCI or both of them, and also in terms of counting the processed unicast DCI formats per scheduled cell or per set of cells for multi-cell scheduling.

In one option, the UE capability can be to process 1 (or 2) unicast DCI formats (SC-DCI or MC-DCI) per set of cells for multi-cell scheduling (for example, 1 unicast DCI scheduling DL, or 1 unicast DCI scheduling UL for FDD scheduling cell, or 2 unicast DCIs scheduling UL for TDD scheduling cell).

In another option, the UE capability can be to process either 1 (or 2) unicast MC-DCI formats per set of cells, or 1 (or 2) unicast SC-DCI formats per scheduled cell (in the set of cells). For example, when the UE detects a DL MC-DCI format 1_3 in a slot for a set of cells, the UE does not need to detect any DL SC-DCI for any cell in the set of cells in that slot (when scheduling cell has an SCS that is smaller than or equal to an SCS of the set of cells). For example, when the UE does not detect a DL MC-DCI format 1_3 in a slot for a set of cells, the UE capability can be to process 1 DL SC-DCI for each cell in the set of cells in that slot. For example, the UE capability can be processing either 1 UL MC-DCI for a set of cells for multi-cell scheduling in a slot, otherwise 1 UL SC-DCI for each cell from the set of cells in the slot, for FDD scheduling cell. For example, the UE capability can be processing either 2 UL MC-DCI for a set of cells for multi-cell scheduling in a slot, otherwise 2 UL SC-DCIs for each cell from the set of cells in the slot, for TDD scheduling cell.

In another option, the UE capability can be to process 1 (or 2) unicast DCI formats (SC-DCI or MC-DCI) for a reference cell of a set of cells for multi-cell scheduling, and also process 1 (or 2) unicast SC-DCI formats for each non-reference cell from the set of cells.

In yet another option, the UE capability can be to process 1 (or 2) unicast MC-DCI formats per set of cells and also processes 1 (or 2) unicast SC-DCI formats per scheduled cell (in the set of cells).

In various options, the number of unicast MC-DCI/SC-DCI are per slot of scheduling cell when the scheduling cell has an SCS configuration that is smaller than or equal to an SCS configuration of the set of cells, or are per N consecutive slots of the scheduling cell when the scheduling cell has an SCS configuration that is N times larger than (e.g., N=2, 4, 8, . . . ) an SCS configuration of the set of cells.

In yet another option, the UE capability can be to process 1 (or 2) unicast DCI (MC-DCI or SC-DCI) per set of cells when the UE is configured to monitor a PDCCH for MC-DCI in the 1 slot or N consecutive slots of the scheduling cell, and UE can process 1 (or 2) unicast SC-DCI per scheduled cell (in the set of cells) when the UE is not configured to monitor a PDCCH for MC-DCI in the 1 slot or N consecutive slots of the scheduling cell.

In a further option, the UE capability can be to process 1 (or 2) unicast MC-DCI per set of cells per 1 slot or per N consecutive slots of the scheduling cell, and to process 1 (or 2) unicast SC-DCI for each cell from the set of cells that is not scheduled by the MC-DCI in the 1 or N slots.

In one example, the options herein for processing MC-DCI and SC-DCI can be conditioned on the UE supporting both a first UE capability for MC-DCI processing and also a second UE capability for SC-DCI processing. For example, for a UE that reports a first UE capability only for MC-DCI processing and does not report a second UE capability for SC-DCI processing, the first UE capability can be to process 1 (or 2) unicast MC-DCIs per set of cells per 1 slot or per N consecutive slots of the scheduling cell and no processing of any SC-DCI for any cell from the set of cells. In another example, the UE capability can be to process 1 (or 2) unicast MC-DCIs per set of cells per 1 slot or per N consecutive slots of the scheduling cell and no processing of any SC-DCI for any cell from the set of cells (regardless of support or no support for a second UE capability for SC-DCI processing).

In one example, a UE capability for processing both MC-DCI and SC-DCI can be restricted to certain cells, and no SC-DCI processing may be supported for other cells in the set of cells. For example, the UE capability can be to process one or both of 1 (or 2) MC-DCI per set of cells and/or 1 (or 2) SC-DCI for one or more of a primary cell (PCell) or a PSCell or an sPCell or a PUCCH-SCell or a secondary PUCCH-SCell or a scheduling cell of the set of cells, or a reference cell of the set of cells (as described herein) per 1 slot or per N consecutive slots of the scheduling cell, while for other cells in the set of cells, the UE is not expected to process any SC-DCI in the 1 or N slots. For example, the UE does not process SC-DCI for such other cells regardless of whether or not the MC-DCI schedules a PDSCH/PUSCH on any cell from such other cells. For example, the UE processes 1 (or) unicast SC-DCI for each cell from the one or more of a primary cell (PCell) or a PSCell or an sPCell or a PUCCH-SCell or a secondary PUCCH-SCell or a scheduling cell of the set of cells, or a reference cell of the set of cells when the cell is not scheduled by the MC-DCI in the 1 or N slots.

In one example, the UE capability for processing SC-DCI in addition to/in parallel with MC-DCI can be restricted to certain DCI formats or certain RNTI. For example, a unicast SC-DCI in options and examples herein can refer (only) to DCI format 0_0/1_0, or (only) to DCI format 0_1/1_1, or (only) for SC-DCI formats with CRC scrambled by one or more of: system information RNTI (SI-RNTI), random access RNTI (RA-RNTI), paging RNTI (P-RNTI), CS-RNTI, temporary cell-radio network temporary identifier (TC-RNTI), MsgB-RNTI, semi-persistent CSI RNTI (SP-CSI-RNTI), and so on.

In various options, the number “1 (or 2)” unicast SC-DCI/MC-DCI refers, for example, to 1 DCI scheduling DL, or 1 DCI scheduling UL from an FDD scheduling cell, or 2 DCIs scheduling UL from a TDD scheduling cell. In various options, separate (advanced) UE capabilities can be defined by replacing the number “1 (or 2)” with a number X, where X can have a value set such as {2} or {2, 4} or {2, 4, 6} or {2, 4, 8}, or {2, 4, 6, 8}, or {1, 2}, {1, 2, 4} or {1, 2, 4, 8}, {1, 2, 4, 6} or {1, 2, 4, 6, 8}. For example, parameter X for the advanced UE capabilities can be defined in terms of a parameter N that is the SCS ratio between the SCS of the scheduling cell and the SCS of the set of co-scheduled cells. For example, parameter X can take value from a value set {1, 2¹, 2², . . . , N} where N=2^{μ}^{_{1−μ}}^{₂} with μ₁ and μ2 corresponding to SCS configurations of the (active BWPs) of the set of co-scheduled cells and the scheduling cell, respectively (or vice versa). For example, the advanced UE capability can be applicable (only) for the low-to-high SCS scenario, wherein the SCS configuration of the scheduling cell is smaller than or equal to an SCS configuration for the set of cells for multi-cell scheduling. For example, parameter X for the advanced UE capabilities can be defined in terms of a (maximum) number of cells in the set of cells. For example, parameter X can take value from a value set {1, 2, 3, 4} or a value set {1, 2, . . . , M} where M is a maximum number of cells in a set of cells that is supported by the UE or a maximum number of co-scheduled cells by an MC-DCI format 0_3/1_3 that is supported by the UE (for a corresponding band or band combination). In one example, a value set of X can be based on both the SCS ratio and the number of co-scheduled cells, so that parameter X can take value from a value set {1, 2¹, 2², . . . , N}×{1, 2, 3, 4} or {1, 2¹, 2², . . . , N}×{1, 2, . . . , M}, where M is as defined herein, and operation ‘×’ refers to cartesian product of two sets of cells. In one example, value 1 can be excluded from the value sets herein, and only values >1 can be reported.

In one example, the advanced UE capabilities can be defined with certain restrictions. For example, the value X only refers to a number of unicast MC-DCI per set of cells per 1 or N consecutive slots, and does not apply to a number of unicast SC-DCIs in the 1 or N slots that the UE can process. For example, the UE does not processes any unicast SC-DCI for any cell from the set of cells in the 1 or N slots, or the UE can process only 1 (or 2) unicast SC-DCI in the 1 or N slots for each cell from the set of cells or for each cell from the set of cells that is not scheduled by any of the X unicast MC-DCIs, or for each cell from the one or more of a primary cell (PCell) or a PSCell or an sPCell or a PUCCH-SCell or a secondary PUCCH-SCell or a scheduling cell of the set of cells, or a reference cell of the set of cells, and so on. For example, the UE can process more than 1 (or 2) unicast SC-DCIs in the 1 or N slots for a cell (as described herein) when the UE separately report an Advanced capability for processing multiple SC-DCIs in 1 or N slots.

In one example, the X unicast MC-DCIs in 1 or N slots can be for separate cell combinations/subsets from the set of cells, while in another example, the X unicast MC-DCIs in 1 or N slots can be for overlapping or identical cell combinations/subsets from the set of cells.

In one example, the Advanced UE capability for MC-DCI can be based on a maximum number of PDSCHs/PUSCHs that can be scheduled on a same cell per 1 slot or N consecutive slots using one or more MC-DCIs. For example, the UE capability can be to process Y unicast MC-DCI formats per 1 slot or N slots wherein the Y MC-DCI formats can be such that any cell from the set of cells can be scheduled up to X PDSCHs/PUSCHs per 1 slot or N consecutive slots. For example, Y≥X. For example, the value Y may not be reported by the UE and can be up to gNB (e.g., the BS 102) scheduling or configuration implementation. For example, when the set of cells includes cells {1, 2, 3, 4} and UE reports X=2, the UE can process of the following MC-DCI formats: a first MC-DCI format scheduling cells {1, 2, 3}, a second MC-DCI scheduling cells {1, 2, 4}, and a third MC-DCI format scheduling cells {3, 4}, so that Y=3; alternatively, the UE can process of the following MC-DCI formats: a first MC-DCI scheduling cells {1, 2}, a second MC-DCI scheduling cells {2, 3}, a third MC-DCI scheduling cells {3, 4}, and a fourth MC-DCI scheduling cells {1, 4}, so that Y=4.

For example, a UE feature group (FG) 49-1 can refer to a UE capability for DL multi-cell scheduling via DCI format 1_3 when the scheduling cell has same SCS configuration as the set of cells for multi-cell scheduling. For example, FG 49-1b can refer to a UE capability for DL multi-cell scheduling via DCI format 1_3 when the scheduling cell has different SCS configuration than the set of cells for multi-cell scheduling. For example, FG 49-2 can refer to a UE capability for UL multi-cell scheduling via DCI format 0_3 when the scheduling cell has same SCS configuration as the set of cells for multi-cell scheduling. For example, FG 49-2b can refer to a UE capability for UL multi-cell scheduling via DCI format 0_3 when the scheduling cell has different SCS configuration than the set of cells for multi-cell scheduling.

For example, a component in FG 49-1 can be for a number of unicast DCI formats that the UE can process:
One unicast DCI (SC-DCI or MC-DCI) for scheduling DL per slot per reference cell of a set of cells configured for multi-cell scheduling & one unicast SC-DCI for scheduling DL per slot per non-reference cell of the set of cells, for FDD/TDD scheduling cell.

For example, a component in FG 49-2 can be for a number of unicast DCI formats that the UE can process:
One unicast DCI (SC-DCI or MC-DCI) for scheduling UL per slot per reference cell of a set of cells configured for multi-cell scheduling & one unicast SC-DCI for scheduling UL per slot per non-reference cell of the set of cells, for FDD scheduling cell;
Two unicast DCIs (SC-DCI or MC-DCI) for scheduling UL per slot per reference cell of a set of cells configured for multi-cell scheduling & two unicast SC-DCIs for scheduling UL per slot per non-reference cell of the set of cells, for TDD scheduling cell;
For example, a component in FG 49-1b can be for a number of unicast DCI formats that the UE can process:
For low-to-high SCS:
   One unicast DCI (SC-DCI or MC-DCI) for scheduling DL per slot of scheduling cell per reference cell of a set of cells configured for multi-cell scheduling & one unicast SC-DCI for scheduling DL per slot of scheduling cell per non-reference cell of the set of cells, for FDD/TDD scheduling cell;
For high-to-low SCS:
   One unicast DCI (SC-DCI or MC-DCI) for scheduling DL per N consecutive slots of scheduling cell per reference cell of a set of cells configured for multi-cell scheduling & one unicast SC-DCI for scheduling DL per N consecutive slots of scheduling cell per non-reference cell of the set of cells, for FDD/TDD scheduling cell;
   N=2 for (30, 15), (60, 30), (120, 60), (240, 120), and (480, 240); N=4 for (60, 15), (120, 30), (240, 60), and (480, 120); N=8 for (120, 15), (240, 30), and (480, 60); N=16 for (240, 15), (480, 30); N=32 for (480, 15).

For example, a component in FG 49-2b can be for a number of unicast DCI formats that the UE can process:
For low-to-high SCS:
   One unicast DCI (SC-DCI or MC-DCI) for scheduling UL per slot of scheduling cell per reference cell of a set of cells configured for multi-cell scheduling & one unicast SC-DCI for scheduling UL per slot of scheduling cell per non-reference cell of the set of cells, for FDD scheduling cell;
   Two unicast DCIs (SC-DCI or MC-DCI) for scheduling UL per slot of scheduling cell per reference cell of a set of cells configured for multi-cell scheduling & two unicast SC-DCIs for scheduling UL per slot of scheduling cell per non-reference cell of the set of cells, for TDD scheduling cell;
For high-to-low SCS:
   One unicast DCI (SC-DCI or MC-DCI) for scheduling UL per N consecutive slots of scheduling cell per reference cell of a set of cells configured for multi-cell scheduling & one unicast SC-DCI for scheduling UL per N consecutive slots of scheduling cell per non-reference cell of the set of cells, for FDD scheduling cell;
   Two unicast DCIs (SC-DCI or MC-DCI) for scheduling UL per N consecutive slots of scheduling cell per reference cell of a set of cells configured for multi-cell scheduling & two unicast SC-DCIs for scheduling UL per N consecutive slots of scheduling cell per non-reference cell of the set of cells, for TDD scheduling cell;
   N=2 for (30, 15), (60, 30), (120, 60), (240, 120), and (480, 240); N=4 for (60, 15), (120, 30), (240, 60), and (480, 120); N=8 for (120, 15), (240, 30), and (480, 60); N=16 for (240, 15), (480, 30); N=32 for (480, 15).

For example, a component in FG 49-1 (same SCS) for a baseline UE capability for a number of unicast DL DCI formats that the UE (e.g., the UE 116) can process can be as follows:
The number of unicast DL DCI to process for each cell in a set of cells configured for multi-cell PDSCH scheduling by a DCI format 1_3
   One unicast DCI per slot of scheduling cell for each cell in the set of cells for FDD/TDD scheduling cell
The unicast DCI can be either a typical DCI format or a DCI format 1_3
A DCI format 1_3 can schedule more than one cell from the set of cells
For example, a component in FG 49-2 (same SCS) for a baseline UE capability for a number of unicast UL DCI formats that the UE can process can be as follows:
The number of unicast UL DCI to process for each cell in a set of cells configured for multi-cell PUSCH scheduling by a DCI format 0_3
   One unicast DCI per slot of scheduling cell for each cell in the set of cells for FDD scheduling cell
   Two unicast DCI per slot of scheduling cell for each cell in the set of cells for TDD scheduling cell
unicast DCI can be either a typical DCI format or a DCI format 0_3
A DCI format 0_3 can schedule more than one cell from the set of cells
For example, a component in FG 49-1b (different SCS) for a baseline UE capability for a number of unicast DL DCI formats that the UE can process can be as follows:
For low-to-high SCS:
   One unicast DCI per slot of scheduling cell for each cell in the set of cells for FDD/TDD scheduling cell
For high-to-low SCS:
   One unicast DCI per N consecutive slots of scheduling cell for each cell in the set of cell] for FDD/TDD scheduling cell
   N=2 for (30, 15), (60, 30), (120, 60), (240, 120), and (480, 240); N=4 for (60, 15), (120, 30), (240, 60), and (480, 120); N=8 for (120, 15), (240, 30), and (480, 60); N=16 for (240, 15), (480, 30); N=32 for (480, 15).
unicast DCI can be either a typical DCI format or a DCI format 1_3
A same DCI format 1_3 can schedule more than one cell from the set of cells
For example, a component in FG 49-2b (different SCS) for a baseline UE capability for a number of unicast UL DCI formats that the UE can process can be as follows:
For low-to-high SCS:
The number of unicast UL DCI to process for each cell in a set of cells configured for multi-cell PUSCH scheduling by a DCI format 0_3
   One unicast DCI per slot of scheduling cell for each cell in the set of cells for FDD scheduling cell
   Two unicast DCI per slot of scheduling cell for each cell in the set of cells for TDD scheduling cell
For high-to-low SCS:
The number of unicast UL DCI to process for each cell in a set of cells configured for multi-cell PUSCH scheduling by a DCI format 0_3
   One unicast DCI per N consecutive slots of scheduling cell for each cell in the set of cells for FDD scheduling cell
   Two unicast DCI per N consecutive slots of scheduling cell for each cell in the set of cells for TDD scheduling cell
   N=2 for (30, 15), (60, 30), (120, 60), (240, 120), and (480, 240); N=4 for (60, 15), (120, 30), (240, 60), and (480, 120); N=8 for (120, 15), (240, 30), and (480, 60); N=16 for (240, 15), (480, 30); N=32 for (480, 15).
The unicast DCI can be either a typical DCI format or a DCI format 0_3
A same DCI format 0_3 can schedule more than one cell from the set of cells

In one embodiment, when a UE is provided an MC-DCI format 1_3 in a PDCCH, and the MC-DCI format 1_3 schedules first PDSCHs on first cells from a set of cells, and the UE receives the PDCCH in a monitoring occasion (MO)/slot that is before a BWP change event, the UE can skip the HARQ-ACK information corresponding to one or more or PDSCHs from the first PDSCHs. Herein, the BWP change event can include change for one or more of: an active DL BWP of a cell from the first cells, an active DL BWP of a cell from the set of cells, active DL BWPs of cells from the first cells, active DL BWPs of cells from the set of cells, active UL BWP of PCell or PSCell or PUCCH-SCell or secondary PUCCH-SCell (sPUCCH-SCell). For example, the UE can skip the HARQ-ACK information corresponding to the cell with a change of the active DL BWP. For example, the UE can skip the HARQ-ACK information for cells from the first (co-scheduled) cells when there is a change of active DL BWP for each cell from the first cells or when there is a change of active DL BWP for at least one cell from the first cells.

In one example, HARQ-ACK information for the entire set of cells is skipped in case of (i) active DL BWP change for at least one cell from the set of cells for multi-cell scheduling; or (ii) active UL BWP change for the PCell/PUCCH-SCell. This example can be implemented in the specifications using a text such as that provided in TP #1 herein.

In another example, HARQ-ACK information for the entire set of cells is skipped in case of (i) active DL BWP change for at least one cell from the co-scheduled cells by the MC-DCI format 1_3 that is provided in the PDCCH MO of interest; or (ii) active UL BWP change for the PCell/PUCCH-SCell. This example can be implemented in the specifications using a text such as that provided in TP #2 herein.

In another example, HARQ-ACK information for the entire set of cells is skipped in case of (i) active DL BWP change for cells from the set of cells for multi-cell scheduling; or (ii) active UL BWP change for the PCell/PUCCH-SCell.

In another example, HARQ-ACK information for the entire set of cells is skipped in case of (i) active DL BWP change for cells from the co-scheduled cells by the MC-DCI format 1_3 that is provided in the PDCCH MO of interest; or (ii) active UL BWP change for the PCell/PUCCH-SCell.

In yet another example, HARQ-ACK information for the entire set of cells is skipped only in case of active UL BWP change for the PCell/PUCCH-SCell. For example, in case of active DL BWP change for one or more cells from the set of cells or from the co-scheduled cells, only HARQ-ACK information for the corresponding one or more cell is skipped (e.g., a NACK value is provided). This example can be implemented in the specifications using a text such as that provided in TP #3 herein.

In a further example, HARQ-ACK skipping due to BWP change is not on the level of a set of serving cells, rather applies to serving cells individually. For example, an active UL BWP change for the PCell/PUCCH-SCell is also provided as part of event for HARQ-ACK skipping for a serving cell along with a change of active DL BWP on the serving cell. This example can be implemented in the specifications using a text such as that provided in TP #4 herein.

In one example, at least for the case of multi-cell scheduling with a single DCI format such as DCI format 1_3, HARQ-ACK skipping applies only to UL BWP change, but not for DL BWP change. For example, when a PDCCH providing a DCI format 1_3 is before an UL BWP change for the PCell or the cell for PUCCH transmission, and the PUCCH transmission with HARQ-ACK information corresponding to the DCI format 1_3 is after the UL BWP change, the UE generates NACK for the DCI format 1_3, such as a block of NACKs for the DCI format 1_3 in a position corresponding to the DAI associated with the DCI format 1_3. For example, when a PDCCH providing a DCI format 1_3 is before a DL BWP change for a serving cell, from the cells scheduled by the DCI format 1_3, (and the/a DL BWP change on the corresponding cell is not triggered in a same PDCCH MO as an MO for the PDCCH providing the DCI format 1_3), the UE does not skip the HARQ-ACK information for the DCI format 13, for example, the UE generates the HARQ-ACK information without any regards to the DL BWP change occurrence (e.g., no NACK instead of the HARQ-ACK information for the cell with DL BWP change, or no block of NACKs instead of a block of HARQ-ACK information associated with the DCI format 1_3). In one example, the latter can be further conditioned on the PUCCH transmission being after the DL BWP change. In another example, UE behavior for no HARQ-ACK skipping in case of DL BWP change applies regardless of whether or not a PUCCH transmission is after the DL BWP change.

In another variation, skipping of HARQ-ACK for DL BWP change applies only when DL BWP changes occur for co-scheduled cells by the DCI format 1_3 between a PDCCH reception that provides the DCI format 1_3 and a PUCCH transmission with HARQ-ACK for the DCI format 1_3. For example, HARQ-ACK skipping may not apply when at least one cell from the co-scheduled cells by the DCI format 1_3 has no DL BWP change between the PDCCH and the PUCCH.

For example, when a PDCCH providing a DCI format 1_3 is before DL BWP changes for serving cell, from the cells scheduled by the DCI format 1_3, and the (same) DL BWP changes (or in another variation, different DL BWP changes) for those cells are not triggered in a same PDCCH MO as an MO for the PDCCH providing the DCI format 1_3, the UE skips the HARQ-ACK information for the DCI format 1_3, for example, the UE generates a block of NACKs for the DCI format 1_3, in a bit position corresponding to the DAI associated with the DCI format 1_3. In one example, the latter can be further conditioned on the PUCCH transmission being after the corresponding DL BWP changes. For example, when a DCI format 1_3 schedules:
first (zero or) one or more cells with respective first (zero or) one or more DL BWP changes that are after a PDCCH that provides the DCI format 1_3, and before a PUCCH transmission with HARQ-ACK information for the DCI format 1_3, and
second one or more cells without any DL BWP change that is after the PDCCH and before the PUCCH,
   the UE generates the HARQ-ACK information for the DCI format 1_3 without regards to the first (zero or) one or more DL BWP changes on the first (zero or) one or more cells (e.g., no NACK instead of the HARQ-ACK information for the first cells with first DL BWP changes, or no block of NACKs instead of a block of HARQ-ACK information associated with the DCI format 1_3).

In one example, embodiments herein and handling may apply with “co-scheduled cells by a DCI format 1_3” replaced by “cells from a corresponding set of cells for multi-cell scheduling”, along with corresponding changes for the embodiment and examples.

In the examples and embodiments herein, HARQ-ACK skipping for a cell implies, in one alternative, a NACK value (or two NACK values, when applicable, in case of 2-TB configuration for cells) is provided for the cell in a same bit position as for a HARQ-ACK information value for the cell, such as based on an ascending order of cell index for the cell among the co-schedule cells or among the cells in the set of cells for multi-cell scheduling. In another alternative, HARQ-ACK skipping implies a NACK value (or two NACK values, when applicable, in case of 2-TB configuration for cells) is provided for the cell as padding NACK value(s) that are appended to an end of a block of HARQ-ACK information corresponding to the DCI format 1_3, as for cells in the corresponding set of cells that are not scheduled by the DCI format 1_3, if any, regardless of a cell index for the cell.

In one example, HARQ-ACK skipping (or no HARQ-ACK skipping) may apply only to certain HARQ-ACK codebook types or only to certain DCI formats, or may be different for different HARQ-ACK codebook types or different DCI formats. For example, the UE applies HARQ-ACK skipping for one HARQ-ACK codebook type, and does not apply for another HARQ-ACK codebook type. For example, the UE applies HARQ-ACK skipping based on first conditions or settings for one HARQ-ACK codebook type, and applies HARQ-ACK skipping based on second/different conditions or setting for a different HARQ-ACK codebook type. For example, the UE applies HARQ-ACK skipping for one DCI format, and does not apply for another DCI format. For example, the UE applies HARQ-ACK skipping based on first conditions or settings for one DCI format, and applies HARQ-ACK skipping based on second/different conditions or setting for a different DCI format.

For example, HARQ-ACK skipping applies to Type-1 HARQ-ACK codebook, for both UL BWP change on the PCell or the cell with PUCCH transmission, and DL BWP change on one (or more or all) cells scheduled cells by a DCI format. For example, HARQ-ACK skipping for a Type-1 HARQ-ACK codebook can be further conditioned on configuration of different TDRA or different K1 values (i.e., PDSCH to HARQ-ACK timing) between the old/previous active BWP and the new active BWP, before the corresponding DL/UL BWP change. For example, the UE does not apply any HARQ-ACK skipping when TDRA configurations (or K1 configurations) are the same for the old/previous active BWP and the new active BWP, before the corresponding DL/UL BWP change. For example, a UE does not expect to be configured different TDRA tables or different K1 configurations across different DL BWPs of a cell. For example, support of same TDRA table and/or same K1 values across different DL BWPs of a cell can be a default UE capability, and support for different TDRA tables and/or different K1 values across different DL BWPs can be an additional capability that the UE reports (possibly along with reporting a supported value of application delay or timeline for DL BWP switching). For example, HARQ-ACK skipping applies to both single-cell scheduling DCI formats, such as DCI formats 1_0 or 1_1 or 1_2, and multi-cell scheduling DCI formats, such as DCI format 1_3.

For example, HARQ-ACK skipping does not apply to Type-2 HARQ-ACK codebook, regardless of UL BWP change or DL BWP changes, as described herein, or regardless of single-cell scheduling DCI format or multi-cell scheduling DCI format, as described herein. In another example, HARQ-ACK skipping applies to Type-2 HARQ-ACK codebook only for UL BWP change, as described herein, and does not apply to DL BWP change, as described herein. In another example, for a Type-2 HARQ-ACK codebook and in case of DL BWP change, the UE applies HARQ-ACK skipping for single-cell scheduling DCI formats, and does not apply HARQ-ACK skipping for multi-cell scheduling DCI formats. In another example, HARQ-ACK skipping applies to Type-2 HARQ-ACK codebook only for single-cell scheduling DCI formats, for both DL BWP change and UL BWP change, and does not apply to multi-cell scheduling DCI formats, neither for DL BWP change nor for UL BWP change.

In various examples, such as examples herein, HARQ-ACK skipping for cells or for one/some cells due to an active DL BWP change for the cells or one/some cells, applies when the corresponding PDSCH receptions are after the same active DL BWP change. For example, when both PDCCH and the corresponding PDSCH are before the active DL BWP for a cell, the UE (e.g., the UE 116) does not skip the corresponding HARQ-ACK information.

Several example specifications texts are as follows with respect to [REF3][TS 38.213 v. 17.6.0] or with respect to draft [REF3][TS 38.213, v 18.0.0].

A first example text (labeled as TP #1) is as follows:

```
$Set {N}_{sets}^{TB , max} to the maximum total number of TBs in PDSCH receptions that can be scheduled by$
  a DCI format 1_3 over more than one serving cells in a set of serving cells across the number
  of sets of serving cells
$Set {N}_{sets}^{DL} to the number of sets of serving cells MC - DCI - SetofCells in a PUCCH group$
Set s to index of sets of serving cells,  $s = 0 , … , {N}_{sets}^{DL} - 1$
Set mc to the index of a serving cell, in a set of indexes of serving cells arranged in ascending
$order , from the set of {N}_{cells , sets}^{DL , max}$
$serving cells , mc = 0 , … , {N}_{cells , sets}^{DL , max} - 1$
Set m = 0 − PDCCH monitoring occasion index for detection of a DCI format 1_3 scheduling
  PDSCH receptions on serving cells from a set of serving cells: lower index corresponds to
  earlier PDCCH monitoring occasion
Set j = 0
Set Vₜₑₘₚ = 0
Set Vₜₑₘₚ₂ = 0
Set Vₛ = Ø
Set M to the number of PDCCH monitoring occasions
while m < M
  s = 0
  if harq-ACK-SpatialBundlingPUCCH is not provided,
    while $s < {N}_{sets}^{DL}$
      if PDCCH monitoring occasion m is before an active DL BWP change on any/at least
      one serving cell from the set of serving cells s or an active UL BWP change on the
      serving cell of PUCCH transmission if the UE is provided pucch-sSCellDyn or pucch-
      sSCellDynDCI-1-2, or an active UL BWP change on the PCell if the UE is not provided
      pucch-sSCellDyn and pucch-sSCellDynDCI-1-2, and an active DL BWP change is not
      triggered in PDCCH monitoring occasion m
        s = s + 1;
      else
      if there are more than one PDSCHs on respective more than one serving cells from the
      set s of serving cells associated with PDCCH in PDCCH monitoring occasion m
        if   ${V}_{C - DAI , s , m}^{DL} \leq {V}_{temp}$
          j = j + 1;
        end if
            *** <Unchanged parts are omitted> ***
      end if
      s= s + 1;
    end while
  else
    while  $s < {N}_{sets}^{DL}$
      if PDCCH monitoring occasion m is before an active DL BWP change on any/at least
      one serving cell from the set of serving cells s or an active UL BWP change on the
      serving cell of PUCCH transmission if the UE is provided pucch-sSCellDyn or pucch-
      sSCellDynDCI-1-2, or an active UL BWP change on the PCell if the UE is not provided
      pucch-sSCellDyn and pucch-sSCellDynDCI-1-2, and an active DL BWP change is not
      triggered in PDCCH monitoring occasion m
        s = s + 1;
      else
      if there are more than one PDSCHs providing a transport block for a HARQ process with
      enabled HARQ-ACK information on respective more than one serving cells from the set
      s of serving cells associated with PDCCH in PDCCH monitoring occasion m
        if   ${V}_{C - DAI , s , m}^{DL} \leq {V}_{temp}$
          j = j+ 1;
            *** <Unchanged parts are omitted> ***
        end if
      end if
      s = s + 1;
    end while
  end if
  m = m+ 1;
end while
${V}_{temp} = ( j mod ( \frac{4}{{T}_{D}} ) ) \times ( \frac{4}{{T}_{D}} ) + {V}_{temp} ;$
if UE does not set  ${V}_{temp 2} = {V}_{T - DAI}^{UL , 2} and {T}_{D} = 2$
  Vₜₑₘₚ₂ = Vₜₑₘₚ;
end if
$j = ⌊ \frac{j \times {T}_{D}}{4} ⌋ ;$
if Vₜₑₘₚ₂ < Vₜₑₘₚ
  j = j+ 1;
end if
if harq-ACK-SpatialBundlingPUCCH is not provided,
  ${O}^{ACK} = {N}_{sets}^{TB , max} \cdot ( 4 \cdot j + {V}_{temp 2} )$
else
  ${O}^{ACK} = {N}_{cells , set}^{DL , max} \cdot ( 4 \cdot j + {V}_{temp 2} )$
end if
${\tilde{O}}_{i}^{ACK} = NACK for any i ∈ \{ 0 , 1 , ⋯ , {O}^{ACK} - 1 \} ∖ {V}_{s} .$
```

Another example specifications text (labeled as TP #2) can be as follows (with more repeated text omitted herein):

```
          *** <Unchanged parts are omitted> ***
Set M to the number of PDCCH monitoring occasions
while m < M
  s = 0
  if harq-ACK-SpatialBundlingPUCCH is not provided,
    while  $s < {N}_{sets}^{DL}$
      if PDCCH monitoring occasion m is before an active DL BWP change on any/at least
      one serving cell from more than one serving cells, from the set s of serving cells, on
      which respective more than one PDSCHs are scheduled by a DCI format 1_3 that is
      provided in a PDCCH in the PDCCH monitoring occasion m or an active UL BWP
      change on the serving cell of PUCCH transmission if the UE is provided pucch-
      sSCellDyn or pucch-sSCellDynDCI-1-2, or an active UL BWP change on the PCell if the
      UE is not provided pucch-sSCellDyn and pucch-sSCellDynDCI-1-2, and an active DL
      BWP change is not triggered in PDCCH monitoring occasion m
        s= s + 1;
      else
      if there are more than one PDSCHs on respective more than one serving cells from the
      set s of serving cells associated with PDCCH in PDCCH monitoring occasion m
          if  ${V}_{C - DAI , s , m}^{DL} \leq {V}_{temp}$
            j = j + 1;
          end if
            *** <Unchanged parts are omitted> ***
      end if
      s = s + 1;
    end while
  else
    while  $s < {N}_{sets}^{DL}$
      if PDCCH monitoring occasion m is before an active DL BWP change on any / at least
      one serving cell from more than one serving cells, from the set s of serving cells, on
      which respective more than one PDSCHs are scheduled by a DCI format 1 3 that is
      provided in a PDCCH in the PDCCH monitoring occasion m or an active UL BWP
      change on the serving cell of PUCCH transmission if the UE is provided pucch-
      sSCellDyn or pucch-sSCellDynDCI-1-2, or an active UL BWP change on the PCell if the
      UE is not provided pucch-sSCellDyn and pucch-sSCellDynDCI-1-2, and an active DL
      BWP change is not triggered in PDCCH monitoring occasion m
        s = s + 1;
      else
      if there are more than one PDSCHs providing a transport block for a HARQ process with
      enabled HARQ-ACK information on respective more than one serving cells from the set
      s of serving cells associated with PDCCH in PDCCH monitoring occasion m
        if   ${V}_{C - DAI , s , m}^{DL} \leq {V}_{temp}$
          j = j + 1;
            *** < Unchanged parts are omitted> ***
          end if
        end if
        s= s + 1;
      end while
    end if
  m = m + 1;
end while
            *** <Unchanged parts are omitted> ***
```

Yet another example specifications text (labeled as TP #3) can be as follows:

```
              ***<Unchanged parts are omitted>***
Set M to the number of PDCCH monitoring occasions
while m < M
  s = 0
  if harq-ACK-SpatialBundlingPUCCH is not provided,
      while $s < {N}_{sets}^{DL}$
        if PDCCH monitoring occasion m is before an active UL BWP change on the serving
        cell of PUCCH transmission if the UE is provided pucch-sSCellDyn or pucch-
        sSCellDynDCI-1-2, or an active UL BWP change on the PCell if the UE is not provided
        pucch-sSCellDyn and pucch-sSCellDynDCI-1-2 (, and an active DL BWP change is not
        triggered in PDCCH monitoring occasion m)
          s = s + 1;
        else
        if there are more than one PDSCHs on respective more than one serving cells from the
        set s of serving cells associated with PDCCH in PDCCH monitoring occasion m
          if ${V}_{C - DAI , s , m}^{DL} \leq {V}_{temp}$
            j = j + 1;
          end if
          ${V}_{temp} = {V}_{C - DAI , s , m}^{DL} ;$
          if  ${V}_{T - DAI , m}^{DL} = ∅$
          ${V}_{temp 2} = {V}_{C - DAI , s , m}^{DL} ;$
        else
        ${V}_{temp 2} = {V}_{T - DAI , m}^{DL} ;$
        end if
        cnt = 0;
        mc = 0;
        while $mc < {N}_{cells , set}^{DL , max}$
          if PDCCH monitoring occasion m is before an active DL BWP change on serving
          cell mc and an active DL BWP change is not triggered in PDCCH monitoring occasion m
            mc = mc + 1;
          else
          if the UE is scheduled PDSCH reception on serving cell mc, if any, of set s
            if maxNrofCode WordsScheduledByDCI is 2 for serving cell mc, if any, of set s
              ${\tilde{O}}_{{N}_{sets}^{TB , max} \cdot {T}_{D} \cdot j + {N}_{sets}^{TB , max} \cdot ( {V}_{C - DAI , s , m}^{DL} - 1 ) + cnt}^{ACK} = HARQ - ACK$
              information bit corresponding to the first transport block of this cell
              ${\tilde{O}}_{{N}_{sets}^{TB , max} \cdot {T}_{D} \cdot j + {N}_{sets}^{TB , max} \cdot ( {V}_{C - DAI , s , m}^{DL} - 1 ) + 1 + cnt}^{ACK} = HARQ - ACK$
              information bit corresponding to the second transport block of this cell
              cnt = cnt + 2;
            else
              ${\tilde{O}}_{{N}_{sets}^{TB , max} \cdot {T}_{D} \cdot j + {N}_{sets}^{TB , max} \cdot ( {V}_{C - DAI , s , m}^{DL} - 1 ) + cnt}^{ACK} = HARQ - ACK$
              information bit corresponding to the transport block of this cell
            cnt = cnt + 1;
            end if
          end if
          mc = mc + 1;
        end while
      while $cnt < {N}_{sets}^{TB , max}$
        ${\tilde{O}}_{{N}_{sets}^{TB , max} \cdot {T}_{D} \cdot j + {N}_{sets}^{TB , max} \cdot {V}_{C - DAI , s , m}^{DL} - 1 + cnt}^{ACK} = NACK ;$
        cnt = cnt + 1;
      end while
      ${V}_{s} = {V}_{s} ⋃ \{ {N}_{sets}^{TB , max} \cdot {T}_{D} \cdot j + {N}_{sets}^{TB , max} \cdot ( {V}_{C - DAI , s , m}^{DL} - 1 ) , … , {N}_{sets}^{TB , max} \cdot {T}_{D} \cdot j + {N}_{sets}^{TB , max} \cdot ( {V}_{C - DAI , s , m}^{DL} - 1 ) + {N}_{sets}^{TB , max} - 1 \} ;$
      end if
      s = s + 1;
    end while
  else
    while $s < {N}_{sets}^{DL}$
      if PDCCH monitoring occasion m is before an active UL BWP change on the serving
      cell of PUCCH transmission if the UE is provided pucch-sSCellDyn or pucch-
      sSCellDynDCI-1-2, or an active UL BWP change on the PCell if the UE is not provided
      pucch-sSCellDyn and pucch-sSCellDynDCI-1-2 (, and an active DL BWP change is not
      triggered in PDCCH monitoring occasion m)
        s = s + 1;
      else
      if there are more than one PDSCHs providing a transport block for a HARQ process with
      enabled HARQ-ACK information on respective more than one serving cells from the set
      s of serving cells associated with PDCCH in PDCCH monitoring occasion m
        if   ${V}_{C - DAI , s , m}^{DL} \leq {V}_{temp}$
          j = j + 1;
        end if
        ${V}_{temp} = {V}_{C - DAI , s , m}^{DL} ;$
        if   ${V}_{T - DAI , m}^{DL} = ∅$
          ${V}_{temp , 2} = {V}_{C - DAI , s , m}^{DL} ;$
        else
          ${V}_{temp , 2} = {V}_{T - DAI , s , m}^{DL} ;$
        end if
        cnt = 0;
        mc = 0;
    while  $mc < {N}_{cells , set}^{DL , max}$
      if PDCCH monitoring occasion m is before an active DL BWP change on serving
      cell mc, and an active DL BWP change is not triggered in PDCCH monitoring
      occasion m
        mc = mc + 1;
      else
      if the UE (e.g., the UE 116) is scheduled PDSCH reception for transport blocks
        with enabled HARQ-ACK information on serving cell mc, if any, of set s
        if maxNrofCode WordsScheduledByDCI is 2 for serving cell mc
          if the PDSCH reception provides two transport blocks
            ${\tilde{O}}_{{N}_{cells , set}^{DL , max} \cdot {T}_{D} \cdot j + {N}_{cells , set}^{DL , max} \cdot {V}_{C - DAI , s , m}^{DL} - 1 + cnt}^{ACK} = binary$
              AND operation of the HARQ-ACK information bits corresponding to the first and second transport blocks of this cell
                else
              ${\tilde{O}}_{{N}_{cells , set}^{DL , max} \cdot {T}_{D} \cdot j + {N}_{cells , set}^{DL , max} \cdot {V}_{C - DAI , s , m}^{DL} - 1 + cnt}^{ACK} = HARQ - ACK$
              information bit corresponding to the first transport block of this cell
              end if
        else
          ${\tilde{O}}_{{N}_{cells , set}^{DL , max} \cdot {T}_{D} \cdot j + {N}_{cells , set}^{DL , max} \cdot {V}_{C - DAI , s , m}^{DL} - 1 + cnt}^{ACK} = HARQ - ACK$
          information bit of this cell
        end if
        cnt = cnt + 1;
      end if
      mc = mc + 1;
    end while
  while  $cnt < {N}_{cells , set}^{DL , max}$
      ${\tilde{O}}_{{N}_{sets}^{DL , max} \cdot {T}_{D} \cdot j + {N}_{cells , set}^{DL , max} \cdot {V}_{C - DAI , s , m}^{DL} - 1 + cnt}^{ACK} = NACK ;$
        cnt = cnt + 1;
    end while
          ${V}_{s} = {V}_{s} ⋃ \{ {N}_{cells , set}^{DL , max} \cdot {T}_{D} \cdot j + {N}_{cells , set}^{DL , max} \cdot ( {V}_{C - DAI , s , m}^{DL} - 1 ) + 1 … , {N}_{cells , set}^{DL , max} \cdot {T}_{D} \cdot j + {N}_{cells , set}^{DL , max} \cdot ( {V}_{C - DAI , s , m}^{DL} - 1 ) + {N}_{sets}^{DL , max} - 1 \} ;$
          end if
          s= s + 1;
        end while
      end if
      m = m + 1;
    end while
                  *** <Unchanged parts are omitted> ***
```

Yet another example specifications text (labeled as TP #4) can be as follows:

```
            *** <Unchanged parts are omitted> ***
Set M to the number of PDCCH monitoring occasions
while m < M
  s = 0
  if harq-ACK-SpatialBundlingPUCCH is not provided,
    while $s < {N}_{sets}^{DL}$
      if there are more than one PDSCHs on respective more than one
      serving cells from the set s of serving cells associated with
      PDCCH in PDCCH monitoring occasion m
        if ${V}_{C - DAI , s , m}^{DL} \leq {V}_{temp}$
          j = j + 1;
        end if
        ${V}_{temp} = {V}_{C - DAI , s , m}^{DL} ;$
        if ${V}_{T - DAI , m}^{DL} = ∅$
          ${V}_{temp , 2} = {V}_{C - DAI , s , m}^{DL} ;$
        else
          ${V}_{temp , 2} = {V}_{T - DAI , m}^{DL} ;$
        end if
        cnt = 0;
  mc = 0;
  while $mc < {N}_{cells , set}^{DL , max}$
    if PDCCH monitoring occasion m is before an active DL BWP change on serving cell mc or before an active UL BWP
    change on the serving cell of PUCCH transmission if the UE is provided pucch-sSCellDyn or
    pucch-sSCellDynDCI-1-2, or an active UL BWP change on the PCell if the UE is not provided pucch-sSCellDyn
    and pucch-sSCellDynDCI-1-2, and an active DL BWP change is not triggered in PDCCH monitoring occasion m
      mc = mc + 1;
        else
        if the UE is scheduled PDSCH reception on serving cell mc, if any, of set s
          if maxNrofCode WordsScheduledByDCI is 2 for serving cell mc, if any, of set s
            ${\tilde{O}}_{{N}_{sets}^{TB , max} \cdot {T}_{D} \cdot j + {N}_{sets}^{TB , max} \cdot ( {V}_{C - DAI , s , m}^{DL} - 1 ) + cnt}^{ACK} = HARQ - ACK$
            information bit corresponding to the first transport block of this cell
            ${\tilde{O}}_{{N}_{sets}^{TB , max} \cdot {T}_{D} \cdot j + {N}_{sets}^{TB , max} \cdot ( {V}_{C - DAI , s , m}^{DL} - 1 ) + 1 + cnt}^{ACK} = HARQ - ACK$
            information bit corresponding to the second transport block of this cell
            cnt = cnt + 2;
          else
            ${\tilde{O}}_{{N}_{sets}^{TB , max} \cdot {T}_{D} \cdot j + {N}_{sets}^{TB , max} \cdot ( {V}_{C - DAI , s , m}^{DL} - 1 ) + cnt}^{ACK} = HARQ - ACK$
            information bit corresponding to the transport block of this cell
          cnt = cnt + 1;
          end if
        end if
        mc = mc + 1;
      end while
    while $cnt < {N}_{sets}^{TB , max}$
        ${\tilde{O}}_{{N}_{sets}^{TB , max} \cdot {T}_{D} \cdot j + {N}_{cells , set}^{TB , max} \cdot {V}_{C - DAI , s , m}^{DL} - 1 + cnt}^{ACK} = NACK ;$
        cnt = cnt + 1;
      end while
      ${V}_{s} = {V}_{s} ⋃ \{ {N}_{sets}^{TB , max} \cdot {T}_{D} \cdot j + {N}_{sets}^{TB , max} \cdot ( {V}_{C - DAI , s , m}^{DL} - 1 ) , … , {N}_{sets}^{TB , max} \cdot {T}_{D} \cdot j + {N}_{sets}^{TB , max} \cdot ( {V}_{C - DAI , s , m}^{DL} - 1 ) + {N}_{sets}^{TB , max} - 1 \} ;$
      end if
      s = s + 1;
    end while
  else
      while $s < {N}_{sets}^{DL}$
        if there are more than one PDSCHs providing a transport block for a HARQ process with
        enabled HARQ-ACK information on respective more than one serving cells from the set
        s of serving cells associated with PDCCH in PDCCH monitoring occasion m
          if ${V}_{C - DAI , s , m}^{DL} \leq {V}_{temp}$
            j = j + 1;
          end if
          ${V}_{temp} = {V}_{C - DAI , s , m}^{DL} ;$
          if ${V}_{T - DAI , m}^{DL} = ∅$
            ${V}_{temp , 2} = {V}_{C - DAI , s , m}^{DL} ;$
          else
            ${V}_{temp , 2} = {V}_{T - DAI , m}^{DL} ;$
          end if
          cnt = 0;
          mc = 0;
          while $mc < {N}_{cells , set}^{DL , max}$
            if PDCCH monitoring occasion m is before an active DL BWP change on serving cell mc, or before an active UL BWP
            change on the serving cell of PUCCH transmission if the UE is provided pucch-sSCellDyn or pucch-sSCellDynDCI-1-2,
            or an active UL BWP change on the PCell if the UE is not provided pucch-sSCellDyn and pucch-sSCellDynDCI-1-2,
            and an active DL BWP change is not triggered in PDCCH monitoring occasion m
              mc = mc + 1;
            else
            if the UE is scheduled PDSCH reception for transport blocks with enabled HARQ-
              ACK information on serving cell mc, if any, of set s
              if maxNrofCode WordsScheduledByDCI is 2 for serving cell mc
                if the PDSCH reception provides two transport blocks
                  ${\tilde{O}}_{{N}_{cells , set}^{DL , max} \cdot {T}_{D} \cdot j + {N}_{cells , set}^{DL , max} \cdot {V}_{C - DAI , s , m}^{DL} - 1 + cnt}^{ACK} = binary$
                    AND operation of the HARQ-ACK information bits corresponding to the first and second
                    transport blocks of this cell
                      else
                    ${\tilde{O}}_{{N}_{cells , set}^{DL , max} \cdot {T}_{D} \cdot j + {N}_{cells , set}^{DL , max} \cdot {V}_{C - DAI , s , m}^{DL} - 1 + cnt}^{ACK} = HARQ - ACK$
                    information bit corresponding to the first transport block of this cell
                      end if
          else
            ${\tilde{O}}_{{N}_{cells , set}^{DL , max} \cdot {T}_{D} \cdot j + {N}_{cells , set}^{DL , max} \cdot {V}_{C - DAI , s , m}^{DL} - 1 + cnt}^{ACK} = HARQ - ACK$
            information bit of this cell
          end if
          cnt = cnt + 1;
        end if
        mc = mc + 1;
      end while
    while $cnt < {N}_{cells , set}^{DL , max}$
      ${\tilde{O}}_{{N}_{cells , set}^{DL , max} \cdot {T}_{D} \cdot j + {N}_{cells , set}^{DL , max} \cdot {V}_{C - DAI , s , m}^{DL} - 1 + cnt}^{ACK} = NACK ;$
      cnt = cnt + 1;
    end while
    ${V}_{s} = {V}_{s} ⋃ \{ {N}_{cells , set}^{DL , max} \cdot {T}_{D} \cdot j + {N}_{cells , set}^{DL , max} \cdot ( {V}_{C - DAI , s , m}^{DL} - 1 ) + 1 … , {N}_{cells , set}^{DL , max} \cdot {T}_{D} \cdot j + {N}_{cells , set}^{DL , max} \cdot ( {V}_{C - DAI , s , m}^{DL} - 1 ) + {N}_{sets}^{DL , max} - 1 \} ;$
    end if
    s= s + 1;
  end while
end if
      m = m + 1;
    end while
                      *** <Unchanged parts are omitted> ***
```

In example texts herein such as TP #1, #2, #3, and #4, the sentence “and an active DL BWP change is not triggered in PDCCH monitoring occasion m” can be replaced by:
“and an active DL BWP change on any serving cell from the set of serving cells s is not triggered in PDCCH monitoring occasion m”, or
“and an active DL BWP change on serving cells from the set of serving cells s is not triggered in PDCCH monitoring occasion m”, or
“and an active DL BWP change on at least one serving cell from the set of serving cells s is not triggered in PDCCH monitoring occasion m”, or
“and an active DL BWP change on the PCell or the serving cell of PUCCH transmission is not triggered in PDCCH monitoring occasion m”.

In one embodiment, when a UE applies unified TCI states indicated by an MC-DCI format 1_3 for cells that are not scheduled respective PDSCH by the DCI format 1_3, the UE can generate a predetermined ACK value to acknowledge the reception of the DCI format 1_3 for indication of the unified TCI state.

In one example, a DCI format for multi-cell scheduling, such a DCI format 1_3, includes a TCI field whose value is a TCI codepoint that provides TCI states for cells in the corresponding set of cells. For example, the TCI codepoint provides TCI states for both cells that are scheduled by the DCI format 1_3 and cells that are not scheduled by the DCI format 1_3. For example, when the UE is configured unified TCI states, the UE applies the TCI states provided by the TCI codepoint to the cells in the set of cells, regardless of whether or not the cells are scheduled by the DCI format 1_3. In one example, the DCI format 1_3 schedules PDSCH at least on one cell from a corresponding set of cells. In another example, the DCI format 1_3 schedules no PDSCHs on any cell from the corresponding set of cells. In another example, the UE applies the TCI states to cells in the corresponding set of cells when the DCI format 1_3 schedules PDSCH on at least one cell from the set of cells. For example, the UE does not apply TCI states to any cell in the corresponding set of cells when the DCI format does not schedule any PDSCH on any cell from the corresponding set of cells. In another example, the UE applies TCI states to the cells in the corresponding set of cells even when the DCI format does not schedule any PDSCH on any cell from the corresponding set of cells. In another example, the UE applies TCI states only to cells with scheduled PDSCH, and does not apply TCI states to cells without scheduled PDSCH.

In one example, when a UE applies a TCI state to a non-scheduled cell of a DCI format 1_3, the UE applies the TCI state based on TCI configuration and activation provided for a currently active BWP of the respective non-scheduled cell. For example, the UE does not apply the TCI state based on TCI configuration and activation provided for a new active BWP indicated by the BWP field of the DCI format 1_3.

A TCI field of a DCI format 1_3 can indicate TCI states both for co-scheduled cells and non-scheduled cells of a set of cells scheduledCellListDCI-1-3. For example, the set of cells scheduledCellListDCI-1-3 includes cells {1, 2, 3, 4}, and a DCI format 1_3 co-schedules cells {1, 2}. The TCI field of the DCI format 1_3, however, indicates TCI state for both the scheduled cells {1, 2} and the non-scheduled cells {3,4}. In addition, the indicated TCI states apply to other cells outside the set of cells {1, 2, 3, 4}(thereby clearly not scheduled and) in a same CC list by simultaneousU-TCI-UpdateList1/2/3/4-r17.

For example, a UE procedure can be as follows. When tci-PresentlnDCI is set as ‘enabled’ or tci-PresentDCI-1-2 is configured for the CORESET, a UE configured with dl-OrJointTCI-StateList with activated TCI-State or ul-TCI-StateList with activated TCI-UL-State receives DCI format 1_1/1_2/1_3 providing indicated TCI-State(s) and/or TCI-UL-State(s) for a CC or CCs in the same CC list configured by simultaneousU-TCI-UpdateList1-r17, simultaneousU-TCI-UpdateList2-r17, simultaneousU-TCI-UpdateList3-r17, simultaneousU-TCI-UpdateList4-r17. The DCI format 1_3 provides indicated TCI state(s) and/or TCI-UL-State(s) for the CC(s) in a scheduledCellListDCI-1-3 if the UE is scheduled by the DCI format 1_3 to receive PDSCH at least on one serving cell in the scheduledCellListDCI-1-3.

For example, the UE applies a BWP indicated/determined by a BWP indicator field of the DCI format 1_3 to TCI states corresponding to the co-scheduled cells. For example, entries for co-scheduled cells in a row of TCI-DCI-1-3 are interpreted based on the respective BWPs of co-scheduled cells that is determined by the BWP indicator field of DCI format 1_3, at least when the BWP indicator field indicates a code point that corresponds to a respective configured BWP for a respective scheduled cell.

For example, for a cell scheduled by a DCI format 0_3/1_3 with valid FDRA value, if the BWP indicator field of the DCI format indicates a code point that does not correspond to a configured BWP for the cell, the UE does not perform BWP switching based on the BWP indicator and the UE transmits a corresponding PUSCH or receives a corresponding PDSCH on a current active BWP of the cell.

Similar can hold for application of TCI state to such a cell. For example, entries for co-scheduled cells in a row of TCI-DCI-1-3 can be interpreted based on respective current active BWPs of co-scheduled cells when the BWP indicator field indicates a code point that does not correspond to a respective configured BWP for a respective scheduled cell.

For application of TCI state to non-scheduled cells, an applicable BWP can be similar to that for a DCI 0_3/1_3 scheduling PDSCH receptions or PUSCH transmissions, as the BWP indicator field in the DCI format 0_3/1_3 applies only to the scheduled cell(s) with valid FDRA value(s). For example, entries for non-scheduled cells in a row of TCI-DCI-1-3 are interpreted based on the respective current active BWPs of respective cells that are not scheduled by a DCI format 1_3.

Similar methods can apply to DCI fields, other than TCI field, of a DCI format 0_3/1_3. For example, for a DCI format 0_3/1_3 associated with a set of cells MC-DCI-SetOfCells, higher layer configuration corresponding to a number of DCI fields are in the form of respective joint tables that are configured per set of cells provided within the configuration of MC-DCI-SetOfCells. Such fields and corresponding RRC parameters include: {rate matching pattern indication field (RateMatchDCI-1-3), ZP-CSI trigger field (ZP-CSI-DCI-1-3), SRS offset field (SRS-OffsetCombo), SRS request field (SRS-RequestCombo)}.

For example, configured values/indexes within the joint tables for such DCI fields/parameters are independent of an applicable BWP. For example, entries for co-scheduled cells in a row of a table corresponding to such fields/parameters are interpreted based on the respective BWPs of co-scheduled cells that is determined by the BWP indicator field of DCI format 0_3/1_3, at least when the BWP indicator field indicates a codepoint that corresponds to a respective configured BWP for the respective scheduled cell, and based on the respective current active BWPs otherwise (that is, when the BWP indicator field indicates a codepoint that does not correspond to a respective configured BWP for the respective scheduled cell).

In one example, a UE does not expect different parameters, such as different RRC configuration parameters, for different BWPs of a cell. For example, for any given DL/UL signal or channel, the UE is provided a single cell-specific configuration that applies to different DL/UL BWPs configured on the cell. For example, such single/common configuration can apply at least for parameters that do not depend on a respective frequency allocation, such as a number of REs/RBs. For example, different DL BWPs (or different UL BWPs) can have different bandwidth sizes, while other applicable parameters are same across different DL BWPs (or different UL BWPs). For example, the UE is configured (or expects to be configured) a single/same TDRA table or a single/same PDCCH-to-PDSC/PUSCH timing parameter (K0/K1) or a single/same PDSCH-to-HARQ_ACK timing parameter K1 across different DL/UL BWPs of a cell. For example, the UE may apply no delay or timeline (or may apply very limited delay, such as one or two OFDM symbols) when switching from a first DL BWP of a cell to a second DL BWP of the cell (similar for UL BWP). For example, support of same RRC parameters across different DL/UL BWPs of a cell can be a default UE capability, and support for different RRC parameters across different DL/UL BWPs can be an additional capability that the UE reports (possibly along with reporting a supported value of application delay or timeline for DL/UL BWP switching). For example, the cell can be a serving cell or a non-serving cell, such as for mobility or beam management or other inter-cell procedures.

In one example, when a DCI format 1_3 schedules PDSCHs on cells from a set of cells for multi-cell scheduling, the UE generates HARQ-ACK information for the DCI format 1_3 based on the scheduled PDSCHs, without regards to TCI state indication.

In another example, when a DCI format 1_3 schedules PDSCH on at least one cell from a set of cells, and the UE applies TCI states to at least one cell without scheduled PDSCH from a corresponding set of cells, the UE generates HARQ-ACK for the scheduled PDSCHs and also for acknowledgment of the TCI state indication for the non-scheduled cells. For example, the UE generates a predetermined ACK value corresponding to a cell with smallest cell index from the cells that are not scheduled by the DCI format 1_3. For example, for the purpose of providing HARQ-ACK information corresponding to TCI state indication, the UE expects that the UE receives a PDSCH on a serving cell with smallest cell index among cells in a corresponding set of cells that are not scheduled by the DCI format 1_3, and that the PDSCH provides one transport block that the UE correctly decodes. For example, the corresponding HARQ-ACK information is included in a second HARQ-ACK sub-codebook of a Type-2 HARQ-ACK codebook, as for DCI formats 1_3 that schedule more than one cells from corresponding set of cells. Same assumption and handling apply for DAI determination.

In another example, when the UE receives a DCI format 1_3 that schedules no PDSCHs on any cell, and the UE applies TCI states to cells from a corresponding set of cells, the UE generates a predetermined ACK for acknowledgment of the TCI state indication for the non-scheduled cells. For example, the UE generates a predetermined ACK value corresponding to a cell with smallest cell index from the cells that are not scheduled by the DCI format 1_3. For example, for the purpose of providing HARQ-ACK information corresponding to TCI state indication, the UE expects that the UE receives a PDSCH on a serving cell with smallest cell index among cells in a corresponding set of cells that are not scheduled by the DCI format 1_3, and that the PDSCH provides one transport block that the UE correctly decodes. For example, the corresponding HARQ-ACK information is included in a first HARQ-ACK sub-codebook of a Type-2 HARQ-ACK codebook, as for single-cell scheduling DCI formats and for DCI formats 1_3 that schedule only one cell from a corresponding set of cells. Same assumption and handling apply for DAI determination.

In one example, when the same DCI format 1_3 is used for both TCI state indication for non-scheduled cells and also for SCell dormancy indication by repurposing certain fields associated with one (or more) non-scheduled cell(s), the UE generates a same predetermined ACK for acknowledgment of both the TCI state indication and the SCell dormancy indication. For example, the predetermined ACK is associated with a cell with smallest cell index among cells, from a corresponding set of cells, that are not scheduled by the DCI format 1_3.

In another example, the UE does not provide any HARQ-ACK information to acknowledge a TCI state indication by the DCI format 1_3. For example, the UE generates HARQ-ACK information for the DCI format 1_3 only based on scheduled PDSCHs (or SCell dormancy indication), without regards for acknowledgment of TCI state indication for scheduled or non-scheduled cells.

The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A method for operating a user equipment (UE), the method comprising:
receiving first information for a set of cells;
receiving a downlink control information (DCI) format that schedules first one or more physical downlink shared channels (PDSCHs) on respective first one or more cells from the set of cells, wherein:
a bandwidth part (BWP) indicator field of the DCI format indicates a downlink (DL) BWP index,
a transmission configuration information (TCI) field of the DCI format provides a TCI state indication including:
first one or more indicated TCI states for the first one or more cells, respectively, and
second one or more indicated TCI states for second one or more cells, respectively, and
the second one or more cells (i) are from the set of cells and (ii) are not scheduled by the DCI format;
determining respective first one or more new active DL BWPs for the first one or more cells based on the indicated DL BWP index, wherein:
the first one or more indicated TCI states are from associated first one or more sets of activated TCI states on the respective first one or more new active DL BWPs, and
the second one or more indicated TCI states are from associated second one or more sets of activated TCI states on respective current active DL BWPs of the second one or more cells; and
receiving the first one or more PDSCHs on the respective first one or more new active DL BWPs of the first one or more cells.

2. The method of claim 1, further comprising:
determining hybrid automatic repeat request acknowledgment (HARQ-ACK) information, wherein the HARQ-ACK information includes:
first HARQ-ACK information bits associated with the first one or more PDSCHs, and
a bit corresponding to a positive acknowledgment (ACK) value that is associated with a cell with a smallest cell index among the second one or more cells;
determining a HARQ-ACK codebook that includes the HARQ-ACK information; and
transmitting a channel that provides the HARQ-ACK codebook, wherein the channel is a physical uplink control channel (PUCCH) or a physical uplink shared channel (PUSCH).

3. The method of claim 2, wherein:
the HARQ-ACK codebook includes:
a first HARQ-ACK sub-codebook associated with first DCI formats that (i) schedule one PDSCH on one cell or (ii) do not schedule a PDSCH and have an associated HARQ-ACK information bit, and
a second HARQ-ACK sub-codebook associated with second DCI formats that schedule more than one PDSCHs on respective more than one cells;
the HARQ-ACK information is included in the second HARQ-ACK sub-codebook; and
the positive ACK value corresponds to the TCI state indication by the DCI format for the set of cells.

4. The method of claim 2, further comprising:
receiving second information indicating two transport blocks (TBs) for PDSCH receptions on the cell with the smallest cell index among the second one or more cells,
wherein the HARQ-ACK information is determined by assuming:
a PDSCH reception with one TB on the cell with the smallest cell index, and
the ACK value for the one TB of the PDSCH reception on the cell with the smallest cell index.

5. The method of claim 2, wherein the first HARQ-ACK information bits and the bit corresponding to the positive ACK are ordered in ascending order of cell index among:
the first one or more cells, and
the cell with the smallest cell index among the second one or more cells.

6. The method of claim 2, wherein:
first fields of the DCI format are used for indication of secondary cell (SCell) dormancy,
the first fields are associated with the cell with the smallest cell index among the second one or more cells, and
the positive ACK corresponds to both the TCI state indication and the SCell dormancy indication.

7. The method of claim 1, further comprising:
determining a DL BWP change for a first cell from the first one or more cells, wherein:
a time-domain resource allocation (TDRA) table for the first cell after the DL BWP change is same as a TDRA table for the first cell before the DL BWP change, and
a size of a DL BWP for the first cell after the DL BWP change is different from a size of a DL BWP for the first cell before the DL BWP change.

8. A user equipment (UE) comprising:
a transceiver configured to receive:
first information for a set of cells, and
a downlink control information (DCI) format that schedules first one or more physical downlink shared channels (PDSCHs) on respective first one or more cells from the set of cells, wherein:
a bandwidth part (BWP) indicator field of the DCI format indicates a downlink (DL) BWP index,
a transmission configuration information (TCI) field of the DCI format provides a TCI state indication including:
first one or more indicated TCI states for the first one or more cells, respectively, and
second one or more indicated TCI states for second one or more cells, respectively, and
the second one or more cells (i) are from the set of cells and (ii) are not scheduled by the DCI format; and
a processor operably coupled with the transceiver, the processor configured to determine respective first one or more new active DL BWPs for the first one or more cells based on the indicated DL BWP index, wherein:
the first one or more indicated TCI states are from associated first one or more sets of activated TCI states on the respective first one or more new active DL BWPs, and
the second one or more indicated TCI states are from associated second one or more sets of activated TCI states on respective current active DL BWPs of the second one or more cells, and
wherein the transceiver is further configured to receive the first one or more PDSCHs on the respective first one or more new active DL BWPs of the first one or more cells.

9. The UE of claim 8, wherein:
the processor is further configured to determine hybrid automatic repeat request acknowledgment (HARQ-ACK) information;
the HARQ-ACK information includes:
first HARQ-ACK information bits associated with the first one or more PDSCHs, and
a bit corresponding to a positive acknowledgment (ACK) value that is associated with a cell with a smallest cell index among the second one or more cells;
the processor is further configured to determine a HARQ-ACK codebook that includes the HARQ-ACK information;
the transceiver is further configured to transmit a channel that provides the HARQ-ACK codebook; and
the channel is a physical uplink control channel (PUCCH) or a physical uplink shared channel (PUSCH).

10. The UE of claim 9, wherein:
the HARQ-ACK codebook includes:
a first HARQ-ACK sub-codebook associated with first DCI formats that (i) schedule one PDSCH on one cell or (ii) do not schedule a PDSCH and have an associated HARQ-ACK information bit, and
a second HARQ-ACK sub-codebook associated with second DCI formats that schedule more than one PDSCHs on respective more than one cells;
the HARQ-ACK information is included in the second HARQ-ACK sub-codebook; and
the positive ACK value corresponds to the TCI state indication by the DCI format for the set of cells.

11. The UE of claim 9, wherein:
the transceiver is further configured to receive second information indicating two transport blocks (TBs) for PDSCH receptions on the cell with the smallest cell index among the second one or more cells; and
the processor is further configured to determine the HARQ-ACK information based on an assumption of:
a PDSCH reception with one TB on the cell with the smallest cell index, and
the ACK value for the one TB of the PDSCH reception on the cell with the smallest cell index.

12. The UE of claim 9, wherein:
the first HARQ-ACK information bits and the bit corresponding to the positive ACK are ordered in ascending order of cell index among:
the first one or more cells, and
the cell with the smallest cell index among the second one or more cells.

13. The UE of claim 9, wherein:
first fields of the DCI format are used for indication of secondary cell (SCell) dormancy,
the first fields are associated with the cell with the smallest cell index among the second one or more cells, and
the positive ACK corresponds to both the TCI state indication and the SCell dormancy indication.

14. The UE of claim 8, wherein:
the processor is further configured to determine a DL BWP change for a first cell from the first one or more cells,
a time-domain resource allocation (TDRA) table for the first cell after the DL BWP change is same as a TDRA table for the first cell before the DL BWP change, and
a size of a DL BWP for the first cell after the DL BWP change is different from a size of a DL BWP for the first cell before the DL BWP change.

15. A base station comprising:
a transceiver configured to:
transmit first information for a set of cells;
transmit a downlink control information (DCI) format that schedules first one or more physical downlink shared channels (PDSCHs) on respective first one or more cells from the set of cells, wherein:
a bandwidth part (BWP) indicator field of the DCI format indicates a downlink (DL) BWP index,
a transmission configuration information (TCI) field of the DCI format provides a TCI states indication including:
first one or more indicated TCI states for the first one or more cells, respectively, and
second one or more indicated TCI states for second one or more cells, respectively, and
the second one or more cells (i) are from the set of cells and (ii) are not scheduled by the DCI format; and
a processor operably coupled with the transceiver, the processor configured to determine respective first one or more new active DL BWPs for the first one or more cells based on the indicated DL BWP index, wherein:
the first one or more indicated TCI states are from associated first one or more sets of activated TCI states on the respective first one or more new active DL BWPs, and
the second one or more indicated TCI states are from associated second one or more sets of activated TCI states on respective current active DL BWPs of the second one or more cells, and
wherein the transceiver is further configured to transmit the first one or more PDSCHs on the respective first one or more new active DL BWPs of the first one or more cells.

16. The base station of claim 15, wherein:
the processor is further configured to determine hybrid automatic repeat request acknowledgment (HARQ-ACK) information;
the HARQ-ACK information is included in the HARQ-ACK codebook, and
the HARQ-ACK information includes:
first HARQ-ACK information bits associated with the first one or more PDSCHs, and
a bit corresponding to a positive acknowledgment (ACK) value that is associated with a cell with a smallest cell index among the second one or more cells;
the transceiver is further configured to receive a channel that provides the HARQ-ACK codebook; and
the channel is a physical uplink control channel (PUCCH) or a physical uplink shared channel (PUSCH).

17. The base station of claim 16, wherein:
the HARQ-ACK codebook includes:
a first HARQ-ACK sub-codebook associated with first DCI formats that (i) schedule one PDSCH on one cell or (ii) do not schedule a PDSCH and have an associated HARQ-ACK information bit, and
a second HARQ-ACK sub-codebook associated with second DCI formats that schedule more than one PDSCHs on respective more than one cells;
the HARQ-ACK information is included in the second HARQ-ACK sub-codebook; and
the positive ACK value corresponds to the TCI state indication by the DCI format for the set of cells.

18. The base station of claim 16, wherein:
the transceiver is further configured to transmit second information indicating two transport blocks (TBs) for PDSCH transmissions on the cell with the smallest cell index among the second one or more cells; and
the processor is further configured to determine the HARQ-ACK information based on an assumption of:
a PDSCH transmission with one TB on the cell with the smallest cell index, and
the ACK value for the one TB of the PDSCH transmission on the cell with the smallest cell index.

19. The base station of claim 16, wherein:
the first HARQ-ACK information bits and the bit corresponding to the positive ACK are ordered in ascending order of cell index among:
the first one or more cells, and
the cell with the smallest cell index among the second one or more cells.

20. The base station of claim 16, wherein:
first fields of the DCI format are used for indication of secondary cell (SCell) dormancy,
the first fields are associated with the cell with the smallest cell index among the second one or more cells, and
the positive ACK corresponds to both the TCI state indication and the SCell dormancy indication.
